(19) United States
(12) Patent Application Publication
(10) Pub. No.: US 2013/0268263 A1
(43) Pub. Date: Oct. 10, 2013

(54) METHOD FOR PROCESSING NATURAL LANGUAGE AND MATHEMATICAL FORMULA AND APPARATUS THEREFOR

(71) Applicant: SK TELECOM CO., LTD., Seoul (KR)

(72) Inventors: Yong Gil PARK, Seongnam Si (KR); Keun Tae Park, Seongnam Si (KR); Dong Hahk Lee, Seoul (KR); Hyeongin Choi, Seoul (KR); Nam Sook Wee, Seoul (KR); Doo Seok Lee, Seoul (KR); Jung Kyo Sohn, Seoul (KR); Haeng Moon Kim, Gwacheon-si (KR)

(21) Appl. No.: 13/908,366

(22) Filed: Jun. 3, 2013

Related U.S. Application Data
(63) Continuation of application No. PCT/KR2011/009333, filed on Dec. 2, 2011.

(30) Foreign Application Priority Data
Dec. 2, 2010 (KR) 10-2010-0122025
Dec. 22, 2010 (KR) 10-2010-0132141
Dec. 23, 2010 (KR) 10-2010-0133761
Dec. 30, 2010 (KR) 10-2010-0138531
Jan. 6, 2011 (KR) 10-2011-0001282
Feb. 21, 2011 (KR) 10-2011-0014968

(51) Int. Cl. G06F 17/27

(52) U.S. Cl. CPC G06F 17/2785
USPC 704/9

(57) ABSTRACT

The present disclosure provides an apparatus and method for processing a natural language and a mathematical formula. The apparatus includes a natural language and mathematical formula input unit configured to receive a natural language and a mathematical formula inputted; an information generation unit configured to generate parsing semantic information of the mathematical formula from combined data composed of the natural language combined with the mathematical formula; an operation information extraction unit configured to extract operation information generated by using a logical condition from the combined data; a natural language and mathematical formula structuralizing unit configured to analyze, classify in terms of specific meaning and recombine the combined data; an operation structuralizing unit configured to structuralize the operation information; and a natural language and mathematical formula indexing unit configured to index the combined data.

### CROSS-REFERENCE TO RELATED APPLICATION

The present application is a continuation of International Patent Application No. PCT/KR2011/009333, filed Dec. 2, 2011, which is based on and claims priorities to Korean Patent Application No. 10-2010-0122025, filed on Dec. 2, 2010; Korean Patent Application No. 10-2010-0132141, filed on Dec. 22, 2010; Korean Patent Application No. 10-2010-0133761, filed on Dec. 23, 2010; Korean Patent Application No. 10-2010-0138531, filed on Dec. 30, 2010; Korean Patent Application No. 10-2011-0001282, filed on Jan. 6, 2011 and Korean Patent Application No. 10-2011-0014968, filed on Feb. 21, 2011. The disclosures of the above-listed applications are hereby incorporated by reference herein in their entirety.

### FIELD

The present disclosure relates to a method for processing a natural language and a math formula.

### BACKGROUND

The statements in this section merely provide background information related to the present disclosure and may not constitute prior art.

Human's words are abundant and complicated which have a huge vocabulary with complicated grammars and context meanings, whereas machines or software applications generally require that data be inputted depending on specific formats or rules. Here, natural language input can be used in almost all of software applications that interact with human users. A general natural language process includes separating a natural language into tokens, mapping them on one or more operations provided by software applications, and setting each software application to have a series of its own operation information. That is, a software developer makes codes used to analyze a natural language input and then maps the input on operations suitable to each application.

The inventor(s), however, has experienced that such a natural language process has problems that it cannot provide a dedicated input tool to receive a math formula inputted, identify math formula, indexes and structuralize natural language and math formula and understand a meaning included in an actual math formula.

### SUMMARY

In accordance with some embodiments, an apparatus for processing a natural language and a mathematical formula comprises a natural language and mathematical formula input unit, an information generation unit, an operation information extraction unit, a natural language and mathematical formula structuralizing unit, an operation structuralizing unit, and a natural language and mathematical formula indexing unit. The natural language and mathematical formula input unit is configured to receive a natural language and a mathematical formula inputted. The information generation unit is configured to generate parsing semantic information of the mathematical formula from combined data including the natural language combined with the mathematical formula. The operation information extraction unit is configured to extract operation information generated by using a logical condition from the combined data. The natural language and mathematical formula structuralizing unit is configured to analyze, classify in terms of specific meaning and recombine the combined data. The operation structuralizing unit is configured to structuralize the operation information. And the natural language and mathematical formula indexing unit is configured to index the combined data.

In accordance with some embodiments, an apparatus for processing a natural language and a mathematical formula comprises a first natural language input processor, a first mathematical formula input processor, a first information processing unit, a first parsing unit, and a first data management unit. The first natural language input processor is configured to provide a text input tool used to receive a natural language inputted. The first mathematical formula input processor is configured to provide a mathematical formula input tool used to receive a mathematical formula inputted. The first information processing unit is configured to deliver aggregation data generated by aggregating the natural language and the mathematical formula inputted. The first parsing unit is configured to receive the aggregated data inputted, and generate semantic information used to analyze and classify each of constitutional information constituting the natural language and mathematical formula, the classifying being performed in terms of specific meaning. And the first data management unit is configured to recombine one or more of the constitutional information, the natural language, the mathematical formula and the semantic information and to store the one or more recombined information.

In accordance with some embodiments, an apparatus for processing a natural language and a mathematical formula comprises a second information input unit, a second separation unit, a second natural language processing unit, a second mathematical formula processing unit, and a second data management unit. The second information input unit is configured to receive combined data composed of a natural language combined with a mathematical formula. The second separation unit is configured to separate the natural language and the mathematical formula from the combined data. The second natural language processing unit is configured to analyze and classify each first information constituting the separated natural language, the classifying being performed in terms of specific meaning. The second mathematical formula processing unit is configured to analyze and classify each second information constituting the separated mathematical formula, the classifying being performed in terms of specific meaning. And the second data management unit is configured to recombine one or more of the first information, the second information, the natural language and the mathematical formula and to store the one or more recombined information as recombined data.

In accordance with some embodiments, an apparatus for processing a natural language and a mathematical formula comprises a third information input unit, a third semantic parser unit, a third data management unit, a third query parser unit, and a third indexing unit. The third information input unit is configured to receive combined data composed of a natural language combined with a mathematical formula. The third semantic parser unit is configured to separate the natural language and mathematical formula from the combined data and generate semantic information used to analyze and classify each of constitutional information constituting the separated natural language and mathematical formula, the classifying being performed in terms of specific meaning. The third data management unit is configured to recombine one or more of the constitutional information, the natural language, the mathematical formula and the semantic information and to store the recombined information as recombined data. The third query parser unit is configured to extract and structuralize a keyword included in a user query inputted. And the third indexing unit is configured to generate semantic index information generated by indexing the semantic information and generate query index information generated by matching the semantic index information to information on the keyword.

In accordance with some embodiments, an apparatus for processing a natural language and a mathematical formula comprises a fourth information input unit, a fourth separation unit, a fourth natural language processing unit, a fourth mathematical formula processing unit, a fourth rule storage unit, and a fourth operation extraction unit. The fourth information input unit is configured to receive a complex sentence including a natural language and a mathematical formula. The fourth separation unit is configured to separate the natural language and the mathematical formula from the complex sentence. The fourth natural language processing unit is configured to generate a natural language token by tokenizing the separated natural language. The fourth mathematical formula processing unit is configured to parse the separated mathematical formula, extract a semantic meaning and generate a mathematical formula token. The fourth rule storage unit is configured to store a rule generated by coupling a logical condition of the natural language and mathematical formula to operation information corresponding to the logical condition. And the fourth operation extraction unit is configured to extract operation information of the complex sentence from the stored rule by comparing the generated natural language token and the generated mathematical formula token with a logical condition of the stored rule.

In accordance with some embodiments, an apparatus for processing a natural language and a mathematical formula comprises a fifth information input unit, a fifth sentence analysis unit, a fifth operation extraction unit, and a fifth operation execution unit. The fifth information input unit is configured to receive a complex sentence including a natural language and a mathematical formula. The fifth sentence analysis unit is configured to analyze a sentence composition of the complex sentence, tokenize mathematical formula data and the natural language, and generate a mathematical formula token and a natural language token. The fifth operation extraction unit is configured to extract operation information corresponding to a meaning of the natural language token with reference to a natural language token rule. And the fifth operation execution unit is configured to structuralize the extracted operation information with respect to the mathematical formula token.

In accordance with some embodiments, an apparatus for processing a natural language and a mathematical formula comprises a sixth information input unit, a sixth mathematical formula data structuralizing unit, and a sixth operator parsing unit. The sixth information input unit configured to receive mathematical formula data expressed in a mathematical formula. The sixth mathematical formula data structuralizing unit configured to extract an operator and a parameter from the mathematical formula data and structuralize the operator and parameter. And the sixth operator parsing unit configured to extract a semantic meaning of the operator with respect to the structuralized operator, couple the extracted semantic meaning to a parameter associated with the operator, and generate parsing semantic information.

### BRIEF DESCRIPTION OF DRAWINGS

FIG. 1 is a schematic block diagram of an apparatus for processing a natural language and a math formula according to a first embodiment of the present disclosure;

FIG. 2 is a flowchart of a method for inputting a natural language and a math formula according to a first embodiment of the present disclosure;

FIG. 3 is an exemplary view of a structure of XML according to a first embodiment of the present disclosure;

FIG. 4 is a schematic block diagram of an apparatus for processing a natural language and a math formula according to a second embodiment of the present disclosure;

FIG. 5 is a schematic block diagram of a natural language processing unit of FIG. 4 according to a second embodiment of the present disclosure;

FIG. 6 is a schematic block diagram of a math formula processing unit of FIG. 4 according to a second embodiment of the present disclosure;

FIG. 7 is a flowchart of a method for structuralizing a natural language and a math formula according to a second embodiment of the present disclosure;

FIG. 8 is an exemplary diagram of an expression of a tree format of a math formula according to a second embodiment of the present disclosure;

FIG. 9 is an exemplary diagram of a system in which an apparatus for processing a natural language and a math formula provides a cloud computing apparatus with data according to a second embodiment of the present disclosure;

FIG. 10 is an exemplary diagram of a method for analyzing information constituting a natural language and a math formula and classifying the information in terms of a specific meaning according to a second embodiment of the present disclosure;

FIG. 11 is a schematic block diagram of an apparatus for processing a natural language and a math formula according to a third embodiment of the present disclosure;

FIG. 12 is a flowchart of a method for indexing a natural language and a math formula according to a third embodiment of the present disclosure;

FIG. 13 is a flowchart of a method for providing a ranking of indexed query information according to a third embodiment of the present disclosure;

FIG. 14 is an exemplary view of an inversed file structure included in semantic information according to a third embodiment of the present disclosure;

FIG. 15 is an exemplary diagram in which an index included in semantic information is expressed in a full-vector according to a third embodiment of the present disclosure;

FIG. 16 is an exemplary diagram of a system in which an apparatus for processing a natural language and a math formula provides a cloud computing apparatus with data according to a third embodiment of the present disclosure;

FIG. 17 is an exemplary diagram of a method for analyzing information constituting a natural language and a math formula and classifying the information in terms of specific meaning according to a third embodiment of the present disclosure;

FIG. 18 is a schematic block diagram of an apparatus for processing a natural language and a math formula of a complex sentence according to a fourth embodiment of the present disclosure;

FIG. 19 is a diagram in which a format constituting a mathematical problem is exemplified in a tree structure according to a fourth embodiment of the present disclosure;

FIG. 20 is a view of a procedure for generating a rule according to a fourth embodiment of the present disclosure;

FIG. 21 is a view of a constitution of a rule engine used as a rule storage unit and a process to extract operation information of the rule engine according to a fourth embodiment of the present disclosure;

FIG. 22 is a schematic view of a procedure to obtain a mathematical object according to a fourth embodiment of the present disclosure;

FIG. 23 is a flowchart of a method for extracting semantic information of a complex sentence according to a fourth embodiment of the present disclosure;

FIG. 24 is a view of a method for extracting operation information by a rule matching according to a fourth embodiment of the present disclosure;

FIG. 25 is an exemplary view of a system in which an apparatus for processing a natural language and a math formula of a complex sentence provides a cloud computing apparatus with data according to a fourth embodiment of the present disclosure;

FIG. 26 is a schematic block diagram of an apparatus for processing a natural language and a math formula of a complex sentence according to a fifth embodiment of the present disclosure;

FIG. 27 is a schematic block diagram of a sentence analysis unit according to a fifth embodiment of the present disclosure;

FIG. 28 is a schematic block diagram of a natural language processing unit according to a fifth embodiment of the present disclosure;

FIG. 29 is a schematic block diagram of a math formula processing unit according to a fifth embodiment of the present disclosure;

FIG. 30 is a flowchart of a method for converting a logical expression of a complex sentence according to a fifth embodiment of the present disclosure;

FIG. 31 is an exemplary diagram of an expression of a tree format of a complex sentence according to a fifth embodiment of the present disclosure;

FIG. 32 is an exemplary view of a system in which an apparatus for processing a natural language and a math formula of a complex sentence provides a cloud computing apparatus with data according to a fifth embodiment of the present disclosure;

FIG. 33 is a schematic block diagram of an apparatus for processing a math formula and a natural language according to a sixth embodiment of the present disclosure;

FIGS. 34 and 35 are exemplary views of an operator parsing result for math formula data expressed in math formula according to a sixth embodiment of the present disclosure;

FIG. 36 is an exemplary view of a crossing order of a node reflecting a cMathML characteristic according to a sixth embodiment of the present disclosure;

FIG. 37 is an exemplary view of semantic information coupling math formula data including parsing semantic information (b) combined with a math formula inputted (a) according to a sixth embodiment of the present disclosure;

FIG. 38 is an exemplary view of a data structure to deliver data between nodes while crossing nodes according to a sixth embodiment of the present disclosure;

FIG. 39 is an exemplary view of a system in which an apparatus for processing a natural language and a math formula provides a cloud computing apparatus with data according to a sixth embodiment of the present disclosure; and

FIG. 40 is a flowchart of a method for generating math formula semantic information according to the sixth embodiment of the present disclosure.

### DETAILED DESCRIPTION

The present disclosure provides a method and an apparatus for processing a natural language and a math formula. To perform the method, the apparatus is configured to include providing dedicated input tools for allowing a user to input a natural language and a math formula, generate semantic information, extract semantic information automatically, structuralize the natural language and math formula as recombined data on the basis of analyzed contents of combined data of the natural language and math formula, express a complex sentence including the natural language and math formula to have a logical relationship automatically, and index structuralized information of a user query on the basis of semantic information.

Hereinafter, a detail description is given with reference to accompanying drawings.

Meanwhile, an apparatus 100 for processing a natural language and a math formula can be embodied as various apparatuses according to various embodiments. For example, the apparatus 100 can include: (i) a natural language and math formula input unit for a first embodiment; (ii) a natural language and math formula structuralizing unit for a second embodiment; (iii) a natural language and math formula indexing unit for a third embodiment; (iv) an operation information extraction unit for a fourth embodiment; (v) an operation structuralizing unit for a fifth embodiment; and (vi) an information generation unit for a sixth embodiment. Here, the natural language and math formula input unit receives a natural language and a math formula inputted. The information generation unit generates parsing semantic information for the math formula from the combined data composed of the natural language combined with the mathematical formula. The operation information extraction unit extracts operation information generated by using a logical condition from the combined data. The natural language and math formula structuralizing unit analyzes combined data composed of the natural language combined with the math formula, classifying the combined data in terms of specific meaning and then recombining them. The operation structuralizing unit structuralizes the operation information. And the natural language and math formula indexing unit indexes the combined data.

(i) The natural language and math formula input unit provides a text input tool used to receive the natural language inputted, provides a math formula input tool used to receive the math formula inputted, generates aggregated data generated by aggregating natural language and math formula inputted, generates semantic information used to analyze and classify each of constitutional information constituting the natural language and math formula wherein the classifying is performed in terms of specific meaning, and recombines one or more of the constitutional information, the natural language, the math formula and the semantic information and then stores recombined information. (ii) The natural language and math formula structuralizing unit receives the combined data inputted, separates the natural language and the mathematical language from the combined data, analyzes and classifies each first information constituting the separated natural language wherein the classifying is performed in terms of specific meaning, analyzes and classifies each second information constituting the separated math formula wherein the classifying is performed in terms of specific meaning, and recombines one or more of the first information, the second information, the natural language and the math formula and stores the recombined information as recombined data. (iii) The natural language and math formula indexing unit receives the combined data inputted, separates the natural language and math formula from the combined data and generates semantic information used to analyze and classify each of constitutional information constituting the separated natural language and math formula wherein the classifying is performed in terms of specific meaning, recombines one or more of the constitutional information, the natural language, the math formula and the semantic information and stores the recombined information as recombined data, extracts and structuralizes a keyword included in a user query inputted, and generates semantic index information generated by indexing the semantic information and generates query index information generated by matching the semantic index information to information on the keyword

(iv) The operation information extraction unit receiving the combined data inputted, separates the natural language and math formula from the combined data, generates at least one natural language token by tokenizing the separated natural language, generates at least one math formula token by parsing the separated math formula and by extracting a semantic meaning, stores a rule generated by coupling a logical condition of natural language and math formula with the operation information corresponding to the logical condition, extracts the operation information of the combined data from the stored rule by comparing the generated at least one natural language token and math formula token with the logical condition of the stored rule. (v) The operation structuralizing unit receives the combined data inputted analyzes sentence constitution of the combined data, tokenizes the natural language and the math formula and generates the natural language token and the math formula token, extracts the operation information corresponding to a meaning of the natural language token with reference to a natural language token rule, and structuralizes the extracted operation information with respect to the math formula token. (vi) The information generation unit receiving the math formula data inputted, the data being expressed in the math formula, extracts an operator and a parameter from the math formula data and structuralizes the extracted operator and parameter, and extracts a semantic meaning of the operator with respect to the structuralized operator, couples the extracted semantic meaning to a parameter associated with the operator, and generates the parsing semantic information.

Meanwhile, in implementing at least one embodiment of the present disclosure, after providing a dedicated input tool so that a user input a natural language and math formula, while it does not matter what order remaining operations (semantic information generation and extraction, natural language and math formula structuralization and indexing, etc.) is performed, the sematic information is generated, semantic information is automatically extracted, the natural language and math formula are structuralized so that they are managed as recombined data based on analysis contents of data composed of natural language combined with math formula, a complex sentence including a natural language and a math formula is expressed to have logical relationship automatically, and user query structuralized information is indexed together with semantic information based on the semantic information. That is, since the present embodiments have independent characteristics of their own, they can perform respective independent processes, without being limited to a scheme in that a next process is performed only after a certain process is performed.

### First Embodiment

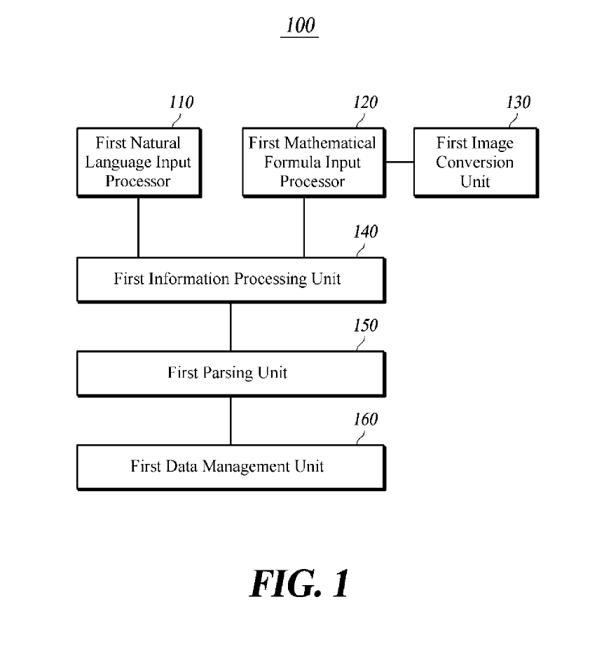

Hereinafter, a first embodiment of the present disclosure of a method and apparatus for providing a natural language and a math formula inputted will be described with reference to FIGS. 1 to 3.

A natural language and math formula processing apparatus 100 described in the first embodiment refers to an apparatus for providing a text input tool to receive a natural language inputted and a math formula tool to receive a math formula inputted, and the natural language and math formula processing apparatus 100 may be embodied with hardware or software and installed on a server or a terminal.

FIG. 1 is a schematic block diagram of an apparatus for processing a natural language and a math formula according to a first embodiment of the present disclosure.

The natural language and math formula processing apparatus 100 in accordance with the first embodiment includes a first natural language input processor 110, a first math formula input processor 120, a first image conversion unit 130, a first information processing unit 140, a first parsing unit 150 and a first data management unit 160. Meanwhile, while it is described that the first embodiment includes only a first natural language input processor 110, a first math formula input processor 120, a first image conversion unit 130, a first information processing unit 140, a first parsing unit 150 and a first data management unit 160, it is merely an exemplary description for a technical idea of the first embodiment and it is noted that those skilled in the art will variously modify, change and apply constitutional elements included in the natural language and math formula processing apparatus 100 without departing from various properties of the first embodiment.

The first natural language input processor 110 provides a text input tool used to receive a natural language inputted. The first natural language input processor 110 provides a dedicated text input tool used to input a natural language. Meanwhile, when the natural language and math formula processing unit 100 is interconnected to an external server, the first natural language input processor 110 may provide a text input tool through the server. When the natural language and math formula processing apparatus 100 is embodied in a server form and interconnected to an external terminal, the first natural language input processor 110 may provide a text input tool to the terminal. Further, the natural language and math formula processing apparatus 100 is embodied in a stand-alone terminal form which is not interconnected to an external apparatus, the first natural language input processor 110 may be embodied in that a text input tool is provided through a display included. Further, text information inputted to the first natural language input processor 110 is information corresponding to a text among mathematical contents including mathematical problems and mathematical proofs, which is not necessarily limited thereto. Further, a user may directly input text information through a text input tool provided by the first natural language input processor 110, to which the embodiment is not limited. The text information corresponding to the natural language may be inputted from a separate external server or terminal.

The first math formula input processor 120 provides a math formula input tool to receive at least one math formula inputted. The first math formula input processor 120 receives at least one math formula formed of Math ML (Mathematical Markup Language) through a math formula input tool. The first math formula input processor 120 refers to a tool that supports at least one of Java Applet, SilverLight, and Active X. Meanwhile, when the natural language and math formula processing apparatus 100 is interconnected to an external server, the first math formula input processor 120 may provide a math formula input tool through the server. When the natural language and math formula processing apparatus 100 is embodied in a stand-along terminal form which is not interconnected to an external apparatus, the first math formula input processor 120 may be embodied to provide a math formula input tool through a display included. Further, the math formula information inputted to the first math formula input processor 120 is information corresponding to a text among mathematical contents including mathematical problems and mathematical proofs, which is not necessarily limited thereto. Further, a user may directly input math formula information through a math formula input tool provided by the first math formula input processor 120, to which the embodiment is not limited. The math formula information corresponding to the natural language may be inputted from a separate external server or terminal.

The first image conversion unit 130 converts the least one math formula inputted through the first math formula input processor 120 into at least one image and then controls to be appear through the math formula input tool. That is, the first image conversion unit 130 can increase resolution of the math formula by converting at least one math formula of Math ML form inputted through the first math formula input processor 120 into at least one image, and control to be appear through a math formula input tool of the first math formula processor 120 again, thereby providing at least one math formula image of higher resolution to the user who has inputted the at least one math formula. Here, the first image conversion unit 130 may convert the at least one math formula inputted through the first math formula input processor 120 from combined form into at least one math formula image. That is, since an API (Application Programing Interface) is provided directly, which is used to convert the at least one math formula inputted through the first math formula input processor 120 into at least one image, the first image conversion unit 130 converts the at least one math formula of Math ML form inputted into at least one image, thereby enhancing user experiences.

The first information processing unit 140 transfers aggregated data generated by aggregating the natural language and math formula inputted. That is, the first information processing unit 140 receives at least one natural language from the first natural language input processor 110, receives at least one math formula from the first math formula input processor 120 inputted, and aggregates them to transfer to the first parsing unit 150. The first information processing unit 140 transfers the aggregated data to the first parsing unit 150 using PHP (Personal Hypertext Preprocessor). That is, the first information processing unit 140 may transfer the aggregated data of XML format to the first parsing unit 150 using the PHP. At this time, the first parsing unit 150 may be made of any programming language with one or more processors of processing any programming language, and set in a standby format to be connected to a plurality of PHPs in the open socket state. Here, semantic information outputted through the first parsing unit 150 may be stored in the XML format again or stored based on corresponding semantic information.

The first parsing unit 150 receives aggregated data, and generates semantic information by analyzing and classifying each of constitutional information constituting a natural language and a math formula included in the aggregated data wherein the classifying is performed in terms of a specific meaning. The first parsing unit 150 parses a string generated by combining the natural language with the math formula using JavaScript. For example, the first parsing unit 150 separates the natural language and the math formula with each other and structuralizes a format matched in a specific format when trying to parse the string generated by combining the natural language inputted from Web with mathematics in a Math ML format using JavaScript technique.

The first parsing unit 150 generates semantic information to analyze each of constitutional information constituting the natural language and classify the constitutional information in terms of specific meaning. When the natural language and math formula are inputted, the first parsing unit 150 analyzes each of constitutional information constituting the natural language and classifies the information in terms of a specific meaning. The parsing unit 150 generates a natural language token generated by tokenizing the natural language, and word filtered data generated by filtering stop words based on a natural language token, deduplication filtered data generated by performing a deduplication filtering in the duplicate word filtered data, and matches operation information to which a meaning defined in advance is given to the deduplication filtered data. Here, token refers to a unit discriminable in continuous sentences, and tokenization refers to a process to divide a natural language into a word unit that the natural language and math formula processing apparatus 100 can understand. Describing the tokenization in more detail, the tokenization is generally divided into a natural language tokenization and a math formula tokenization in the first embodiment. The natural language tokenization refers to a process in which each word corresponding to the output generated by dividing the natural language included in combined data (mathematical problem) based on space is identified as a natural language token. In order to capture meaning of each token in more detail, morpheme analysis for token will be additionally performed. Meanwhile, math formula tokenization refers to a process in which individual unit information obtained after parsing a math formula included in the combined data (mathematical problem) is identified as a math formula token.

Find the function value 9y³+8y²−4y−9 with y=−1 [Exercise 1]

For example, information corresponding to the natural language token in [Exercise 1] is ‘Find’, ‘the’, ‘function’, ‘value’, and ‘with’, the math formula token may be value returned after extracting information through a parsing, polynomial, maximum degree=3, number of terms=4, and condition.

The first parsing unit 150 generates a natural language token by performing a tokenization for constitutional information constituting a natural language, and stop word filtered data by performing a stop word filtering to select and remove a natural language token determined to be a stop word set in advance in the natural language token. Here, the stop word means a set of words that is defined in advance in order to remove portion corresponding to unnecessary token in analysis of sentence or math formula. That is, ‘the’ (and ‘a’ or ‘to’) in [Exercise 1] is defined in advance in a dictionary format in a system. Here, the dictionary means a list including a set of words. That is, while the first parsing unit 150 performs a process to remove stop words that are portions not necessary to make analysis after generating the natural language token, the stop word filtering operates to prevent too much tokens from being used to the analysis process when the mathematical problem becomes long (descriptive problem or the like), and to enhance processing speed of the system.

The first parsing unit 150 generates deduplication filtered data by performing a deduplication filtering to selectively remove duplicate data from the stop word filtered data and matches data corresponding to predicate in the deduplication filtered data to operation information that is given a meaning defined in advance to be stored. Here, the operation information means summary information to be extracted based on a natural language token or a math formula token. For example, it is possible to extract operation information of ‘solve’ on the basis of natural language token or math formula token in [Exercise 1]. Here, the reason why data corresponding to the predicate in the deduplication filtered data is matched to operation information to be stored is to obtain information for a representative operation meant by the entire sentence in the course of defining combined data (mathematical problem) as Schema and utilize the information as a useful tool when making a search or analyzing similarity between problems.

The parsing unit 150 analyzes each of constitutional information constituting the math formula and classifies it in terms of specific meaning. The first parsing unit 150 converts the math formula into a tree format, performs a traverse process to the math formula converted in the tree format, and performs a tokenization in the traverse process performed math formula. The first parsing unit 150 converts the math formula described in Math ML (Mathematical Markup Language) into an XML tree format and then converts the math formula into DOM (Document Object Tree) format. The first parsing unit 150 performs the traverse in Depth-First Search scheme in which constitutional information constituting the math formula is gradually transferred from the lowest node to a high node. Meanwhile, describing the traverse and depth-first search in more detail, the math formula is generally formed in Math ML format, which is constructed of a tree format. The process of traversing such a tree is referred to as a traverse process, and the depth-first search is used when performing the traverse process. Since such traverse process starts at a root of the tree, enters into child nodes, and then moves to parent nodes when the search of all child nodes is ended, all information of the child nodes are transferred to the parent nodes. It is efficient since the search is performed as many as the number of the edges in view of time complexity.

The first data management unit 160 recombines at least one of the construction information, natural language, math formula and semantic information and stores it as recombined data. The first data management unit 160 converts the recombined data into document data.

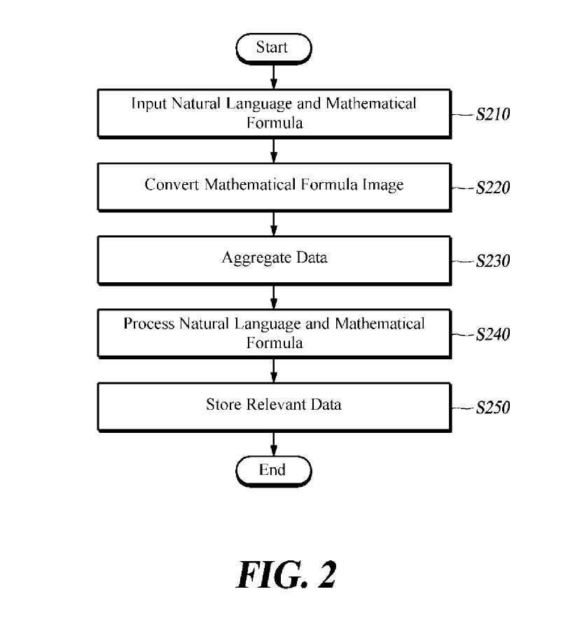

FIG. 2 is a flowchart of a method for inputting a natural language and a math formula according to a first embodiment of the present disclosure.

The natural language and math formula apparatus 100 provides a text input tool to receive the natural language and a math formula input tool to receive the math formula, and receives the natural language and math formula through the text input tool and math formula input tool (S210). Here, when the natural language and math formula processing apparatus 100 is interconnected to an external server, the natural language and math formula processing apparatus 100 can provide the text input tool and the math formula input tool through the server. Further, when the natural language and math formula processing apparatus 100 embodied in the form of a server is interconnected to an external terminal, the natural language and math formula processing apparatus 100 may provide the terminal with the text input tool and math formula input tool. Further, when the natural language and math formula processing apparatus 100 is embodied in the form of a stand-alone terminal which is not interconnected to an external apparatus, it may be embodied to provide the text input tool and the math formula input tool through the display included. Further, it is preferred that the natural language and math formula inputted to the natural language and math formula processing apparatus 100 are information corresponding to text among mathematical contents including mathematical problem and mathematical proofs, but the natural language and math formula are not limited. Meanwhile, the math formula inputted through the math formula input tool is in the Math ML format, and the math formula input tool refers to a tool to support at least one of Java Applet, Silber Light, and Active X.

For example, when the natural language and math formula processing apparatus 100 is applied to a separate Web to interconnect to a separate external server, a user inputs the natural language and math formula through a Web, and the external server transfers the natural language and math formula inputted through a Web request/response or Ajax technology to the natural language and math formula processing apparatus 100. When the user input for the natural language and math formula using the text input tool and the math formula input tool is finished, a PHP driven in an external server is transferred to the natural language and math formula processing apparatus 100 through a socket connection. At this time, the PHP is transferred in a tree format of data including Math ML, that is, in a format of XML data composed of a plurality of natural languages combined with math formulas. However, the XML has a standard format to be understood in the natural language and math formula processing apparatus 100.

The natural language and math formula processing apparatus 100 converts the math formula inputted through the math formula input tool into an image and then controls it to be appeared through the math formula input tool (S220). That is, the natural language and math formula processing apparatus 100 converts the math formula of a Math ML format inputted through the math formula input tool into an image so that the resolution of the math formula may be enhanced. Further, it provides a user who has inputted the math formula with a math formula image of high resolution by making the converted image appear through the math formula input tool of the first math formula input processor 120 again. Here, the natural language and math formula processing apparatus 100 may convert the math formula inputted through the math formula tool into a math formula in a combined format. That is, since the math formula input tool does not provide an API that can directly convert the math formula inputted into an image, the first image converting unit 130 converts the math formula of Math ML format inputted into an image to be provided, thereby enhancing the user's experience.

The natural language and math formula processing apparatus 100 aggregates the natural language and math formula inputted (S230). That is, the natural language and math formula processing apparatus 100 receives a natural language through a natural language input tool, receives a math formula inputted through the math formula input tool, and aggregates them. The natural language and math formula processing apparatus 100 generates semantic information that is used to analyze each of constitutional information constituting the natural language and math formula included in the aggregated data having the natural language and math formula aggregated and classify the information in terms of a specific meaning (S240). The natural language and math formula processing apparatus 100 parses a string generated by combining the natural language with the math formula using Java Script.

The natural language and math formula processing apparatus 100 generates semantic information used to analyze each of constitutional information constituting the natural language and math formula and classify the information in terms of a specific meaning. Describing a process performed by the natural language and math formula processing apparatus 100 in more detail, the natural language and math formula processing apparatus 100 analyzes each of constitutional information constituting the natural language and classifies the information in terms of a specific meaning, when the natural language and math formula are inputted. The natural language and math formula processing apparatus 100 generates a natural language token generated by tokenizing a natural language, generates word filtered data generated by filtering stop words based on the natural language token, generates deduplication filtered data generated by performing a deduplication filtering in the stop word filtered data, and matches operation information to which a meaning defined in advance is given to the deduplication filtered data.

That is, the natural language and math formula processing apparatus 100 generates a natural language token by tokenizing constitutional information constituting the natural language, generates stop word filtered data by performing a stop word filtering that selects a natural language token determined to be stop words set in advance in the natural language token and removes the natural language token, generates deduplication filtered data by performing a deduplication filtering that selects duplicate data in the stop word filtered data and removes the data, and matches data corresponding to a predicate in the deduplication filtered data to operation information to which a meaning defined in advance is given and stores the data.

The natural language and math formula processing apparatus 100 analyzes each of constitutional information constituting the math formula and classifies the information in terms of a specific meaning. The natural language and math formula processing apparatus 100 converts the math formula into a tree format, performs a traverse process to the math formula that has been converted into a tree format, and performs tokenization to the math formula to which the traverse process has been performed. The natural language and math formula processing apparatus 100 converts the math formula prepared in Math ML into a XML tree format and then into DOM format. The first parsing unit 150 performs the traverse in the depth-first search scheme in which constitutional information constituting the math formula is gradually transferred from the lowest node to a high node.

XML stream composed by combining the natural language and math formula transferred to the natural language and math formula processing apparatus 100 is transferred to a socket in which the data is in a stand-by state, and classified into a natural language and a math formula in the processing stage to be processed. That is, the natural language and math formula processing apparatus 100 may extract information on how the apparatus 100 is connected to nearby math formula on the basis of properties of the natural language, and then, based on the extracted information, extract semantic information needed in the contents. Meanwhile, the natural language and math formula processing apparatus 100 may parse a math formula of Math ML format inputted in a standard format and then extract semantic information related to the mathematical format.

The natural language and math formula processing apparatus 100 recombines at least one of constitutional information, natural language, math formula and semantic information and stores them as recombined data (S250). The first data management unit 160 converts the recombined data into document data. That is, the semantic information may be stored in a DB or a file system in a proper format matched to an object of the system in the future.

Although FIG. 2 and description related thereto illustrate that the processes S210 to S250 are sequentially carried out, it is contemplated that the sequence of the processes shown in FIG. 2, in the second embodiment, is changed and modified or one or more processes among the processes S210 to S250, within the intrinsic characteristics of the second embodiment, are performed in parallel and/or omitted, and thus what is illustrated FIG. 2 is not limited to that time series sequence.

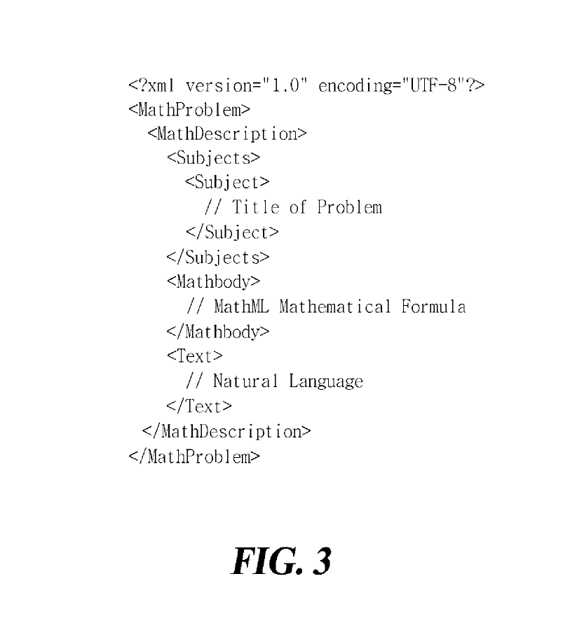

FIG. 3 is an exemplary view of a structure of XML according to a first embodiment of the present disclosure.

FIG. 3 is like an exemplary view of natural language and math formula inputted for a specific mathematical problem in a general XML format using a text input tool and math formula input tool provided in the natural language and math formula processing apparatus 100 by a user. That is, since the mathematical problem is in a format generated by combining the natural language with the math formula, XML is prepared to include the natural language and math formula. That is, XML uses <Mathbody><Mathbody> including a plurality of <Text><Text> portion and Math ML in overlapping manner.

Further, XML may be converted to be matched to a form required in a specific system with respect to mathematical problems inputted. That is, it is possible to manage the natural language and math formula inputted through the natural language and math formula processing apparatus 100 in a format to be understood in a machine, and to store and manage semantic information extracted with respect to the natural language and math formula. For example, when a user wants to input a mathematical problem of ‘a quadratic equation’, the user may input a natural language and math formula through a text input tool and a math formula input tool provided by the natural language and math formula processing apparatus 100, and is provided with information relevant to the ‘a quadratic equation’ inputted by the user.

### Second Embodiment

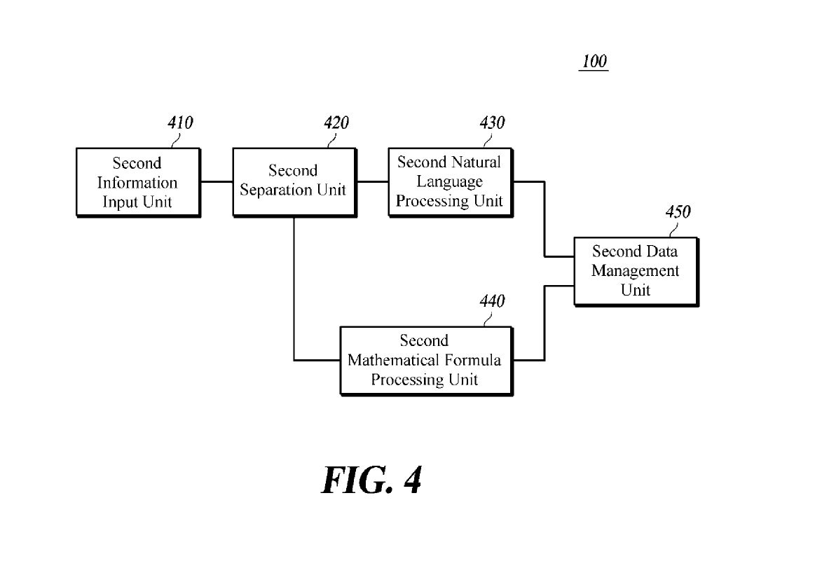

Hereinafter, a second embodiment of the present disclosure of a method for structuralizing a natural language and a math formula and apparatus therefor with reference to FIGS. 4 to 10.

The natural language and math formula processing apparatus 100 described in a second embodiment refers to an apparatus for structuralizing a natural language and a math formula respectively in combined data generated by combining the natural language with the math formula, and the natural language and math formula processing apparatus 100 may be embodied in hardware and software and installed in a server or a terminal.

FIG. 4 is a schematic block diagram of an apparatus for processing a natural language and a math formula according to a second embodiment of the present disclosure.

The natural language and math formula processing apparatus 100 according to a second embodiment of the present disclosure may include a second information input unit 410, a second separation unit 420, a second natural language processing unit 430, a second math formula processing unit 440, and a second data management unit 450. Meanwhile, while the second embodiment describes that the natural language and math formula processing apparatus 100 includes only a second information input unit 410, a second separation unit 420, a second natural language processing unit 430, a second math formula processing unit 440, and a second data management unit 450, it merely describes an example of a technical idea of the second embodiment of the present disclosure. Without departing from inherent properties of the second embodiment, those skilled in the art may apply the present disclosure by modifying and changing constitutional elements included in the natural language and math formula processing apparatus 100.

The second information input unit 410 receives combined data composed of the natural language combined with the math formula. Here, while the combined data is mathematical contents including mathematical problems and math formula proofs, the combined data is not limited necessarily thereto. Further, while the combined data composed of the natural language combined with the math formula can be directly inputted by a user's manipulation or command, it is not limited thereto. Separate external server may input document data composed of the natural language combined with the math formula. The second separation unit 420 separates the natural language and math formula from the combined data. That is, when the combined data composed of the natural language combined with the math formula is inputted through the second information input unit 410, the second separation unit 420 separately identifies the natural language and math formula included in the combined data.

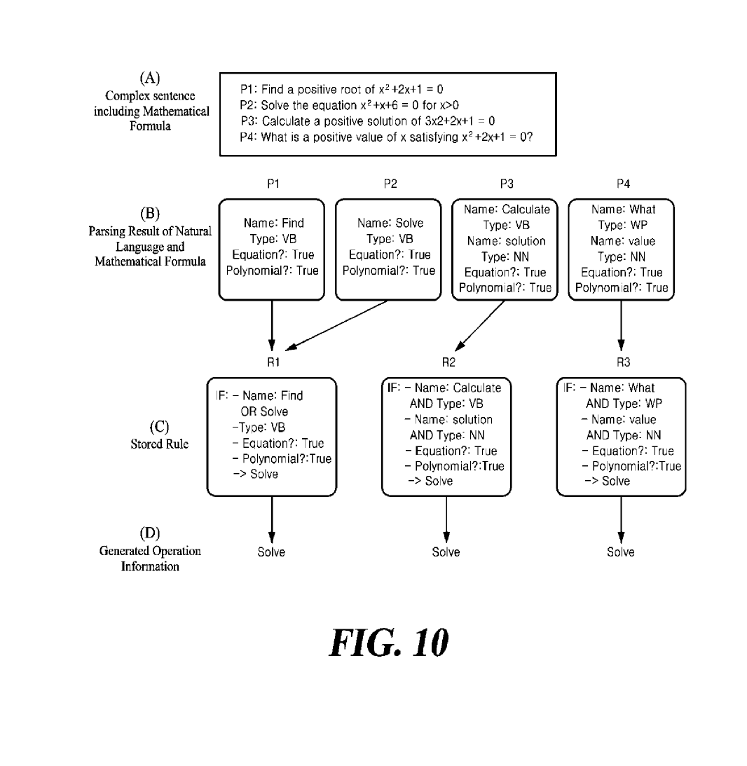

The second natural language processing unit 430 analyzes each first piece of information constituting the separated natural language and classifies each first piece of information in terms of specific meaning. Meanwhile, describing operations performed by the second natural language processing unit 430 to capture the specific meaning in more detail, the second natural language processing unit 430 may analyze the first information constituting the natural language and then capture the specific meaning using at least one of sentence structure and a key word included. That is, the second natural language processing unit 430 may operate based on a rule set in advance to capture the specific meaning, and a detailed method where the second natural language processing unit 430 analyzes the first information constituting the natural language and classifies the first information in terms of specific meaning will be described with reference to FIG. 10.

The second natural language processing unit 430 generates a language token generated by tokenizing the natural language. Here, token refers to token refers to a unit discriminable in continuous sentences, and tokenization refers to a process to divide a natural language into a word unit that the natural language and math formula processing apparatus 100 can understand. Describing the tokenization in more detail, the tokenization is generally divided into a natural language tokenization and a math formula tokenization in the second embodiment. The natural language tokenization refers to a process in which each word corresponding to the output generated by dividing the natural language included in combined data (mathematical problem) based on space is identified as a natural language token. In order to capture meaning of each token in more detail, morpheme analysis for token may be additionally performed. Meanwhile, math formula tokenization refers to a process in which individual unit information obtained after parsing a math formula included in the combined data (mathematical problem) is identified as a math formula token.

Find the function value 9y³+8y²−4y−9 with y=−1 [Exercise 1]

For example, information corresponding to the natural language token in [Exercise 1] is ‘Find’, ‘the’, ‘function’, ‘value’, and ‘with’, the math formula token may be value returned after extracting information through a parsing, polynomial, maximum degree=3, number of terms=4, and condition.

The second natural language processing unit 430 generates word filtered data generated by filtering stop words based on the natural language token, and deduplication filtered data generated by performing a deduplication filtering in the stop word filtered data. Here, the stop word means a set of words that is defined in advance in order to remove portion corresponding to unnecessary token in analysis of sentence or math formula. That is, ‘the’ (and ‘a’ or ‘to’) in [Exercise 1] is defined in advance in a dictionary format in a system. Here, the dictionary means a list including a set of words. That is, while the second natural language processing unit 430 performs a process to remove stop words that are portions not necessary to make analysis after generating the natural language token, the stop word filtering operates to prevent too much tokens from being used to the analysis process when the mathematical problem becomes long (descriptive problem or the like), and to enhance processing speed of the system.

The second natural language processing unit 430 matches action information to which a meaning defined in advance is given to the deduplication filtered data. Here, the action information means summary information that can be extracted based on the natural language token or math formula token. For example, it is possible to extract operation information of ‘solve’ on the basis of natural language token or math formula token in [Exercise 1]. Here, the reason why data corresponding to the predicate in the deduplication filtered data is matched to operation information to be stored is to obtain information for a representative operation meant by the entire sentence in the course of defining combined data (mathematical problem) as Schema and utilize the information as a useful tool when making a search or analyzing similarity between problems.

The second natural language processing unit 430 generates a natural language token by tokenizing the first information constituting the natural language. The second natural language processing unit 430 generates stop word filtered data by performing a stop word filtering that selects a natural language token determined to be stop words set in advance in the natural language token and removes the natural language token. The second natural language processing unit 430 generates deduplication filtered data by performing a deduplication filtering that selects duplicate data in the stop word filtered data and removes the data. The second natural language processing unit 430 matches data corresponding to a predicate in the deduplication filtered data to operation information to which a meaning defined in advance is given and stores the data.

The second math formula processing unit 440 analyzes each second information constituting separated math formula and classifies the information in terms of specific meaning. Meanwhile, describing the operation performed by the second math formula processing unit 440 to capture the specific meaning, the second math formula processing unit 440 may analyze the second information constituting the math formula and capture the specific meaning using information on the kind of the math formula. That is, the second math formula processing unit 440 may operate based on the rule set in advance to capture the specific meaning, and a detailed method to analyze the second information constituting the math formula and classify the information in terms of specific meaning will be described with reference to FIG. 10.

The second math formula processing unit 440 converts the math formula into a tree format, performs a traverse process to the math formula converted into the tree format, and performs a tokenization in the traverse process performed math formula. The second math formula processing unit 440 converts the math formula described in Math ML (Mathematical Markup Language) into an XML tree format and then converts the math formula into DOM (Document Object Tree) format. The second math formula processing unit 440 performs the traverse in Depth-First Search scheme in which the second information constituting the math formula is gradually transferred from the lowest node to a high node. Meanwhile, describing the traverse and depth-first search in more detail, the math formula is generally formed in Math ML format, which is constructed of a tree format. The process of traversing such a tree is referred to as a traverse process, and the depth-first search is used when performing the traverse process. Since such traverse process starts at a root of the tree, enters into child nodes, and then moves to parent nodes when the search of all child nodes is ended, all information of the child nodes are transferred to the parent nodes. It is efficient since the search is performed as many as the number of the edges in view of time complexity.

The second data management unit 450 recombines at least one of the first information analyzed through the second natural language processing unit 430, the second information analyzed through the second math formula processing unit 440, the natural language and math formula identified through the second separation unit 420 and stores the recombined information as recombined data. The second data processing unit 450 converts the recombined data into document data. Meanwhile, while the second data processing unit 440 may define XML so that the first information, the second information, and natural language and math formula are stored as an XML tree, the detailed description therefor will be omitted in the second embodiment. However, describing the XML defining the first information, the second information, and the natural language and math formula schematically, the defined XML may be classified into two portions in format, first one being ‘problem description’ portion, second one being ‘semantic’ portion that is constructed of information extracted from the natural language and math formula. Here, ‘semantic’ portion may be added or changed in the future depending on finding a new format of mathematical problem.

Further, describing XML defined in the mathematical format, the mathematical problem is constructed in a tree format to have a structure where necessary information is gathered on the semantic portion in the entire tree and used when searching for mathematical problem in the future. That is, according to the mathematical problem constructed in a tree format, mathematical contents expressed in the natural language and math formula standardized are converted into format that can be identified by the natural language and math formula processing apparatus 100, and the semantic information is extracted based on the meaning of the natural language and math formula to be structuralized in XML tree format.

Meanwhile, the natural language and math formula processing apparatus 100 may store computing resources such as hardware or software to structuralize the natural language and math formula, and provides the computing resources needed by a client to the terminal using the cloud computing. A detailed description for them will be given with reference to FIG. 9.

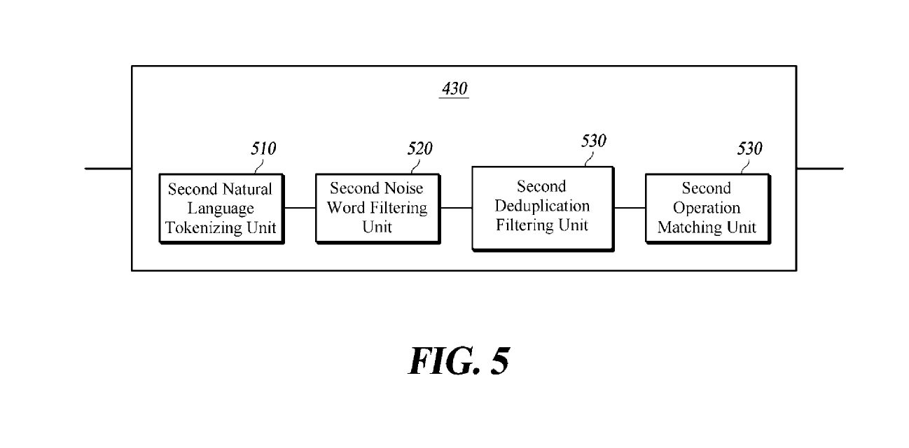

FIG. 5 is a schematic block diagram of a natural language processing unit of FIG. 4 according to a second embodiment of the present disclosure.

The second natural language processing unit 430 according to the second embodiment may include a second natural language tokenization unit 510, a second stop word filtering unit 520, a second deduplication filtering unit 530, and a second operation matching unit 540. While it is described the second embodiment includes a second natural language tokenization unit 510, a second stop word filtering unit 520, a second deduplication filtering unit 530, and a second operation matching unit 540, this is merely an exemplary description for the technical idea. Without departing from inherent properties of the second embodiment, those skilled in the art may apply the present disclosure by modifying and changing constitutional elements included in the second natural language processing apparatus 430.

The second natural language tokenization unit 510 generates a natural language token generated by tokenizing the natural language. The second natural language tokenization unit 510 generates the natural language token by tokenizing the first information constituting the natural language. Here, the natural language token refers to each word corresponding to the output generated by dividing the natural language included in combined data (mathematical problem) based on space is identified as a natural language token. For example, the natural language and math formula processing unit 100 receives natural language nodes included in the combined data individually or the entire natural language nodes at the same time, using the second natural language tokenization unit 510. Here, the natural language does not mean that nodes have a property of a sentence constructed of a plurality of words or the natural language is limited to a perfect sentence. That is, the natural language nodes are divided into word unit that can be understood by the natural language and math formula processing apparatus 100, which is called as a tokenization process. Meanwhile, the natural language node has a format in which the natural language and math formula are mixed without any order when the combined data (mathematical problems) are constructed of schema. At this time, a portion corresponding to the natural language is referred to as a natural language node. That is, a problem (schema) may include a plurality of natural language portions. [Exercise 1] includes two natural language nodes, and ‘Find the function value’ and ‘with’ become natural language node. Accordingly, in case of inputting the natural language nodes into a system, a tokenization process is performed in which the natural language nodes are divided into a unit that can be understood by the system. Here, the natural language token refers to each word corresponding to the output generated by separating the natural language included in the combined data (mathematical problem) based on a space.

The second stop word filtering unit 520 generates stop word filtered data generated by filtering stop words based the natural language token. The second stop word filtering unit 520 generates the stop word filtered data generated by performing the stop word filtering that selects and removes the natural language token determined to be stop words that are set in advance in the natural language token. Here, the stop word means a set of words that is set in advance in order to remove portions that are not necessary when analyzing sentences or math formulas. That is, ‘the’ (and ‘a’ or ‘to’) in [Exercise 1] is defined in advance in a dictionary format in a system. Here, the dictionary means a list including a set of words. That is, while the second natural language processing unit 430 performs a process to remove stop words that are portions not necessary to make analysis after generating the natural language token, the stop word filtering operates to prevent too much tokens from being used to the analysis process when the mathematical problem becomes long (descriptive problem or the like), and to enhance processing speed of the system. That is, when each first information constituting the natural language is divided into a plurality of tokens and inputted into the natural language and math formula processing apparatus 100 after the tokenization process is performed using the second stop word filtering unit 520, the natural language and math formula processing apparatus 100 proceeds to the next process, that is, a stop word removal process. In this process, unnecessary tokens are removed to extract semantic meaning. For example, while ‘this’, ‘that’, ‘here’ and ‘there’ are set as stop words, the stop word is not limited thereto. Further, setting unnecessary tokens in a sense of meaning may be determined depending on each system.

The second deduplication filtering unit 530 generates deduplication filtered data generated by performing a deduplication filtering in the stop word filtered data. The second deduplication filtering unit 530 generates deduplication filtered data generated by performing a deduplication filtering that selects and removes duplicate data in the stop word filtered data to generate the deduplication filtered data. That is, the natural language and math formula processing apparatus 100 performs a process to remove duplicate after filtering the duplicate words using the second deduplication filtering unit 530. Further, it may reduce a processing load of the natural language and math formula processing apparatus 100 by removing the overlapped words through the deduplication filtering.

The second operation matching unit 540 matches operation information to which a meaning defined in advance is given to the deduplication filtered data. The second operation matching unit 540 matches the data corresponding to a predicate in the deduplication filtered data to operation information to which a meaning defined in advance is given to be stored. Here, the operation information means summary information that can be extracted based on the natural language token or math formula token. For example, it is possible to extract operation information of ‘solve’ on the basis of natural language token or math formula token in [Exercise 1]. Here, the reason why data corresponding to the predicate in the deduplication filtered data is matched to operation information to be stored is to obtain information for a representative operation meant by the entire sentence in the course of defining combined data (mathematical problem) as Schema and utilize the information as a useful tool when making a search or analyzing similarity between problems. The natural language and math formula processing apparatus 100 analyzes properties of the combined data by way of the pre-processing, compares operations to which a meaning defined in advance is given to a token, and then stores them when they are matched. That is, the natural language and math formula processing apparatus 100 may be used to bind the math formulas included in combined data with ‘condition’ or ‘definition’ using the second operation matching unit 540 based on the result obtained in the second natural language processing unit 430, or capture semantic meaning that the math formula has.

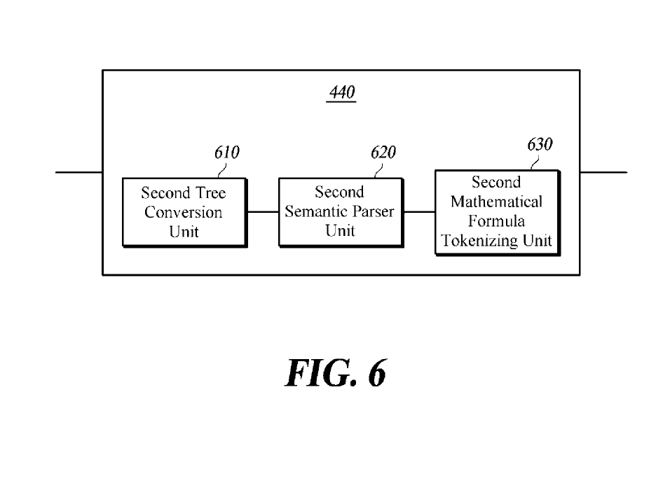

FIG. 6 is a schematic block diagram of a math formula processing unit according to a second embodiment of the present disclosure.

The second math formula processing unit 440 according to the second embodiment of the present disclosure may include a second tree converting unit 610, a second semantic parser 620, and a second math formula tokenization unit 630. Meanwhile, while the second math formula processing unit 440 may include a second tree converting unit 610, a second semantic parser 620, and a second math formula tokenization unit 630 in the second embodiment, it merely is an exemplary description of the technical idea of the second embodiment. Without departing from inherent properties of the second embodiment, those skilled in the art may apply the present disclosure by modifying and changing constitutional elements included in the second math formula processing unit 440. Here, the semantic means to understand the meaning of specific information and infer it logically in the apparatus.

The natural language and math formula processing apparatus 100 receives individual math formula prepared in a standard format through the second information input unit 410, and transfers it to the second math formula processing unit 440. That is, the math formula transferred to the math formula processing unit 440 forms in XML tag based on Math ML (Mathematical Markup Language) that is a standard defined in W2C (World Wide Web Consortium). However, it is preferable that the math formula transferred to the second math formula processing unit 440 is Math ML, but it is not limited necessarily thereto.

The second tree conversion unit 610 converts math formula into a tree format. The second tree conversion unit 610 converts math formulas prepared in each Math ML into XML tree format and then DOM format. The natural language and math formula processing apparatus 100 converts the math formula into XML tree of Math ML format using the second tree conversion unit 610, and the tree is converted into DOM so that it is converted into the tree format accessible in a program.

The second semantic parser unit 620 performs a traverse process to the math formula converted into a tree format. The second semantic parser unit 620 executes the traverse in depth first search scheme in which the second information constituting the math formula is gradually transferred from the lowest node to a high node. While the natural language and math formula processing apparatus 100 performs the traverse process in order to capture a semantic meaning of the math formula using the second semantic parser unit 620, the second semantic parser unit 620 executes the traverse using the depth first search in which information is gradually transferred from the lowest node to a high node. Accordingly, the second information gathered through the second semantic parser unit 620 is collected at the highest node all together and undergoes a process to make the token of math formula based on such information.

Describing the traverse process and the depth first search in more detail, the math formula is generally in Math ML format, which is constructed of a tree format. Such process of traversing the tree is called as a traverse process, and the depth first search is used when performing the traverse process. Since such traverse process starts from the root of the tree into the child node first and then moves to parent node when all child nodes have been searched for, all information of child nodes is transferred to the parent node. It becomes efficient in time complexity since the search is made as many as the number of edges.

The second math formula tokenization unit 630 generates math formula tokens by tokenizing the math formula to which a traverse process has been performed. Here, the math formula token refers to individual unit information that is obtained after parsing the math formula included in the combined data (mathematical problem). That is, the math formula token that is tokenized refers to a token composed of the mathematics natural language. Meanwhile, the math formula token is dealt differently from the natural language token. That is, while the second natural language processing unit 430 matches operations based on the natural language token, the second math formula processing unit 440 has the math formula as an output. The math formula token may be used for works such as finding out math formula contents through the search.

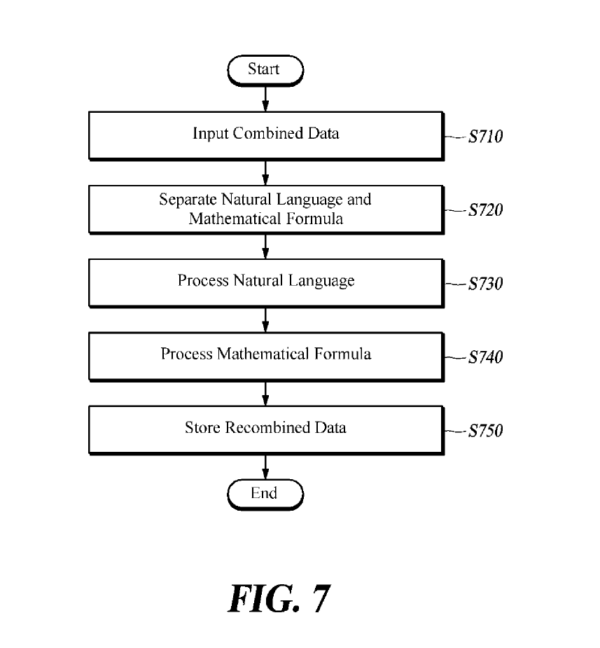

FIG. 7 is a flowchart of a method for structuralizing a natural language and a math formula according to a second embodiment of the present disclosure.

The natural language and math formula processing apparatus 100 receives combined data composed of the natural language combined with the math formula (S710). Here, the combined data composed of the natural language combined with the math formula may be directly inputted by a user's manipulation or command but it is not limited necessarily thereto. Further, the document data composed of the natural language combined with the math formula may be inputted from separate external server. The natural language and math formula processing apparatus 100 separates the natural language and math formula from the combined data (S720). That is, when the combined data composed of the natural language combined with math formula is inputted, the natural language and math formula processing apparatus 100 separately identifies the natural language and math formula included in the combined data.

The natural language and math formula processing apparatus 100 performs a process to analyze each of first information composed of separate natural language and classify the information in terms of specific meaning (S730). That is, the natural language and math formula processing apparatus 100 generates a natural language token generated by tokenizing the natural language, generates word filtered data generated by filtering stop words based on the natural language token, generates deduplication filtered data generated by performing a deduplication filtering in the stop word filtered data, and matches operation information to which a meaning defined in advance is given to the deduplication filtered data. The natural language and math formula processing apparatus 100 performs generates stop word filtered data by performing a stop word filtering that selects and removes natural language tokens determined to be stop words defined in advance in the natural language tokens. The natural language and math formula processing apparatus 100 generates the duplicate word filtered data by performing a stop word filtering that selects and removes a natural language token determined to be a stop word defied in advance in the natural language token. The natural language and math formula processing apparatus 100 generates the deduplication filtered data by performing a deduplication filtering that selects and removes data overlapped in the stop word filtered data. The natural language and math formula processing apparatus 100 matches data corresponding to a predicate among the deduplication filtered data to operation information to which a meaning defined in advance is given.

The natural language and math formula processing apparatus 100 performs a process to analyze each second piece of information constituting the separate math formula and classify the information in terms of specific meaning (S740). The natural language and math formula processing apparatus 100 converts the math formula into a tree format, performs a tokenization on the math formula that has been converted into a tree format, and performs a tokenization on the math formula to which the traverse process has been performed. The natural language and math formula processing apparatus 100 converts the math formula prepared in Math ML into XML tree format and then DOM format. The natural language and math formula processing apparatus 100 performs the traverse in a depth first search scheme in which the second information constituting the math formula is gradually transferred from the lowest node to a high node.

The natural language and math formula processing apparatus 100 recombines at least one of the first information, the second information, the natural language and math formula and stores it as recombined data (S750). The natural language and math formula processing apparatus 100 coverts the recombined data into document data. That is, by performing processes S710 to S750, the natural language and math formula may be stored as the recombined data through the natural language and math formula processing apparatus 100 and it may be possible to search for the math formula or extract the semantic caused by the math formula in the future using the recombined data stored.

Although FIG. 7 and description related thereto illustrate that the processes S710 to S750 are sequentially carried out, it is contemplated that the sequence of the processes shown in FIG. 7, in the second embodiment, is changed and modified or one or more processes among the processes S710 to S750, within the intrinsic characteristics of the second embodiment, are performed in parallel and/or omitted, and thus what is illustrated FIG. 7 is not limited to that time series sequence.

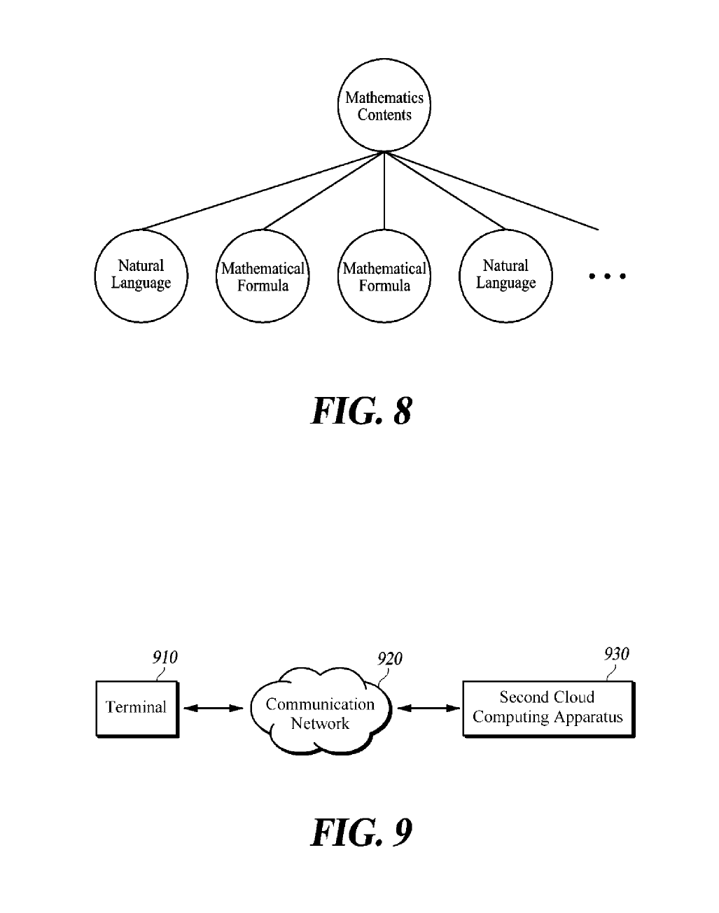

FIG. 8 is an exemplary diagram of an expression of a tree format of a math formula according to a second embodiment of the present disclosure.

Referring to FIG. 8, describing a structure of one mathematical content, child nodes connected to the root node have a format that is separated into natural language and math formula while maintaining information of word order that is one of important meanings. Further, each natural language has specific meaning depending on connection order of sentence. That is, many contents generally have a structure in which math formulas are tied together based on the natural language. For example, the structure may be that math formula following one natural language is connected in a specific condition or defined. The present disclosure can extract semantic meaning by combining natural language, as well as meaning and connection relationship of natural language of each node. That is, in order to classify operations indicating whether mathematical contents is required to solve or describe the math formula, entire natural languages are combined together so that their meaning is captured. It may be used to capture the direction of the problem.

FIG. 9 is an exemplary diagram of a system in which an apparatus for processing a natural language and a math formula provides a cloud computing apparatus with data according to a second embodiment of the present disclosure.

In order that natural language and math formula according to the second embodiment of the present disclosure provides a cloud computing with data, a system is needed which includes a terminal 910, a communication network 920 and a second cloud computing apparatus 930.

Here, the terminal 910 refers to terminals capable of transmitting/receiving various data via communication network 920 following instructions or manipulations of a user and may be one of a tablet PC, laptop computer, personal computer of PC, smartphone, personal digital assistant or PDA and mobile communication terminal. Further, the terminal 910 may be a cloud computing terminal that makes use of services such reading, writing and storing of data, and using network and contents through communication network 920. In order words, terminal 910 means a memory for storing programs for connecting with the second cloud computing apparatus 930 via communication network 920, and a microprocessor for executing the relevant programs to effect operations and controls. To be more specific, terminal 910 may be any terminals as long as they connect to communication network 920 for server-client communication with the second cloud computing apparatus 930 and encompasses any communicating computing devices including the notebook computer, mobile communication terminal, PDA, etc. Meanwhile, terminal 910 is preferably made to have a touch screen through it is not limited to that effect.

The terminal 910 may structuralize the natural language and math formula in a cloud computing scheme through a second cloud computing apparatus 930. That is, the terminal 910 may include a separate input/output interface unit that provides an input/output interface communicating with a storage medium stored in the second cloud computing apparatus 930 in order to structuralize the natural language and math formula in the second cloud computing apparatus 930, and include an interface controlling unit that performs reading and writing of data for the storage medium stored in the second cloud computing apparatus 930 through the input/output interface unit. Describing it in more detail, the terminal 910 may input combined data composed of the natural language combined with the math formula into the second cloud computing apparatus 930 through the input/output interface unit, separate the natural language and the math formula from the combined data through the second cloud computing apparatus 930, analyze each first information constituting the separated math formula and classify it in terms of specific meaning, generate/store recombined data generated by recombining one or more information among the first information, the second information, and natural language and math formula, thereby structuralizing the natural language and math formula without any application.

The communication network 920 refers to a network capable of transmitting/receiving data with an Internet protocol using various wired/wireless communication technologies such as Internet network, Intranet network, and mobile communication network, which performs a function to relay data between the terminal 910 and the second cloud computing apparatus 930. Further, the communication network 920 may be connected to the second cloud computing apparatus 930 to store computing resources such as hardware and software, and include a cloud computing network capable of providing the terminal 910 with computing resources needed in clients.

The second cloud computing apparatus 930 may be embodied based on the natural language and math formula processing apparatus 100. Further, the second cloud computing apparatus 930 may provide a cloud computing to make the terminal 910 perform reading and writing of data from and to the storage medium stored in the second cloud computing apparatus 930 in order to structuralize the natural language and math formula through the cloud computing terminal 910, separate the natural language and math formula from the combined data when the combined data composed of the natural language combined with the math formula inputted, analyze the first information constituting the separated natural language and classify the information in terms of specific meaning, analyze the second information constituting the separated math formula and classify the information in terms of specific meaning, store computer readable record medium that generates recombined data generated by recombining at least one of the first information, the second information, natural language and math formula, transmit only a portion of data of the record medium to the terminal 910, and structuralize the natural language and math formula without installing an application in the terminal 910. That is, the second cloud computing apparatus 930 may additionally include a cloud computing unit that makes the storage unit and terminal 910 perform reading and writing of data for the storage medium in order to structuralize the natural language and math formula in a cloud computing scheme.

FIG. 10 is an exemplary diagram of a method for analyzing information constituting a natural language and a math formula and classifying the information in terms of a specific meaning according to a second embodiment of the present disclosure.

Describing the operation performed by the second natural language processing unit 430 and the second math formula processing unit 440 to capture a specific meaning in more detail, the second natural language processing unit 430 and the second math formula processing unit 440 may analyze each of constitutional information constituting the natural language and math formula, and capture a specific meaning suing at least one of information of a sentence structure, information on keyword included and information on kind of the math formula, thereby generating semantic information classified by the specific meaning captured.

The second natural language processing unit 430 and the second math formula processing unit 440 may operate based on a rule set in advance and capture a specific meaning. Describing it in more detail, in the case that four mathematical sentences P1, P2, P3 and P4 each composed of a natural language combined with a math formula as illustrated in FIG. 10(A), there may be generated an output resulted by analyzing (parsing) the first information constituting a natural language and the second information constituting a math formula using the second natural language processing unit 430 and the second math formula processing unit 440 as illustrated in FIG. 10B.

For example, in case of P1, as a result of analyzing the first information constituting the natural language using the second natural language processing unit 430, it is indicated that the math formula name is “Find” and its type is a verb (VB). Further, as a result of analyzing the second information constituting the math formula using the second math formula processing unit 440, it is indicated that Equation is true, and Polynomial is true. As illustrated in FIG. 10(C), comparing this with a logical condition of a rule stored, it is indicated that R1 among R1, R2 and R3 is matched. Accordingly, as illustrated in FIG. 10(D), “Solve” being operation information satisfying the logical condition is extracted as operation information from the matched rule. That is, in this case, it is possible that a specific meaning indicated by P1 is identified as an operation index to be extracted.

The second natural language processing unit 430 or the second math formula processing unit 440 may extract all operation information satisfying logical condition of the rule stored in advance. While the logical condition composed of the natural language combined with the math formula may satisfy various logical conditions of a rule stored, this case is that one mathematical problem includes several operation information. When a combination composed of the natural language token combined with math formula token does not satisfy any logical condition, it is determined that the complex sentence is an item that is omitted when analyzing a mathematical sentence (combined data) in generation of a rule or that is not included in an analysis process, or is an erroneous mathematical sentence. Further, the second natural language processing unit 430 or the second math formula processing unit 440 may match the math formula to be an object of the natural language token generated as a result of the natural language parsing to the math formula token(s).

### Third Embodiment

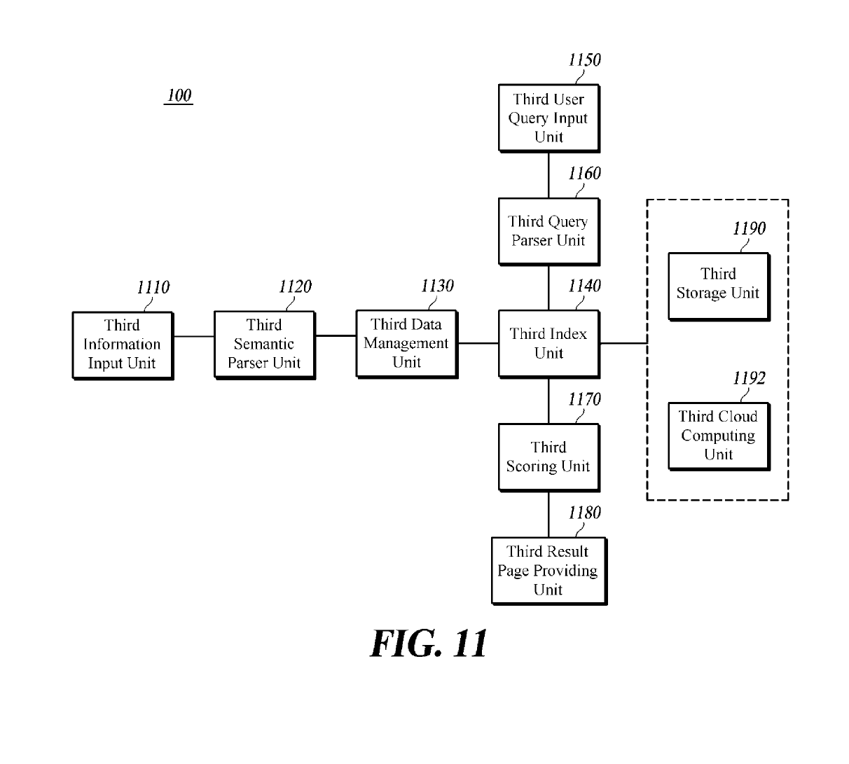

Hereinafter, a third embodiment will be described which is a method and apparatus for providing a natural language and a math formula with reference to FIGS. 11 to 17.

A natural language and math formula processing apparatus 100 described in the third embodiment refers to an apparatus for indexing user's query structuralized information together with semantic information based on the semantic information when structuralizing each natural language and math formula in combined data composed of the natural language combined with the math formula, and the natural language and math formula processing apparatus 100 may be embodied with hardware or software, and installed on a server or a terminal.

FIG. 11 is a schematic block diagram of an apparatus for processing a natural language and a math formula according to a third embodiment of the present disclosure.

The natural language and math formula processing apparatus 100 in accordance with the third embodiment may include a third information input unit 1110, a third semantic parser unit 1120, a third data management unit 1130, a third index unit 1140, a third user query input unit 1150, a third parser unit 1160, a third scoring unit 1170, a third result page providing unit 1180, a third storage unit 1190 and a third cloud computing unit 1192. Meanwhile, while the third embodiment describes that the natural language and math formula processing apparatus 100 only includes a third information input unit 1110, a third semantic parser unit 1120, a third data management unit 1130, a third index unit 1140, a third user query input unit 1150, a third parser unit 1160, a third scoring unit 1170, a third result page providing unit 1180, a third storage unit 1190 and a third cloud computing unit 1192, it merely is an exemplary description for a technical idea of the third embodiment, and those skilled in the art may apply the present disclosure by modifying and changing constitutional elements included in the natural language and math formula processing apparatus 100 without departing from inherent properties of the third embodiment.

The third information input unit 1110 receives combined data composed of the natural language combined with the math formula. Here, it is preferable that the combined data is mathematical contents including mathematical problem and mathematical proofs, but the combined data is not limited thereto. Further, the combined data composed of the natural language combined with the math formula may be directly inputted by a user's manipulation or command, but it is not limited thereto. The document data composed of the natural language and the math formula may be inputted from a separate external server.

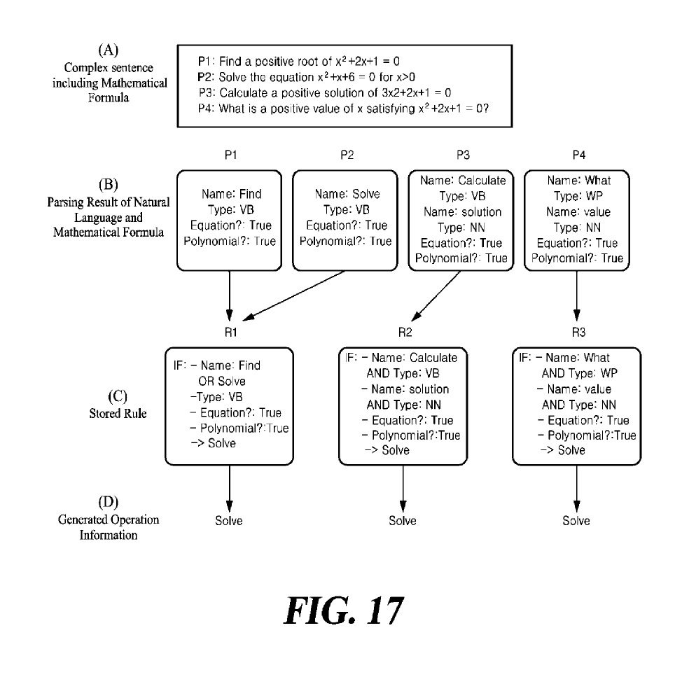

The third semantic parser unit 1120 separates the natural language and the math formula from the combined data, and generates semantic information that analyzes each of constitution information constructing the separated natural language and math formula and classifies the information in terms of specific meaning. Here, the semantic information may include at least one of an operation index, a semantic index, and a problem list index, and a problem list may be arranged by a problem ID. Meanwhile, describing an operation performed by the third semantic parser unit 1120 to capture a specific meaning in more detail, the third semantic parser unit 1120 analyzes each of the constitutional information constituting the natural language and math formula, and then captures a specific meaning using at least one of information on a structure of sentence, information on a keyword included and information on a kind of the math formula. That is, the third semantic parser unit 1120 may operate based on a rule set in advance to capture a specific meaning. A detailed method that the third semantic parser unit 1120 analyzes each of the constitutional information constituting the natural language and math formula and classifies the information in terms of specific meaning will be described with reference to FIG. 17.

Further, describing operations performed by the third semantic parser unit 1120 to analyze each of the constitutional information constituting the natural language and math formula in more detail, the third semantic parser unit 1120 separates the natural language and the math formula from the combined data. That is, when combined data composed of the natural language combined with the math formula is inputted through the third information input unit 1110, the third semantic parser unit 1120 separately identifies the natural language and math formula included in the combined data. The third semantic parser unit 1120 analyzes each of the constitutional information constituting the separated natural language and classifies the information in terms of specific meaning. Here, token refers to a unit discriminable in continuous sentences, and tokenization refers to a process to divide a natural language into a word unit that the natural language and math formula processing apparatus 100 can understand. Describing the tokenization in more detail, the tokenization is generally divided into a natural language tokenization and a math formula tokenization in the third embodiment. The natural language tokenization refers to a process in which each word corresponding to the output generated by dividing the natural language included in combined data (mathematical problem) based on space is identified as a natural language token. In order to capture meaning of each token in more detail, morpheme analysis for token may be additionally performed. Meanwhile, math formula tokenization refers to a process in which individual unit information obtained after parsing a math formula included in the combined data (mathematical problem) is identified as a math formula token.

Find the function value 9y³+8y²−4y−9 with y=−1 [Exercise 1]

For example, information corresponding to the natural language token in [Exercise 1] is ‘Find’, ‘the’, ‘function’, ‘value’, and ‘with’, the math formula token may be value returned after extracting information through a parsing, polynomial, maximum degree=3, number of terms=4, and condition.

The third semantic parser unit 1120 generates a natural language token by performing a tokenization for constitutional information constituting a natural language, and stop word filtered data by performing a stop word filtering to select and remove a natural language token determined to be a stop word set in advance in the natural language token. Here, the stop word means a set of words that is defined in advance in order to remove portion corresponding to unnecessary token in analysis of sentence or math formula. That is, ‘the’ (and ‘a’ or ‘to’) in [Exercise 1] is defined in advance in a dictionary format in a system. Here, the dictionary means a list including a set of words. That is, while the third semantic parsing unit 1120 performs a process to remove stop words that are portions not necessary to make analysis after generating the natural language token, the stop word filtering operates to prevent too much tokens from being used to the analysis process when the mathematical problem becomes long (descriptive problem or the like), and to enhance processing speed of the system.

The third semantic parser unit 1120 matches operation information to which a meaning defined in advance is given to deduplication filtered data. Here, the action information means summary information that can be extracted based on the natural language token or math formula token. For example, it is possible to extract operation information of ‘solve’ on the basis of natural language token or math formula token in [Exercise 1]. Here, the reason why data corresponding to the predicate in the deduplication filtered data is matched to operation information to be stored is to obtain information for a representative operation meant by the entire sentence in the course of defining combined data (mathematical problem) as Schema and utilize the information as a useful tool when making a search or analyzing similarity between problems.

The third semantic parser unit 1120 generates a natural language token by tokenizing the first information constituting the natural language. The third semantic parser unit 1120 generates stop word filtered data by performing a stop word filtering that selects a natural language token determined to be stop words set in advance in the natural language token and removes the natural language token. The third semantic parser unit 1120 generates deduplication filtered data by performing a deduplication filtering that selects duplicate data in the stop word filtered data and removes the data. The third semantic parser unit 1120 matches data corresponding to a predicate in the deduplication filtered data to operation information to which a meaning defined in advance is given and stores the data.

The third semantic parser unit 1120 analyzes each of the constitutional information constituting the separated math formula and classifies in terms of specific meaning. The third semantic parser unit 1120 converts the math formula into a tree format, performs a traverse process in the math formula converted into a tree format, and performs a tokenization to the math formula performed in the traverse process. The third semantic parser unit 1120 converts the math formula prepared in Math ML into a XML tree format and then into DOM format. The third semantic parser unit 1120 performs the traverse in a depth-first search scheme in which constitutional information constituting the math formula is gradually transferred from the lowest node to a high node. Meanwhile, describing the traverse and depth-first search in more detail, the math formula is generally formed in Math ML format, which is constructed of a tree format. The process of traversing such a tree is referred to as a traverse process, and the depth-first search is used when performing the traverse process. Since such traverse process starts at a root of the tree, enters into child nodes, and then moves to parent nodes when the search of all child nodes is ended, all information of the child nodes are transferred to the parent nodes. It is efficient since the search is performed as many as the number of the edges in view of time complexity.

The third data management unit 1130 recombines at least one of the construction information, the natural language information, the math formula and semantic information and stores the information as recombined data. The third data management unit 1130 converts the recombined data as document data. The third index unit 1140 performs a indexing to give numbers to the semantic information received through the third semantic parser unit 1120 and the third data management unit 1130, generates semantic index information generated by indexing the semantic information, and generates query index information generated by matching information on the keyword to the semantic index information.

That is, the third information input unit 1110 math formula that is content based Math ML that being a structure of XML format included in the combined data that is inputted through the third information input unit 1110 is inputted into the third semantic parser unit 1120, extracts semantic information of natural language and math formula based on the XML input, and is drawn as XML result by the third data management unit 1130. That is, the XML result including the semantic information is indexed after being indexed by the third index unit 1140.

The third user query input unit 1150 transfers the user query inputted to the third query parser unit 1160. Here, the user query is a kind of search query, which includes a key word inputted by a user to search for. The third query parser unit 1160 extracts and structuralizes the key word included in the user query inputted. The third scoring unit 1170 scores the query index information based on the similarity between the key word and the semantic index information. The third scoring unit 1170 uses Cosine Similarity to perform the scoring. Further, the third scoring unit 1170 may perform the scoring using Equation 1.

$$cos ( q , p ) = \frac{q \cdot p}{\vert q \vert \vert p \vert} = \frac{q}{\vert q \vert} \cdot \frac{p}{\vert P \vert} = \frac{{\sum }_{i = 1}^{\vert V \vert} {q}_{i} {p}_{i}}{\sqrt{{\sum }_{i = 1}^{\vert V \vert} {q}_{i}^{2}} \sqrt{{\sum }_{i = 1}^{\vert V \vert} {p}_{i}^{2}}} \qquad Equation 1$$

(p: problem vector, q: query vector, pi: weight of i in Boolean/query q, v: number of element in vector)

The third result page providing unit 1180 provides a ranking result page of query index information that is scored by the third scoring unit 1170. Here, the third result page providing unit 1180 may provide a server or a terminal requesting a scoring result page with the scoring result page, but the unit is not limited thereto. When the natural language and math formula processing apparatus 100 is embodied in a stand-alone apparatus, the ranking result page may appear through the display unit included.

That is, the user query inputted through third user query input unit 1150 is parsed in the query parser unit 1160 and transferred to the third index unit 1140. The third scoring unit 1170 compares an index for the mathematical contents stored in advance with an index of the user query to perform a scoring. The third result page providing unit 1180 outputs a scoring on the user result page.

Meanwhile, the natural language and math formula processing apparatus 100 may include a separate third storage unit 1190 and third cloud computing unit 1192 to include a cloud computing that indexes information generated by structuralizing the user query together when structuralizing the data composed of the natural language combined with the math formula without installing application in a terminal corresponding to the client. Here, the third storage unit 1190 separates the natural language and math formula from the combined data when receiving combined data composed of the natural language combined with the math formula inputted, generates semantic information to analyze each of constitutional information constituting the separated natural language and math formula and classify the information in terms of specific meaning, recombines at least one of the construction information, natural language, math formula an semantic information and stores the recombined information as recombined data, extracts and structuralizes a keyword included in the user query inputted, generates semantic index information generated by indexing the semantic information, and stores storage medium to generate query index information generated by matching information on the keyword to the semantic index information. Further, the third cloud computing unit 1192 makes the terminal corresponding to the client perform reading and writing of data with respect to storage data stored in the third storage unit 1190.

That is, when structuralizing data composed of natural language combined with math formula through the third storage unit 1190 and the third cloud computing unit 1192, the natural language and math formula processing apparatus 100 may support computing resources such as hardware or software to index the information generated by structuralizing the user query together, and provides the computing resources needed by the client to the terminal using the cloud computing. Detailed description related with the above will be given with reference to FIG. 16.

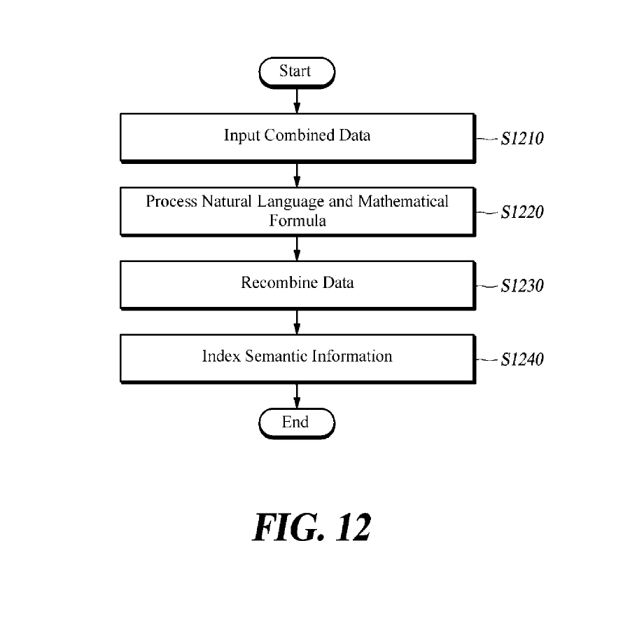

FIG. 12 is a flowchart of a method for indexing a natural language and a math formula according to a third embodiment of the present disclosure.

The natural language and math formula processing apparatus 100 receives combined data composed of natural language combined with math formula (S1210). Here, the combined data composed of natural language combined with math formula may be directly inputted by a user's manipulation or command but it is not limited thereto. The document data composed of natural language and math formula may be inputted from a separate external server.

The natural language and math formula processing apparatus 100 separates the natural language and math formula from the combined data, and generates semantic information to analyze each of the constitutional information constituting the separated natural language and math formula and classifies the information in terms of specific meaning (S1220). Describing in more detail, the natural language and math formula processing apparatus 100 separates the natural language and math formula from the combined data. That is, when the combined data composed of natural language combined with math formula is inputted, the natural language and math formula processing apparatus 100 separately identifies the natural language and math formula included in the combined data. The natural language and math formula processing apparatus 100 performs a process to analyze each of first information composed of separate natural language and classify the information in terms of specific meaning. That is, the natural language and math formula processing apparatus 100 generates a natural language token generated by tokenizing the natural language, generates word filtered data generated by filtering stop words based on the natural language token, generates deduplication filtered data generated by performing a deduplication filtering in the stop word filtered data, and matches operation information to which a meaning defined in advance is given to the deduplication filtered data. The natural language and math formula processing apparatus 100 performs a tokenization with respect to constitutional information constituting the natural language and generates a natural language token. The natural language and math formula processing apparatus 100 performs a stop word filtering that selects and removes a natural language token determined to be stop words set in advance in the natural language token and generates stop word filtered data. The natural language and math formula processing apparatus 100 generates the deduplication filtered data by performing a deduplication filtering that selects and removes duplicate data in stop word filtered data. The natural language and math formula processing apparatus 100 matches data corresponding to a predicate among the deduplication filtered data to operation information to which a meaning defined in advance is given. The natural language and math formula processing apparatus 100 performs a process to analyze each of constitutional information constituting the separated math formula and classify the information in terms of specific meaning.

The natural language and math formula processing apparatus 100 converts the math formula into a tree format, performs a traverse process to the math formula that has been converted into a tree format, and performs tokenization to the math formula to which the traverse process has been performed. The natural language and math formula processing apparatus 100 converts the math formula prepared in Math ML into a XML tree format and then into DOM format. The natural language and math formula processing apparatus 100 performs the traverse in the depth-first search scheme in which constitutional information constituting the math formula is gradually transferred from the lowest node to a high node.

The natural language and math formula processing apparatus 100 recombines at least one of constitutional information, natural language, math formula and semantic information and stores them as recombined data (S1230). The natural language and math formula processing apparatus 100 converts the recombined data into document data. The natural language and math formula processing apparatus 100 indexes the semantic information (S1240). For example, the natural language and math formula processing apparatus 100 performs an indexing in which a number is given to the semantic information.

Although FIG. 12 and description related thereto illustrate that the processes S1210 to S1240 are sequentially carried out, it is contemplated that the sequence of the processes shown in FIG. 12, in the third embodiment, is changed and modified or one or more processes among the processes S1210 to S1240, within the intrinsic characteristics of the third embodiment, are performed in parallel and/or omitted, and thus what is illustrated FIG. 12 is not limited to that time series sequence.

The method for providing a natural language and a math formula according to the third embodiment as described above and shown in FIG. 12 may be implemented as a program on a computer-readable recording medium. The computer-readable recording medium storing the program for realizing the method for providing a natural language and a math formula according to the fourth embodiment of the present disclosure may be any data storage devices that can store data which can be thereafter read by a computer system. The computer-readable recording medium, in one or more embodiments, includes any kinds of recording devices suitable for recording data readable by computers. Examples of the computer-readable recording medium include a ROM, a RAM, flash memory, a CD-ROM, a magnetic tape, a floppy disc, an optical data storage device. The computer-readable recording medium may also be distributed over network coupled computer systems so that computer-readable codes are stored and executed in a distributed fashion. In addition, functional programs, codes, and code segments for accomplishing the fourth embodiment of the present disclosure may be easily construed by programmers skilled in the art to which the third embodiment pertains.

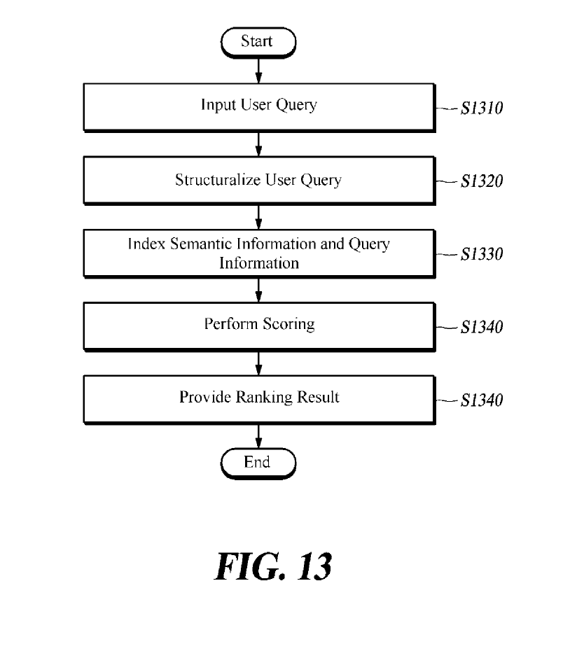

FIG. 13 is a flowchart of a method for providing a ranking of indexed query information according to a third embodiment of the present disclosure.

The natural language and math formula processing apparatus 100 receives a user's query inputted (S1310). Here, the user query is a kind of search query, which includes a key word inputted by a user to search for. The natural language and math formula processing apparatus 100 extracts and structuralizes the key word included in the user query inputted (S1320). The natural language and math formula processing apparatus 100 generates query index information generated by matching keyword information to semantic index information generated by indexing the semantic information (S1330).

The natural language and math formula processing apparatus 100 scores the query index information based on the similarity between the key word and the semantic index information. The third scoring unit 1170 uses Cosine Similarity to perform the scoring. Further, the third scoring unit 1170 may perform the scoring using [Mathematical equation 1]. The natural language and math formula processing apparatus 100 provides a ranking result page of query index information that is scored by the third scoring unit 1170. Here, the third result page providing unit 1180 may provide the ranking result page to a server or a terminal that requests the ranking result page, but it is not limited thereto. When the natural language and math formula processing apparatus 100 is embodied with a stand-along apparatus, the ranking result page may be appeared through the display provided.

Although FIG. 13 and description related thereto illustrate that the processes S1310 to S1350 are sequentially carried out, it is contemplated that the sequence of the processes shown in FIG. 13, in the third embodiment, is changed and modified or one or more processes among the processes S1310 to S1350, within the intrinsic characteristics of the third embodiment, are performed in parallel and/or omitted, and thus what is illustrated FIG. 13 is not limited to that time series sequence.

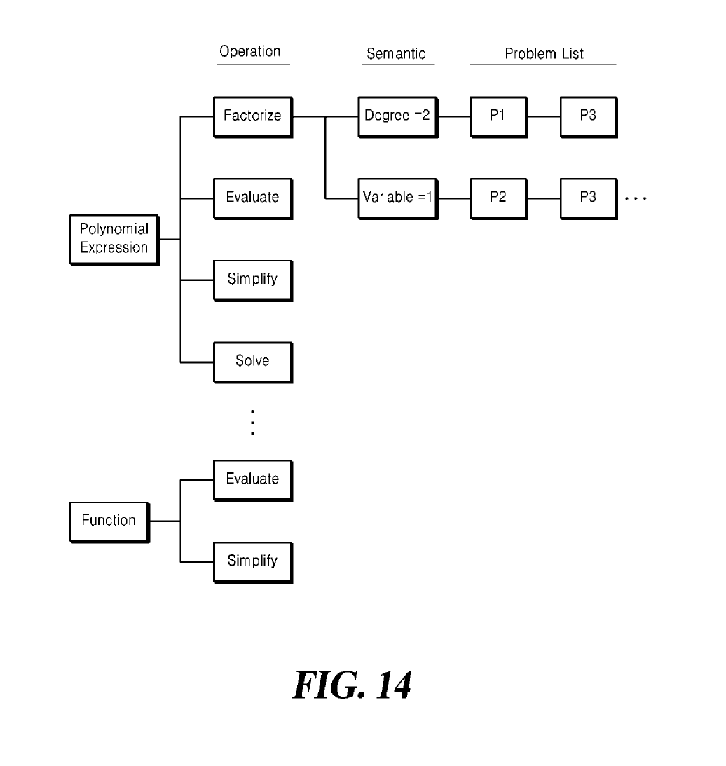

FIG. 14 is an exemplary view of an inversed file structure included in semantic information according to a third embodiment of the present disclosure.

An index of inverted file structure included in semantic information that is generated through the semantic parser unit 1120 of the natural language and math formula processing apparatus 100 is as illustrated in FIG. 14. Meanwhile, the third embodiment does not mention XML format of the semantic information used in the inverted file structure. However, it is assumed that the function format, operation and semantic keyword are all stored in a format of hierarchical structure. That is, the semantic information may include at least one of the operation index, semantic index, an problem list index and the problem list is arranged as problem ID. Accordingly, two lists may be merged by linear time.

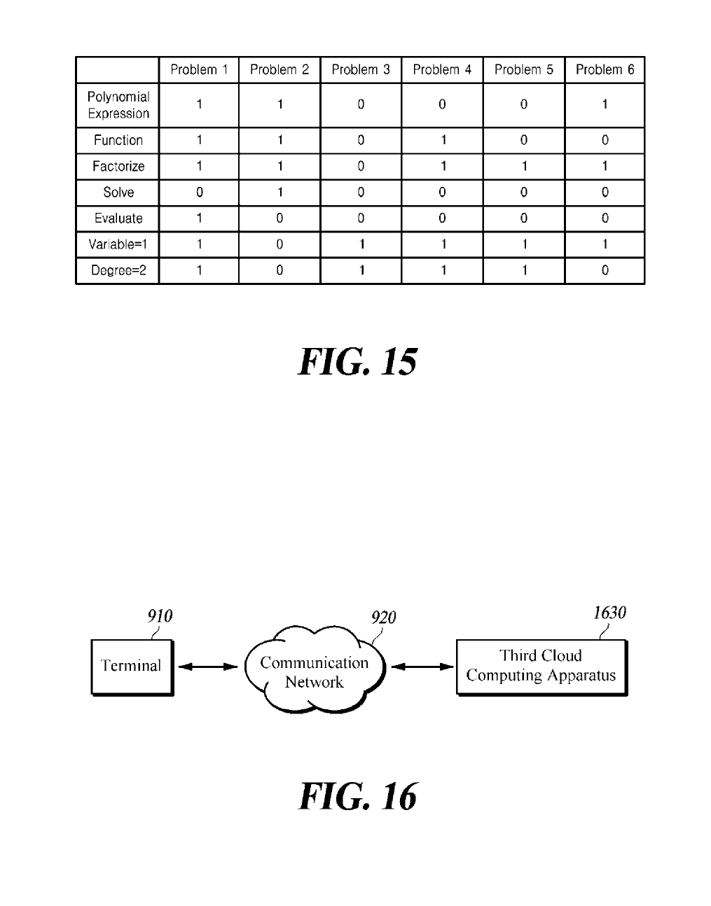

FIG. 15 is an exemplary diagram in which an index included in semantic information is expressed in a full-vector according to a third embodiment of the present disclosure.

The natural language and math formula processing apparatus 100 may use Cosine Similarity to perform a scoring. That is, expressing an index included in semantic information as a Boolean Vector, it is as illustrated in FIG. 15. Here, a value ‘0’ indicates that there is no identical ‘term’ or ‘keyword’ in a relevant column, or there is no relationship with the problem in the row. On the other hand, a value ‘1’ indicates that there is an identical ‘term’ or ‘keyword’ in a relevant column, or there is no relationship with the problem in the row. When using such matrix, it is possible to produce a cosine angle between two problem vector p and query vector q, and an expression to produce the cosine angle is like [Mathematical equation 1].

That is, cos (q,p) in [Math formula] refers to a cosine similarity of q and p, or a cosine angle of q and p. Since cosine is a monotone decreasing function in ‘0°’, ‘180°’, it can be said that two problems are similar when a relevant value is small or large. Further, weight may be applied instead of Boolean format. For example, much more weight may be given to an action or mathematical object that has a significant meaning, among the semantic information. Further, a function that is not frequent relatively is given a smaller weight compared with a function that is frequent. Such can be formularized as follows.

That is, a problem frequency means the number of problems to which ‘term’ and ‘keyword’ are given, and a relevant value means a value opposite to term information. In order to express the relevant value, an inverse problem frequency, ipf, is used. Here, ipf may be calculated using N/pf, where N indicates the number of entire problems. Using index of combined data (mathematical contents) composed of user's query combined with natural language and math formula, the similarity may be analyzed, and then outputted through a display in an order obtained by calculating ranking. Accordingly, an identification may be made staring from the document including the math formula nearest to the user's query to the document similar thereto.

FIG. 16 is an exemplary diagram of a system in which an apparatus for processing a natural language and a math formula provides a cloud computing apparatus with data according to a third embodiment of the present disclosure.

In order to provide data using a cloud computing according to the third embodiment, a system including a terminal 910, a communication network 920 and a third cloud computing apparatus 1600 is needed.

Here, terminal 910 refers to terminals capable of transmitting/receiving various data via communication network 920 following instructions or manipulations of a user and may be one of a tablet PC, laptop computer, personal computer or PC, smartphone, personal digital assistant or PDA and mobile communication terminal. Further, the terminal 910 may be a cloud computing terminal that supports a cloud computing to use services such as reading, writing and storing of data, network, and contents usage through the communication network 920. In other words, terminal 910 means a memory for storing programs for connecting with the third cloud computing apparatus 1600 via communication network 920, and a microprocessor for executing the relevant programs to effect operations and controls. To be more specific, terminal 910 may be any terminals as long as they connect to communication network 920 for server-client communication with the second cloud computing apparatus 930 and encompasses any communicating computing devices including the notebook computer, mobile communication terminal, PDA, etc. Meanwhile, the terminal 930 is preferably made to have a touch screen, but it is not limited thereto.

When structuralizing data composed of natural language combined with math formula through the third cloud computing apparatus 1600 in a cloud computing scheme, the terminal 910 makes information generated by structuralizing the user query indexed together. That is, the terminal 910 may include a separate input/output interface unit that provides an input/output interface to storage medium stored in the third cloud computing apparatus 1600 in order to structuralize the natural language and math formula in a cloud computing scheme from the third cloud computing apparatus 1600, and an interface controlling unit to enable reading and writing of data for the storage medium stored in the third cloud computing apparatus 1600 to be performed through the input/output interface. Describing it in more detail, the terminal 910 may input combined data composed of the natural language combined with the math formula to the third cloud computing apparatus 1600 through the input/output interface unit, and accordingly make the third cloud computing apparatus 1600 to generate/store query index information generated by matching keyword information to the semantic index information. Therefore, when the terminal 910 structuralizes data composed of the natural language combined with the math formula, it makes information generated by structuralizing a user query indexed together without installing any application.

The communication network 920 refers to a network capable of transmitting/receiving data with Internet protocol using various wired/wireless communication technologies such as Internet network, Intranet network, mobile communication network, and satellite communication network, which performs a function to relay data between the terminal 910 and the third cloud computing apparatus 1600. Further, the communication network 920 may include a cloud computing network that may be coupled with the third cloud computing apparatus 1600 to store computing resources such as hardware and software, and provide the terminal 910 with computing resources needed by a client.

The third cloud computing apparatus 1600 may be embodied based on the natural language and math formula processing apparatus 100. Further, the third cloud computing apparatus 1600 may provide a cloud computing to make the terminal 910 perform reading and writing of data with respect to storage medium stored in the third cloud computing apparatus 1600 in order to make information generated by structuralizing a user's query indexed together when structuralizing combined data composed of the natural language combined with the math formula through the terminal 910 using the cloud computing, separate the natural language and math formula from the combined data when the combined data composed of the natural language combined with the math formula is inputted, generate semantic information to analyze each of constitutional information constituting the separated natural language and classify the information in terms of specific meaning, recombine at least one of construction information, natural language, math formula and semantic information and store the recombined information as recombined data, generate semantic index information generated by indexing the semantic information, store computer readable record medium that generate query index information generated by matching keyword information to the semantic index information, transmit a portion of the record medium only to the terminal 910, and index information generated by structuralizing the user's query together when the terminal 910 structuralizes data composed of the natural language combined with the math formula without installing any application.

FIG. 17 is an exemplary diagram of a method for analyzing information constituting a natural language and a math formula and classifying the information in terms of specific meaning according to a third embodiment of the present disclosure.

Describing operation that the third semantic parser unit 1120 performs to capture a specific meaning in more detail, the third semantic parser unit 1120 may analyze each of constitutional information constituting the natural language and math formula, capture a specific meaning using at least one information of structure of sentence, keyword included and kind of math formula, and generate semantic information classified using the captured specific meaning.

The third semantic parser unit 1120 operates based on a rule set in advance to capture a specific meaning. Describing it in more detail, when four mathematical sentences composed of natural language and math formula, P1, P2, P3 and P4, are inputted through the third information input unit 1110 as illustrated in FIG. 17(A), a result generated by analyzing each of constitutional information constituting the natural language and math formula by the third semantic parser unit 1120 may be generated as illustrated in FIG. 17(B).

For example, in case of P1, as a result of analyzing the first information constituting the natural language using the third natural language processing unit 1120, it is indicated that the math formula name is “Find” and it type is a verb (VB). Further, as a result of analyzing the second information constituting the math formula using the third semantic parsing unit 1120, it is indicated that Equation is true, and Polynomial is true. As illustrated in FIG. 17(C), comparing this with a logical condition of a rule stored, it is indicated that R1 among R1, R2 and R3 is matched. Accordingly, as illustrated in FIG. 17(D), “Solve” being operation information satisfying the logical condition is extracted as operation information from the matched rule. That is, in this case, it is possible that a specific meaning indicated by P1 is identified as an operation index to be extracted.

The third natural language processing unit 1120 may extract all operation information satisfying logical condition of the rule stored in advance. While the logical condition composed of the natural language combined with the math formula may satisfy various logical conditions of a rule stored, this case is that one mathematical problem includes several operation information. When a combination composed of the natural language token combined with math formula token does not satisfy any logical condition, it is determined that the complex sentence is an item that is omitted when analyzing a mathematical sentence (combined data) in generation of a rule or that is not included in an analysis process, or is an erroneous mathematical sentence. Further, the third semantic parsing unit 1120 may match the math formula to be an object of the natural language token generated as a result of the natural language parsing to the math formula token(s).

### Fourth Embodiment

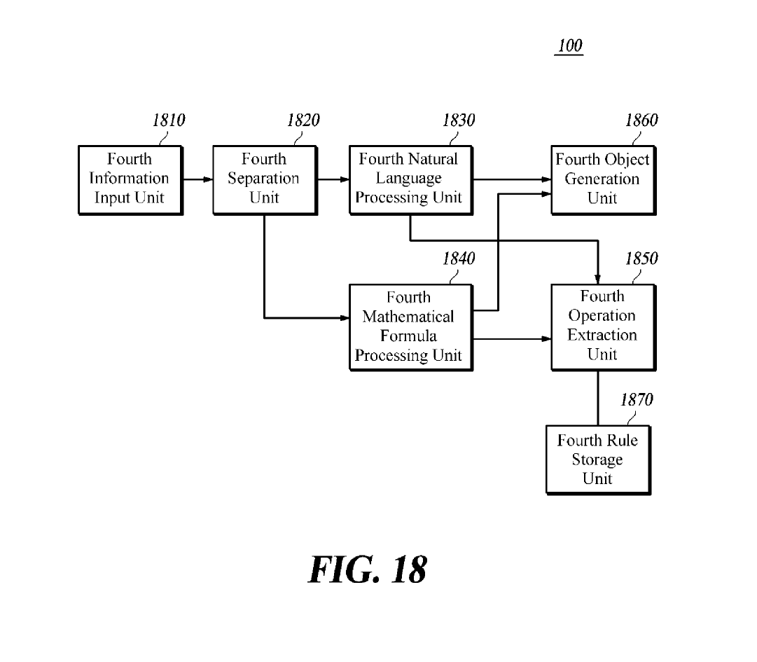

Hereinafter, a fourth embodiment for a method and apparatus for extracting semantic information of a complex sentence including a natural language and a math formula will be described with reference to FIGS. 18 to 25.

FIG. 18 is a schematic block diagram of an apparatus for processing a natural language and a math formula of a complex sentence according to a fourth embodiment of the present disclosure.

A natural language and math formula processing apparatus 100 according to a fourth embodiment may be comprised of a fourth information input unit 1810, a fourth separation unit 1820, a fourth natural language processing unit 1830, a fourth math formula processing unit 1840, a fourth operation extraction unit 1850, a fourth object generation unit 1860 and a fourth rule storage unit 1870.

The fourth information input unit 1810 receives a complex sentence including the natural language and math formula. The fourth separation unit 1820 separates the natural language and math formula from the complex sentence. The fourth natural language processing unit 1830 tokenizes the separated natural language and generates a natural language token. The fourth math formula processing unit 1840 parses the separated math formula, extracts semantic meaning and generates a math formula token. The fourth rule storage unit 1870 stores a rule generated by coupling a combination of the natural language and math formula to operation information corresponding the combination. The fourth operation extraction unit 1850 extracts operation information of the complex sentence from the rule stored in the fourth rule storage unit 1870 by comparing the generated natural language token and math formula token with the combination of the natural language and math formula in the stored rule. The fourth object generation unit 1860 generates a math formula object matches math formula being a target of the natural language token to the math formula token(s) generated in the fourth math formula processing unit 1840 so as to generate a mathematical object.

When generating the mathematical object, in order to extract and express an actual meaning of the mathematical sentence constructed of a complex sentence including a math formula as well as a natural language, following processes will be performed.

1. Process of constructing a token relationship of math formula and natural language

2. Process of reading out a sentence expressing the natural language and math formula and finding out operation information that the mathematical sentence means

3. Process of constructing a mathematical object

Semantic information in the mathematical sentence may include operation information and a mathematical object. Further, action information expresses a target that a mathematical problem basically solves. For example, it is information extracted from the problem based on information with which a person who actually solves the problem can take an action regarding whether the math formula sentence is for problem solving or concept description. The information may experience a pre-processing through a token of the natural language and math formula and be generated by a defined rule.

The mathematical object is used to express each segmented entity included in the mathematical problem. That is, the mathematical object indicates what technique or fact is needed to solve this mathematical problem, and what type of function is entered into the mathematical problem. The concept of object may be helpful in an expendability to support a diversity of mathematical problem. Information obtained in the natural language and math formula each may be converted into mathematical object.

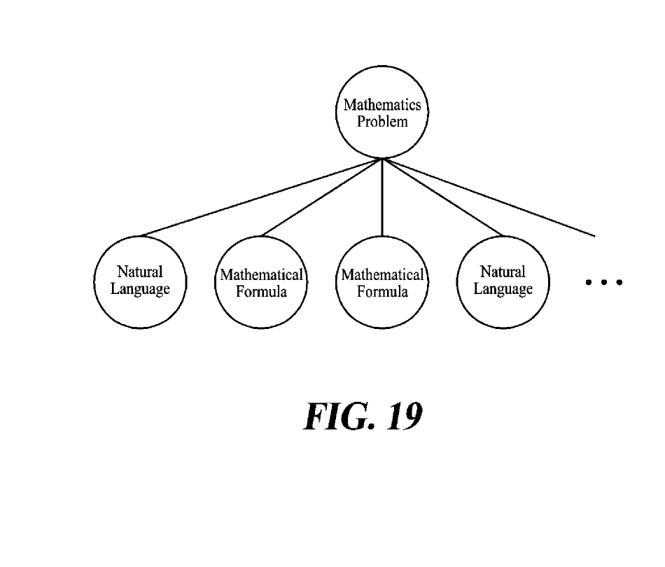

FIG. 19 is a diagram in which a format constituting a mathematical problem is exemplified in a tree structure according to a fourth embodiment of the present disclosure. As illustrated in FIG. 19, when expressing a structure that can be taken by a mathematical content as a tree, child nodes constituting relevant mathematical contents (root node) have a format separated into natural language and math formula while maintaining word order information being one of important meanings as it is. Further, each natural language has a specific meaning depending on a connection order of sentence. For example, each natural language has a meaning indicating whether a math formula following a natural language is connected with a specific condition, or the following math formula is defined.

In order to automatically obtain the above information from the math formula, it is needed to separately tokenize the natural language and standardized math formula. Program to analyze such natural language and math formula may be inputted in a format of mixture of the two as illustrated in FIG. 18. That is, a general natural language and an XML compliant with Math ML standard that is standardized in W3C (World Wide Web Consortium) may be inputted.

The fourth information input unit 1810 receives combined data (complex sentence) composed of natural language and math formula inputted. Here, it is preferable that the combined data is mathematical contents including mathematical problems and mathematical proofs, but it is not limited thereto. Further, combined data composed of natural language and math formula may be directly inputted by a user's manipulation or command, but it is not limited thereto. It may be possible to receive document data including a combination composed of natural language and math formula from a separate external server.

The fourth separation unit 1820 separates the natural language and math formula from the combined data. That is, when the fourth separation unit 1820 receives the combined data composed of the natural language combined with the math formula through the fourth information input unit 1810, it separately identifies the natural language and math formula included in the combined data. Here, the math formula may be generated in a Math ML format based on the contents.

The fourth natural language processing unit 1830 generates a natural language token generated by tokenizing the natural language, generates stop word filtered data generated by filtering stop words in the natural language token generated, generates deduplication filtered data by performing a deduplication filtering in the stop word filtered data, and matches operation information to which a meaning defined in advance is given to the deduplication filtered data. Here, token refers to a unit discriminable in continuous sentences, and tokenization refers to a process to divide a natural language into a word unit that the natural language and math formula processing apparatus 100 can understand. The fourth natural language processing unit 1830 generates stop word filtered data by performing a stop word filtering that selects and removes a natural language token determined to be a stop word defined in advance in the natural language token. The fourth natural language processing unit 1830 generates deduplication filtered data by performing a deduplication filtering that selects and removes duplicate data from the duplicate word filtered data. The fourth natural language processing unit 1830 matches data corresponding to a predicate in the deduplication filtered data to operation information to which a meaning defined in advance is given, thereby extracting a natural language token.

Describing the tokenization in more detail, the tokenization may be generally classified into a natural language tokenization and a math formula tokenization in the fourth embodiment. The natural language tokenization refers to a process in which each word corresponding to the output generated by dividing the natural language included in combined data (mathematical problem or complex sentence) based on space is identified as a natural language token. Meanwhile, the math formula tokenization refers to a process in which each of unit information obtained after parsing a math formula included in the combined data is identified as a math formula.

Find the function value 9y³+8y²−4y−9 with y=−1 [Exercise 1]

For example, information corresponding to the natural language token in [Exercise 1] is ‘Find’, ‘the’, ‘function’, ‘value’, and ‘with’, the math formula token may be value returned after extracting information through a parsing, polynomial, maximum degree=3, number of terms=4, and condition, y=−1.

Further, describing the stop word filtering in more detail, the stop word means a set of words that is defined in advance in order to remove portion corresponding to unnecessary token in analysis of sentence or math formula. That is, ‘the’ (and ‘a’ or ‘to’) in [Exercise 1] is a stop word, which is defined in advance in a dictionary format in the natural language and math formula processing apparatus 100 of a complex sentence according to the fourth embodiment. That is, while the fourth natural language processing unit 1830 performs a process to remove stop words that are portions not necessary to make analysis after generating the natural language token, the stop word filtering operates to prevent too much tokens from being used to the analysis process when the mathematical problem becomes long (descriptive problem or the like), and to enhance a processing speed of the mathematical problem. Further, in case that there is a mathematical problem of “when a value of this equation is 3, solve another value of this equation”, when natural language is tokenized, tokens “equation” and “value” may be extracted by two, respectively. In this case, it is possible to remove each one from two duplicate tokens of “equation” and two duplicate tokens of “value”, and then extract operation information using the extracted data.

The fourth math formula processing unit 1840 generates a math formula token by parsing the math formula separated from the complex sentence and extracting a semantic meaning. The fourth math formula processing unit 1840 converts the math formula into a tree format, performs a traverse process to the math formula converted into a tree format, and performs a tokenization to the math formula to which the traverse process has been performed. The fourth math formula processing unit 1840 may convert the math formula prepared in Math ML into an XML tree format, and then into a DOM format. The fourth math formula processing unit 1840 executes the traverse in a depth-first search scheme in which information constituting the math formula is gradually transferred from the lowest node to a high node and then extracts a semantic meaning.

Describing the traverse process and the depth first search in more detail, the math formula is generally made in Math ML format, which is constructed of a tree format. A process to search for such node of tree to extract information from such tree is called as a traverse process, and it is possible to use the depth-first search when performing the traverse process. Since the depth-first search traverse process starts from the root of the tree, enters up to child nodes, and then moves to parent nodes after all child nodes are completely searched for, all information that child nodes have is transferred to parent nodes. It becomes efficient in time complexity since the search is made as many as the number of edges. Here, while the depth-first search is illustrated, the fourth embodiment is not limited thereto.

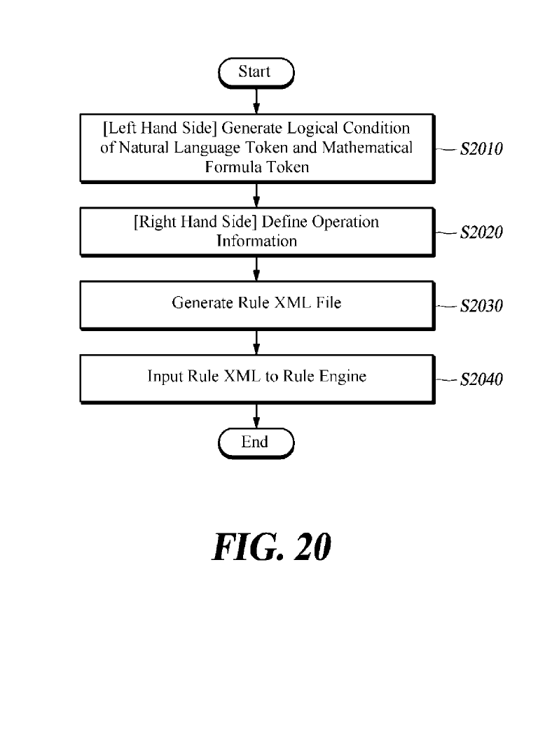

FIG. 20 is a view of a procedure to generate a rule according to a fourth embodiment of the present disclosure.

The fourth rule storage unit 1870 stores a rule generated by coupling a combination of the natural language and math formula and operation information corresponding the combination.

Here, the rule stored in the fourth rule storage unit 1870 may include a logical condition of one or more natural language tokens and math formula tokens and operation information generated correspondingly to the logical condition.

In order to store the rule, a process to capture what combination of natural language token and math formula token is existed based on the mathematical problem is performed (S2010). This becomes a logical condition of rule (which may be stored as LHS (Left Hand Side) on material structure of Binary tree format, for example). The logical condition may be constructed of several tokens and may define a logical relationship of tokens. That is, it is possible to define a plurality of natural language tokens and math formula tokens as a logical relationship using an ‘and’ condition in which two tokens are simultaneously satisfied, an ‘or’ condition in which one of two condition may be satisfied or the like. Next, operation information (which may be stored as RHS (Right Hand Side) on the material structure of Binary tree format, for example) (S2020). Accordingly, when a mathematical sentence that tries to extract the operation information correspondingly to the definition satisfies a logical condition of any rule stored in the fourth rule storage unit 1870, it may be a format to generate operation information corresponding to the logical condition. It is possible to generate the rule defined like this as a file (S2030), to input the file generated into a rule engine in an XML format, whereby it may be stored in the fourth rule storage unit 1870 (S2040).

The fourth operation extraction unit 1850 compares the natural language token and math formula token that are generated in the fourth natural language processing unit 1830 and the fourth math formula processing unit 1840 with the logical condition of the natural language and math formula of the rule stored in the fourth rule storage unit 1870. Then, when satisfied with the logical condition of any rule stored, the fourth operation extraction unit 1850 extracts operation information corresponding to the logical condition, and then generates operation information of relevant complex sentence.

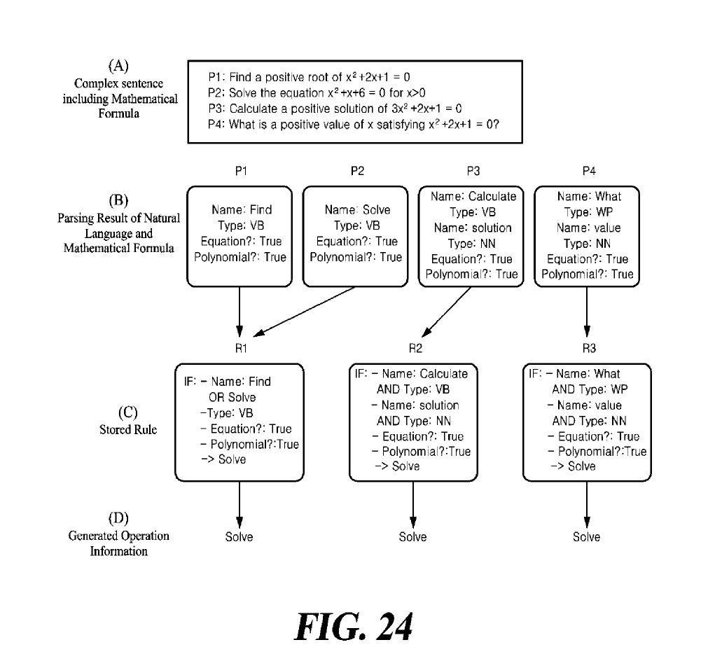

FIG. 24 is a view of a method for extracting operation information by a rule matching according to a fourth embodiment of the present disclosure.

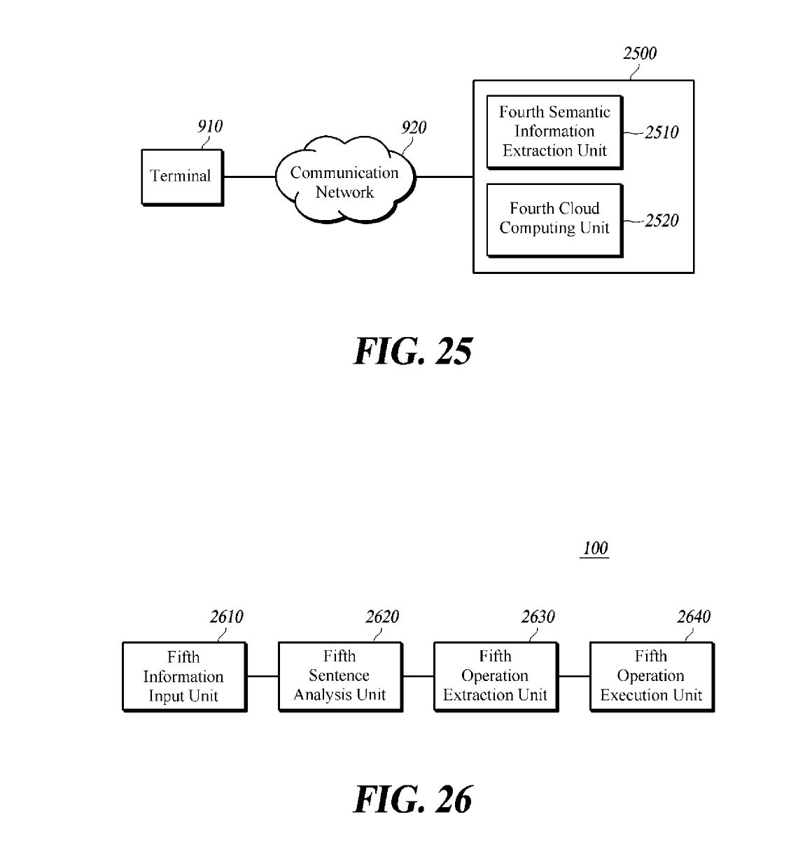

Referring to FIG. 24, when there exist four math formulas P1, P2, P3 and P4 as illustrated in FIG. 24(A), a parsed result may be generated by the fourth natural language processing unit 1830 and the fourth math formula processing unit 1840 as illustrated in FIG. 25(B). For example, in case of P1, as a result of parsing using the fourth natural language processing unit 1830, it is indicated that the math formula name is “Find” and its type is a verb (VB). Further, as a result of parsing using the fourth math formula processing unit 1840, it is indicated that Equation is true, and Polynomial is true. As illustrated in FIG. 24(C), comparing this with a logical condition of a rule stored, it is indicated that R1 among R1, R2 and R3 is matched. Accordingly, as illustrated in FIG. 24(D), “Solve” being operation information satisfying the logical condition is extracted as operation information from the matched rule.

The fourth natural language processing unit 1850 may extract all operation information satisfying the logical condition of the rule stored in the fourth rule storage unit 1870. The logical condition comprised of the natural language token combined with the math formula token may satisfy various logical conditions of the rule stored. In this case, one mathematical problem includes a plurality of operation information. When a combination of the natural language token and math formula token does not satisfy any logical condition, it may be determined that the relevant complex sentence is a list or an erroneous mathematical sentence that has been omitted or excluded in the course of analyzing mathematical sentences when generating the rule.

The fourth object generation unit 1860 matches the math formula that is a target of the natural language generated as a result of parsing natural language among the math formula tokens.

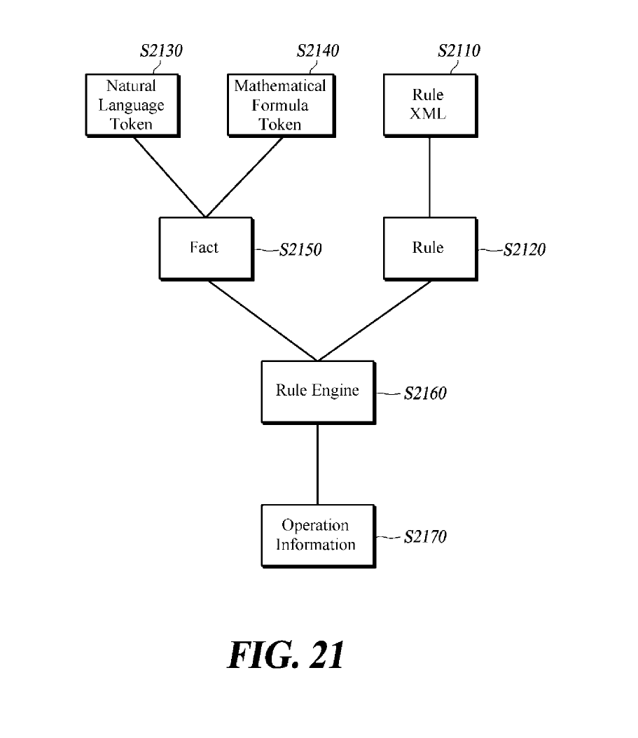

FIG. 21 is a view of a constitution of a rule engine used as a rule storage unit and a process to extract operation information of the rule engine, which is used as a fourth rule storage unit 1870.

Referring to FIG. 21, the natural language token extracted from the fourth natural language processing unit 1830 and the math formula token that has a semantic meaning of the math formula extracted from the fourth math formula processing unit 1840 are used to extract meaning of entire operations that the relevant math formula problem has. As described above, when a certain natural language token and a certain math formula semantic token are inputted through a pre-processing of the math formula problem, operation information to be extracted is inputted in an XML (S2110), and defied by the rule to be stored (S2120). The complex sentence to be analyzed is separately parsed into a natural language token and a math formula token (S2130, S2140). Each token is inputted into the fourth operation extraction unit 1850 as a Fact (S2150), and the fourth operation extraction unit 1850 drives a rule engine to search for a rule and refers to the fourth rule storage unit 1870 to which the rule is defined and stored (in an XML format, for example) (S2160). The rule engine compares the fact inputted with the rule stored and generates operation information of the relevant rule satisfying the logical condition (S2170).

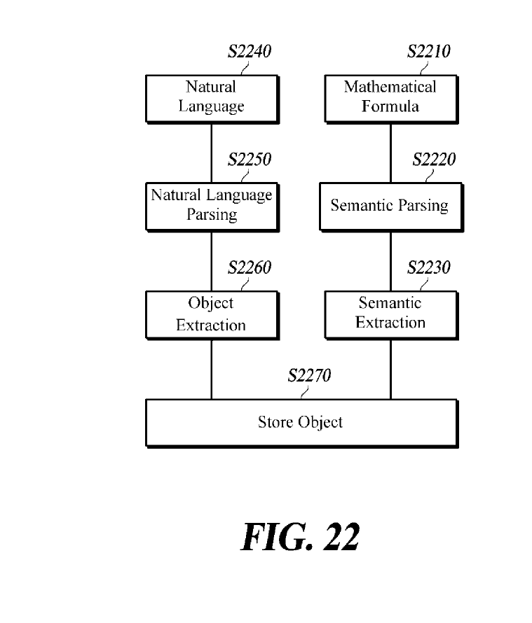

FIG. 22 is a schematic view o a procedure to obtain a mathematical object according to a fourth embodiment of the present disclosure.

Flowcharts of left portion of FIGS. 22 (S2240, S2250 and S2260) extract information corresponding to technique, definition and theorem that are needed to solve mathematical problem in the natural language. When it is determined that there are more information needed through problem analysis, it is possible to make category of a needed format and add such information.

Flowcharts of right portion of FIGS. 22 (S2210, S2220 and S2230) illustrate a process in which semantic information is extracted through a parsing of math formula that is received in Math ML format which is standardized in W3C. That is, when the fourth math formula processing unit 1840 receives a math formula token inputted (S2210), XML is formed in a tree format using a general DOM (Document Object Model), the math formula is parsed by collecting information in a method where information of the lowest node is captured and transferred to a high node through a depth-first search (S2220) and semantic information is extracted (S2230). Since a technology of extracting semantic information of the math formula is beyond the scope of the fourth embodiment, detailed description thereof will be omitted.

When the natural language is inputted (S2240), a natural language token is generated by parsing the natural language (S2250). Further, a relevant math formula object is extracted by performing a process in which the math formula being a natural language token generated is matched to math formulas generated in the fourth math formula processing unit 1840 (S2260) and a math formula object is stored in a format combined with the natural language token (S2270).

Here, the math formula object may be stored in a variety of formats depending on method to store, and this may be expressed in a parallel, serial or nested format. That is, it may be possible that a plurality of math formula objects are arranged in a math formula object serially or in parallel, or another math formula object is included in a math formula object.

According to the fourth embodiment, operation information and mathematical object of a mathematical problem includes all information on what the mathematical problem is and what contents it includes. A scope of utilizing such mathematical problem semantic information is very large. For example, when a person wishes to practice a problem to solve a quadratic equation, needed information may be provided based on information extracted in advance in a short time, instead of comparing natural language, parsing all XML in a Math ML format and identifying whether there is information needed. Further, it may be used even in the process to capture a correlation among searched matters, and such operation may be helpful to a user to obtain the best search result.

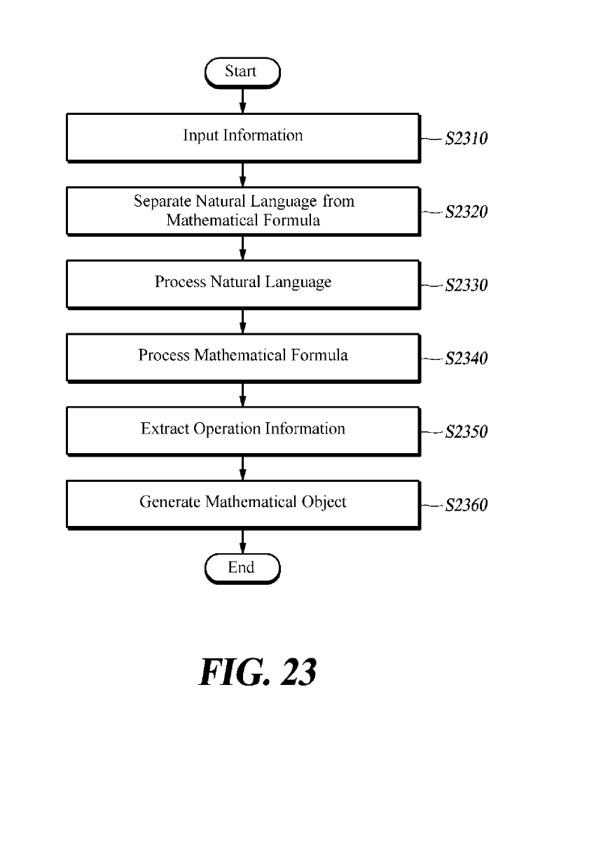

FIG. 23 is a flowchart of a method for extracting semantic information of a complex sentence according to a fourth embodiment of the present disclosure.

A method of extracting semantic information of a complex sentence according to fourth embodiment may include an information input process to receiving a complex sentence including natural language and math formula (S2310), a separation process to separate the natural language and math formula from the complex sentence (S2320), a natural language processing step to tokenize the separated natural language and generate a natural language token (S2330), a math formula processing step to generate a math formula by parsing the separated math formula and extract a semantic meaning (S2340), an operation extraction step to extract operation information of the complex sentence by comparing the natural language token and the math formula token with a rule generated by coupling a logical condition of the natural language and math formula to operation information corresponding to the logical condition (S2350), and an object generation step to match a math formula being a target of the generated natural language token to the generated math formula tokens (S2360).

Here, the information input process (S2310) corresponds an operation of the fourth information input unit 1810, the separation process (S2320) corresponds to an operation of the fourth separation unit 1820, the natural language processing unit (S2330) corresponds to an operation of the fourth natural language processing unit 1830, the math formula processing step (S2340) corresponds to an operation of the fourth math formula processing unit 1840, the operation extraction process (S2350) corresponds to an operation of the fourth operation extraction unit 1850, and the object generation process (S2360) corresponds to an operation of the fourth object generation unit 1860. Therefore, a detailed description for the above processes will be omitted.

The method for extracting semantic information of a complex sentence according to the fourth embodiment as described above and shown in FIG. 23 may be implemented as a program on a computer-readable recording medium. The computer-readable recording medium storing the program for realizing the method for extracting semantic information of a complex sentence according to the fourth embodiment of the present disclosure may be any data storage devices that can store data which can be thereafter read by a computer system. Examples of the computer-readable recording medium include a ROM, a RAM, flash memory, a CD-ROM, a magnetic tape, a floppy disc, an optical data storage device. The computer-readable recording medium may also be distributed over network coupled computer systems so that computer-readable codes are stored and executed in a distributed fashion. In addition, functional programs, codes, and code segments for accomplishing the fourth embodiment of the present disclosure may be easily construed by programmers skilled in the art to which the fourth embodiment pertains.

FIG. 25 is an exemplary view of a system in which an apparatus for processing a natural language and a math formula of a complex sentence provides a cloud computing apparatus with data according to a fourth embodiment of the present disclosure.

In order that an apparatus for processing a natural language and a math formula of a complex sentence according to a fourth embodiment provides data in a cloud computing, a system including a terminal 910, a communication network 920, and a fourth cloud computing apparatus 2500 is needed.

Here, terminal 910 refers to terminals capable of transmitting/receiving various data via communication network 920 following instructions or manipulations of a user and may be one of a tablet PC, laptop computer, personal computer or PC, smartphone, personal digital assistant or PDA and mobile communication terminal. Further, the terminal 910 may be a cloud computing terminal that supports a cloud computing capable of using services such as reading, inputting and storing of data, and use of network and content. In other words, terminal 910 means a memory for storing programs for connecting with the fourth cloud computing apparatus 2500 via communication network 920, and a microprocessor for executing the relevant programs to effect operations and controls. To be more specific, terminal 910 may be any terminals as long as they connect to communication network 920 for server-client communications with the fourth cloud computing apparatus 2500 and encompasses any communicating computing devices including the notebook computer, mobile communication terminal, PDA, etc. Meanwhile, terminal 920 is preferably made to have a touch screen though it is not limited to that effect.

The terminal 910 may input a complex sentence to the fourth cloud computing apparatus 2500, and the fourth cloud computing apparatus 2500 may extract semantic information of the complex sentence in a cloud computing method and provide the terminal 910 with the semantic information. That is, the terminal 910 may include a separate input/output interface unit that provides an input/output interface to the fourth cloud computing apparatus 2500 in order to input/output data to and from the fourth cloud computing apparatus 2500 in a cloud computing scheme, and an interface control unit that makes reading and writing of data with respect to storage medium stored in the fourth cloud computing apparatus 2500 through the input/output interface unit. To be more specific, the terminal 910 may input the complex sentence composed of the natural language combined with the math formula to the fourth cloud computing apparatus 2500. The fourth cloud computing apparatus 2500 may receive the complex sentence including the natural language and math formula, separate the natural language and math formula from the complex sentence, generate a natural language token by tokenizing the separated natural language and generate a math formula token by parsing the separated math formula and extracting a semantic meaning. Using a rule generated by coupling a logical condition of the natural language and math formula to operation condition corresponding to the logical condition, the fourth cloud computing apparatus 2500 may extract operation information of the complex sentence from the rule by comparing the generated natural token and the math formula token with the logical condition of stored rule. Therefore, the terminal 910 may actually extract semantic information of the complex sentence without installing any application.

The communication network 920 refers to a network capable of transmitting/receiving data with an Internet protocol using various wired/wireless communication technologies such as Internet network, Intranet network, and mobile communication network, which performs a function to relay data between the terminal 910 and the fourth cloud computing apparatus 2500.

The fourth cloud computing apparatus 2500 may be embodied based on the natural language and math formula processing apparatus 100. Further, the fourth cloud computing apparatus 2500 may make the terminal 910 perform reading and writing of data with respect to storage medium stored in the fourth cloud computing apparatus 2500 in order that the terminal 910 extracts semantic information of the complex sentence. When the complex sentence composed of the natural language combined with the math formula is inputted, the fourth cloud computing apparatus 2500 may separate the natural language and math formula from the complex sentence, extract a semantic meaning by analyzing each information constituting the separated natural language and math formula, extract operation information corresponding to the natural language token with reference to the natural language token rule to be stored in storage medium, and transmit data of the relevant record medium to the terminal 910. Therefore, the fourth cloud computing apparatus 2500 may provide a cloud computing capable of converting a logical expression of the complex sentence without installing any application in the terminal 910. That is, the fourth cloud computing apparatus 2500 may include a fourth sematic information extraction unit 2510 to store an output generated by extracting semantic information of the complex sentence in a cloud computing scheme and a fourth cloud computing unit 2520 that makes the terminal 910 perform reading and writing of data stored in the storage medium by the fourth semantic information extraction unit 2510.

### Fifth Embodiment

Hereinafter, a fifth embodiment being a method and apparatus for converting a logical expression of a complex sentence including natural language and math formula will be described with reference to FIGS. 26 to 32.

FIG. 26 is a schematic block diagram of an apparatus for processing a natural language and a math formula of a complex sentence according to a fifth embodiment of the present disclosure.

The apparatus 100 for processing a natural language and a math formula of a complex sentence according to a fifth embodiment may be comprised of a fifth information input unit 2610, a fifth sentence analysis unit 2620, a fifth operation extraction unit 2630, and a fifth operation execution unit 2640. The fifth information input unit 2610 receives a complex sentence including a natural language and a math formula. The fifth sentence analysis unit 2620 analyzes a sentence construction of the complex sentence and tokenizes the math formula data and natural language, thereby generating a math formula token and a natural language token. The fifth operation extraction unit 2630 extracts operation information corresponding to a meaning of the natural language token with reference to a natural language token rule. The fifth operation execution unit 2640 structuralizes the extracted operation information with respect to the math formula token. Here, the structuralizing means to couple the extracted operation information to the math formula token and structuralize them.

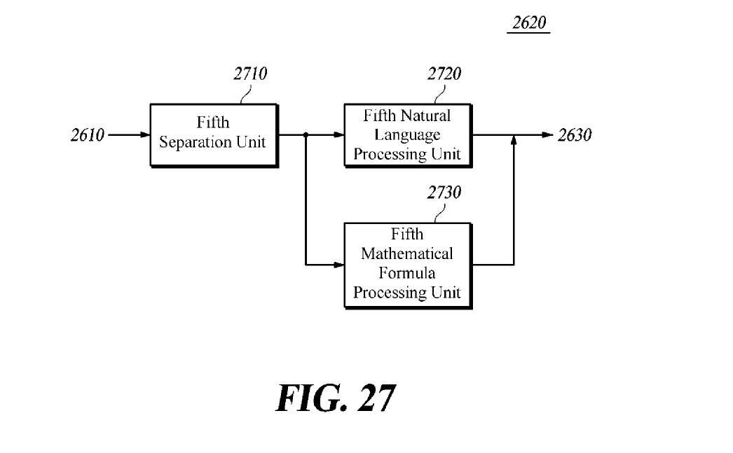

FIG. 27 is a schematic block diagram of a sentence analysis unit according to a fifth embodiment of the present disclosure.

The fifth sentence analysis unit 2620 may include a fifth separation unit 2710 to separate the natural language and math formula from a combined data, a fifth natural language processing unit 2720 to analyze each of natural language information constituting the separated natural language and extract a semantic meaning, and a fifth math formula processing unit 2730 to analyze each of math formula information constituting the separated math formula and extract the semantic meaning.

The fifth information input unit 2610 receives combined data composed of a natural language combined with a math formula. Here, it is preferable that the combined data is mathematical contents including mathematical problems and mathematical proofs, but the combined data is not limited thereto. Further, the combined data composed of a natural language and a math formula may be directly inputted by a user's manipulation or command, but the data is not limited thereto. Document data composed of a natural language combined with a math formula may be inputted from a separate external server. The fifth separation unit 2710 separates the natural language and math formula from the combined data. That is, when the fifth separation unit 2710 receives the combined data composed of a natural language combined with a math formula through the fifth information unit 2610, it separately identifies the natural language and math formula included in the combined data.

The fifth natural language processing unit 2720 analyzes natural language information constituting the separated natural language and extracts a semantic meaning. The fifth natural language processing unit 2720 generates a natural language token by tokening a natural language, generates stop word filtered data produced by filtering stop words set in advance based on the natural language token, and generates deduplication filtered data by performing a deduplication filtering in the stop word filtered data. Here, token refers to a unit discriminable in continuous sentences, and tokenization refers to a process to divide a natural language into a word unit that the natural language and math formula processing apparatus 100 can understand. Describing the tokenization in more detail, the tokenization is generally divided into a natural language tokenization and a math formula tokenization in the fifth embodiment. The natural language tokenization refers to a process in which each word corresponding to the output generated by dividing the natural language included in combined data (mathematical problem or complex sentence) based on space is identified as a natural language token. Meanwhile, math formula tokenization refers to a process in which individual unit information obtained after parsing a math formula included in the combined data (mathematical problem) is identified as a math formula token.

Find the function value 9y³+8y²−4y−9 with y=−1 [Exercise 1]

For example, information corresponding to the natural language token in [Exercise 1] includes ‘Find’, ‘the’, ‘function’, ‘value’, and ‘with’, while the math formula token may include values returned after extracting information through a parsing such as a polynomial, maximum degree=3, number of terms=4, and condition (y=−1).

Further, describing the stop word filtering in more detail, the stop word means a set of words that is defined in advance in order to remove portion corresponding to unnecessary token in analysis of sentence or math formula, and the fifth natural language processing unit 2720 may operate referring to a stop word list defined by unnecessary tokens among the natural language tokens. For example, ‘the’ (and ‘a’ or ‘to’) in [Exercise 1] is predefined as a stop word by the system in a dictionary format. Here, the dictionary means a list that contains a set of words. Specifically, upon generating natural language token, the fifth natural language processing unit 2720 proceeds to remove unnecessary stop word components in analyzing, which is a noise word filtering to prevent too many tokens from entering the analyzing process with a longer math problem (such as the problem of narrative type) and to improve the processing speed of the system. The fifth natural language processing unit 2720 performs a deduplication filtering to selectively remove the duplicate data from the stop word filtered data, to generate a deduplication filter data.

Referring to a predefined natural language token rule in the deduplication filter data, the fifth operation extraction unit 2630 extracts motion information or action corresponding to the meaning of the natural language token. The action is information extracted from an input problem of composite statement based on information for allowing an actual answerer to take action concerning the composite statement depending on whether it is for solving a problem solving or illustrating a concept, etc. That is, the action refers to the summary information that can be extracted based on the tokens included in the math problem. For example, from the math content of [Example 1], an action called ‘solve’ can be extracted based on the natural language tokens and mathematics tokens. Thus, in the process of a schema definition of a math problem, one can obtain information about the representative operation meant by the entire problem. This can be a tool that helps to perform searches or analyze association or similarity between problems.

The fifth math formula processing unit 2730 analyzes each separate pieces of formula information composing a math formula that has been separated to extract the semantic meaning. The fifth math formula processing unit 2730 converts the math formula into a tree form formula, carry out a traverse process on the tree form formula, and tokenize the traversed formula. The fifth math formula processing unit 2730 converts the math formula written in Math ML (Mathematical Markup Language) first into an XML tree formula and then into DOM (Document Object Model) format. The fifth math formula processing unit 2730 performs the traverse in depth-first search method for transferring formula information that make up a math formula from a bottom node gradually to higher nodes. On the other hand, to explain the traverse procedure and depth-first search in detail, the formula generally exhibits the form of a Math ML composed in the form of a tree wherein tree nodes are searched through to extract information during this traverse procedure using the depth-first search. Since the depth-first search traverse procedure starts from the tree root to reach into child nodes and searches them through before moving to the parent nodes, it transfers child nodes' information entirely to the parent nodes with the efficiency in terms of time complexity of needing searches to be performed just by the number of the node connection lines called edges.

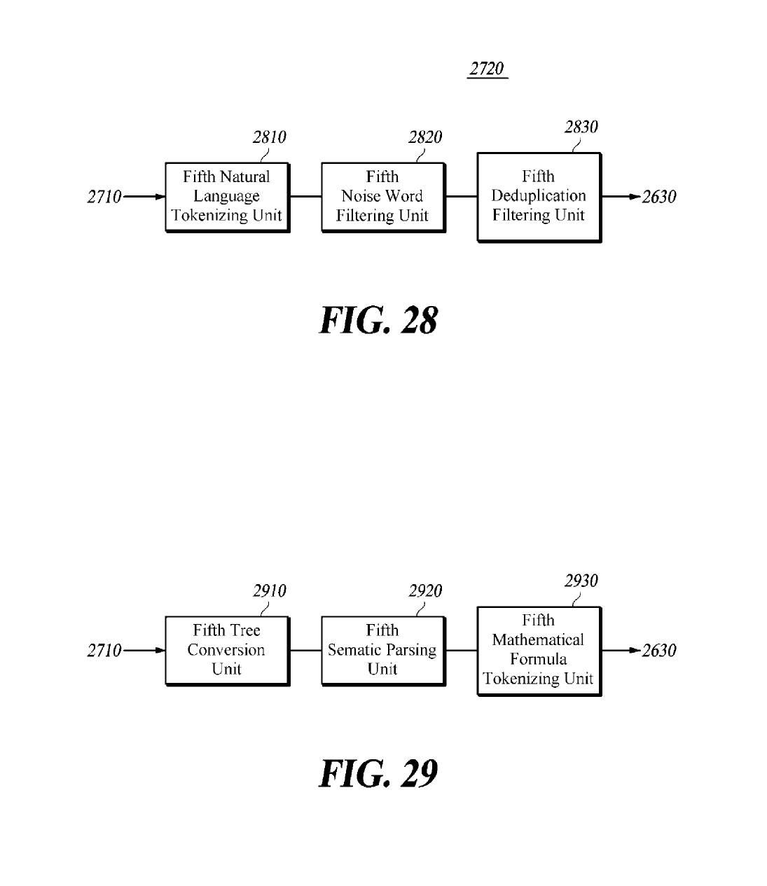

FIG. 28 is a schematic block diagram of a natural language processing unit according to a fifth embodiment of the present disclosure.

The fifth natural language processing unit 2720 according to the fifth embodiment includes a fifth natural language tokenizing unit 2810, a fifth noise word filtering unit 2820 and a fifth deduplication filtering unit 2830. Meanwhile, while it is described that the fifth embodiment specifically includes the fifth natural language tokenizing unit 2810, fifth noise word filtering unit 2820 and fifth deduplication filtering unit 2830, it is merely an exemplary description for a technical idea of the fifth embodiment and it is noted that those skilled in the art will variously modify, change and apply components of the fifth natural language processing unit 2720 without departing from essential properties of the fifth embodiment.

The fifth natural language tokenizing unit 2810 generates a natural language token by tokenizing the natural language. The fifth natural language tokenizing unit 2810 carries out a tokenization on natural language information that makes up the natural language to generate the natural language token. For example, the natural language and math formula processing apparatus 100 can use the fifth natural language tokenizing unit 2810 to receive input natural language nodes individually or the natural language nodes all at once. Here, the natural language is not intended to be limited to having the nature of a sentence which is composed of more than one word by the node itself or to being a perfect sentence. In other words, the natural language node is supposed to be split into unit words that the processing apparatus 100 can understood, which is called a tokenization process.

Based on the natural language token, the fifth noise word filtering unit 2820 generates stop word filtered data by filtering stop words. In generating the stop word filtered data, the fifth noise word filtering unit 2820 performs a stop word filtering to selectively remove from the natural language tokens the tokens identified as preset stop words. In other words, upon completing the tokenization process by the fifth noise word filtering unit 2820 when the natural language information that composes the natural language is divided into a plurality of tokens and upon receiving the divided tokens, the natural language and math formula processing apparatus 100 proceeds to the next process for a stop word removal process. This process removes unnecessary tokens in extracting semantic meaning. For example, while ‘this’, ‘that’, ‘here’ and ‘there’ are set as stop words, the stop word is not limited thereto. Further, setting unnecessary tokens in a sense of meaning may be determined depending on each system.

The fifth deduplication filtering unit 2830 generates deduplication filtered data by performing a deduplication filtering on the stop word filtered data. In generating the deduplication filtered data, the fifth deduplication filtering unit 2830 performs the deduplication filtering to selectively remove duplicate data from the stop word filtered data. In other words, the natural language and math formula processing apparatus 100 first filters stop words through the fifth deduplication filtering unit 2830 and then runs the process of deleting duplicates, and further removes duplicate words through the deduplication to reduce the processing load on the processing apparatus 100.

The fifth operation extraction unit 2630 extracts the operation information corresponding to the meaning of the natural language token by referring to the rules of the natural language token. In this case, natural language token rules mean the rules that define the action information of the natural language token, and they define various representations of a natural language as a certain semantic meaning (meaning of natural language token) and can contain the directivity of the natural language token and the point at the extent of the influence of the natural language token. The directivity herein refers to the condition of whether a natural language token within a mathematics content associates with a math formula located forward or rearward of the corresponding the natural language token.

FIG. 29 is a schematic block diagram of a math formula processing unit according to a fifth embodiment of the present disclosure.

A math formula processing unit 2730 according to the fifth embodiment includes a fifth tree conversion unit 2910, a fifth sematic parsing unit 2920 and a fifth math formula tokenizing unit 2930. Meanwhile, while it is described that the fifth embodiment specifically includes the fifth tree conversion unit 2910, fifth sematic parsing unit 2920 and fifth math formula tokenizing unit 2930, it is merely an exemplary description for a technical idea of the fifth embodiment and it is noted that those skilled in the art will variously modify, change and apply components of the math formula processing unit 2730 without departing from essential properties of the fifth embodiment. Here, the term, semantic means information for allowing particular information understood and logical reasoning by a corresponding apparatus.

The natural language and math formula processing apparatus 100 receives individual math formulas written in a standard format through the fifth information input unit 2610, and transfers the same to the fifth math formula processing unit 2730. That is, the math formula transferred to the math formula processing unit 2730 forms in XML tag based on Math ML (Mathematical Markup Language) that is a standard defined in W2C (World Wide Web Consortium). However, it is preferable that the math formulas transferred to the fifth math formula processing unit 2730 are Math ML, but they are not limited necessarily thereto.

The fifth tree conversion unit 2910 converts math formula into a tree format. The fifth tree conversion unit 2910 converts math formulas prepared in each Math ML into XML tree format and then DOM format. The natural language and math formula processing apparatus 100 converts the math formula into XML tree of Math ML format using the fifth tree conversion unit 2910, and the tree is converted into DOM (Document Object Model) so that it is converted into the tree form accessible in a program.

The fifth semantic parser unit 2920 performs a traverse process on the math formula converted into a tree format. The fifth semantic parser unit 620 executes the traverse in depth first search scheme in which the second information constituting the math formula is gradually transferred from the lowest node to a high node. While the natural language and math formula processing apparatus 100 performs the traverse process in order to capture a semantic meaning of the math formula using the fifth semantic parser unit 2920, the fifth semantic parser unit 2920 executes the traverse using the depth first search in which information is gradually transferred from the lowest node to a high node. Accordingly, the second information gathered through the fifth semantic parser unit 2920 is collected at the highest node all together and undergoes a process to make the token of math formula based on such information.

The fifth math formula tokenization unit 2930 tokenizes the math formula to which a traverse process has been performed. That is, the math formula token that is tokenized refers to a token composed of the mathematics natural language. Meanwhile, the math formula token is dealt differently from the natural language token. In other words, while the fifth natural language processing unit 2720 matches action information based on the natural language token, the fifth math formula processing unit 2730 has the math formula as an output. The math formula token may be used for works such as finding out math formula contents through the search.

The fifth operation execution unit 2640 combines operation information from the fifth operation extraction unit 2630 to a formula token into a structuralized combination before outputting it in the form of schema (e.g., structured in XML) or storing it in a storage medium.

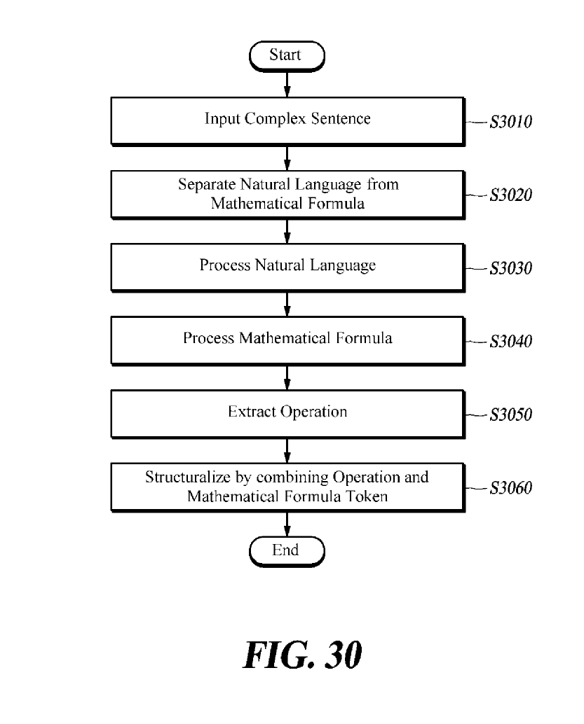

FIG. 30 is a flowchart of a method for converting a logical expression of a complex sentence according to a fifth embodiment of the present disclosure.

The natural language and math formula processing apparatus 100 for a complex sentence receives an input of complex sentence made up of a natural language and math formulas (S3010). Here, the complex sentence of the natural language and math formula may be input directly by a user operation or command which is not a necessary constraint but it may be input from a separate external server. The natural language and math formula processing apparatus 100 for a complex sentence separates the natural language from the math formula in the complex sentence (S3020). In other words, upon receipt of the complex sentence of the natural language and math formula, the processing apparatus 100 recognizes the natural language as separated from the math formula.

The natural language and math formula processing apparatus 100 for a complex sentence executes a process of analyzing information in a natural language, which composes discrete natural words. In other words, the natural language and math formula processing apparatus 100 for a complex sentence generates a natural language token by tokenizing the natural language, stop word filtered data by filtering stop words based on the natural language token and deduplication filtered data through a deduplication filtering performed on the stop word filtered data, and then matches operation information with a predefined meaning to the deduplication filtered data. The natural language and math formula processing apparatus 100 for a complex sentence carries out a tokenization on the natural language information that makes up the natural words to generate the natural language token. In generating the deduplication filtered data, the natural language and math formula processing apparatus 100 for a complex sentence performs the deduplication filtering to identify and remove from the natural language tokens the ones determined as predefined stop words from the stop word filtered data. The natural language and math formula processing apparatus 100 for a complex sentence generates the deduplication filtered data through the deduplication filtering performed on the stop word filtered data.

The natural language and math formula processing apparatus 100 for a complex sentence performs a process for respective math formula information items that make up discrete math formulas (S3040). The natural language and math formula processing apparatus 100 for a complex sentence converts the math formula into a tree format, performs a traverse process to the math formula that has been converted into a tree format, and performs tokenization to the math formula to which the traverse process has been performed. The natural language and math formula processing apparatus 100 for a complex sentence converts the math formula prepared in Math ML into a XML tree format and then into DOM format. The natural language and math formula processing apparatus 100 for a complex sentence performs the traverse in the depth-first search scheme in which constitutional information constituting the math formula is gradually transferred from the lowest node to a high node.

The natural language and math formula processing apparatus 100 for a complex sentence extracts operation information corresponding to a meaning of the natural language token with reference to a natural language token rule (S3050), and structuralize the extracted operation information with respect to the math formula before outputting it in a predefined form of schema or storing it in a storage medium (S3060).

Although FIG. 30 illustrates that the processes S3010 to S3060 are sequentially carried out, they are merely exemplifying the technical idea of the fifth embodiment and it is contemplated that the sequence of the processes shown in FIG. 30, in the fifth embodiment, is changed and modified or one or more processes among the processes S3010 to S3060, within the intrinsic characteristics of the fifth embodiment, are performed in parallel and/or omitted, and thus what is illustrated FIG. 30 is not limited to that time series sequence.

The method for converting the logical expression of a complex sentence according to the fifth embodiment as described above and shown in FIG. 30 may be implemented as a program on a computer-readable recording medium. The computer-readable recording medium storing the program for realizing the method for converting the logical expression of a complex sentence according to the fifth embodiment of the present disclosure includes all kinds of recorders for storing data which can be thereafter read by a computer system. The computer-readable recording/storage medium include a read only memory (ROM), a random access memory (RAM), a flash memory, an optical disk, a magnetic disk, a solid-state disc, an optical data storage device. The computer-readable recording medium may also be distributed over network coupled computer systems so that computer-readable codes are stored and executed in a distributed fashion. In addition, functional programs, codes, and code segments for accomplishing the fifth embodiment of the present disclosure may be easily construed by programmers skilled in the art to which the fifth embodiment pertains.

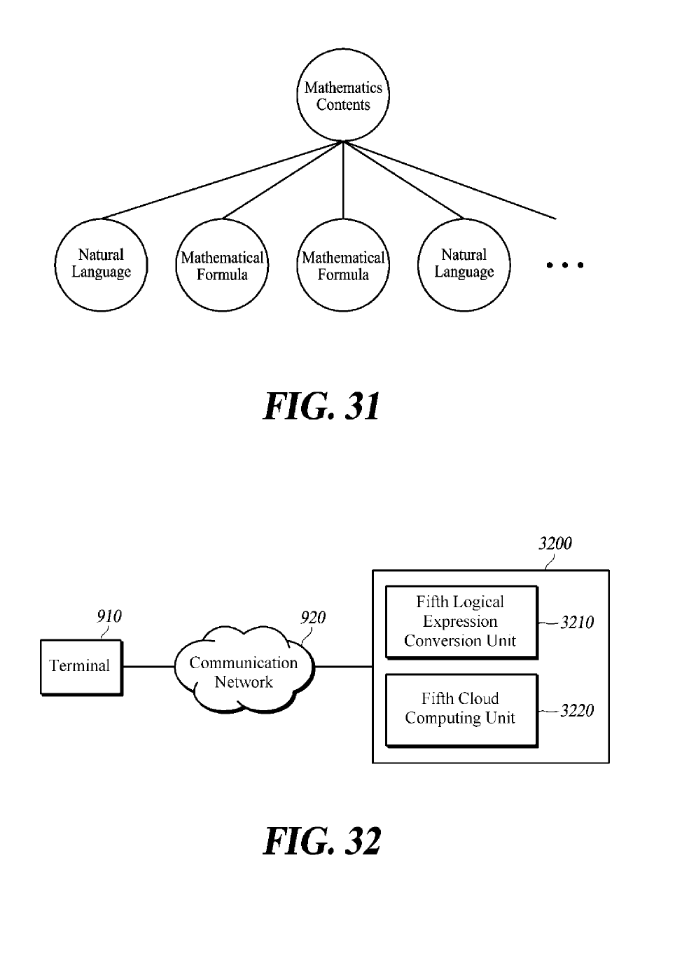

FIG. 31 is an exemplary diagram of an expression of a tree format of a complex sentence according to a fifth embodiment of the present disclosure.

Referring to FIG. 31, describing a structure of one mathematical content, child nodes connected to the root node have a format that is separated into natural language and math formula while maintaining information of word order that is one of important meanings. Further, each natural language has specific meaning depending on connection order of sentence. That is, many contents generally have a structure in which math formulas are tied together based on the natural language. For example, the structure may be that math formula following one natural language is connected in a specific condition or defined. Combining natural language can extract a semantic meaning, as well as meaning and connection relationship of natural language of each node. That is, in order to classify operations indicating whether mathematical contents is required to solve or describe the math formula, entire natural languages are combined together so that their meaning is captured. It may be used to capture the direction of the problem.

FIG. 32 is an exemplary view of a system in which an apparatus for processing a natural language and a math formula of a complex sentence provides a cloud computing apparatus with data according to a fifth embodiment of the present disclosure.

To enable the natural language and math formula processing apparatus 100 for a complex sentence to provide a cloud computing preparation of data, a system is necessary with the terminal 910, communication network 920 and a fifth cloud computing unit 3200 for a complex sentence inclusive.

Here, the terminal 910 refers to terminals capable of transmitting/receiving various data via the communication network 920 following instructions or manipulations of a user and may be one of a tablet PC, laptop computer, personal computer or PC, smartphone, personal digital assistant or PDA and mobile communication terminal. Further, the terminal 910 may be a cloud computing terminal that supports a cloud computing capable of using services such as reading, inputting and storing of data, and use of network and content via the communication network 920. In other words, the terminal 910 means a memory for storing programs for connecting with the fifth cloud computing apparatus 3200 for a complex sentence via communication network 920, and a microprocessor for executing the relevant programs to effect operations and controls. To be more specific, the terminal 910 may be any terminals as long as they connect to the communication network 920 for server-client communications with the fifth cloud computing apparatus 3200 for a complex sentence and encompasses any communicating computing devices including the notebook computer, mobile communication terminal, PDA, etc. Meanwhile, the terminal 920 is preferably made to have a touch screen though it is not limited to that effect.

The terminal 910 may input a complex sentence to the fifth cloud computing apparatus 3200 for a complex sentence, which may extract semantic information of the complex sentence in a cloud computing method and provide the terminal 910 with the semantic information. That is, the terminal 910 may include a separate input/output interface unit that provides an input/output interface to the fifth cloud computing apparatus 3200 for a complex sentence in order to input/output data to and from the fifth cloud computing apparatus 3200 for a complex sentence in a cloud computing scheme, and an interface control unit that makes reading and writing of data with respect to storage medium stored in the fifth cloud computing apparatus 3200 for a complex sentence through the input/output interface unit. To be more specific, the terminal 910 may input the complex sentence composed of the natural language combined with the math formula to the fifth cloud computing apparatus 3200 for a complex sentence. The fifth cloud computing apparatus 3200 for a complex sentence may receive the complex sentence including the natural language and math formula, separate the natural language and math formula from the complex sentence, generate a natural language token by tokenizing the separated natural language and generate a math formula token by parsing the separated math formula and extracting a semantic meaning. Using a rule generated by coupling a logical condition of the natural language and math formula to operation condition corresponding to the logical condition, the fifth cloud computing apparatus 3200 for a complex sentence may extract operation information of the complex sentence from the rule by comparing the generated natural token and the math formula token with the logical condition of stored rule. Therefore, the terminal 910 may actually extract semantic information of the complex sentence without installing any applications.

The communication network 920 refers to a network capable of transmitting/receiving data with an Internet protocol using various wired/wireless communication technologies such as Internet network, Intranet network, and mobile communication network, which performs a function to relay data between the terminal 910 and the fifth cloud computing apparatus 3200.

The fifth cloud computing apparatus 3200 for a complex sentence may be embodied based on the natural language and math formula processing apparatus 100. Further, the fifth cloud computing apparatus 3200 for a complex sentence may make the terminal 910 perform reading and writing of data with respect to storage medium stored in the fifth cloud computing apparatus 2500 in order that the terminal 910 extracts semantic information of the complex sentence. When the complex sentence composed of the natural language combined with the math formula is inputted, the fifth cloud computing apparatus 3200 for a complex sentence may separate the natural language and math formula from the complex sentence, extract a semantic meaning by analyzing each information constituting the separated natural language and math formula, extract operation information corresponding to the natural language token with reference to the natural language token rule to be stored in storage medium, and transmit data of the relevant record medium to the terminal 910. Therefore, the fifth cloud computing apparatus 3200 for a complex sentence may provide a cloud computing capable of converting a logical expression of the complex sentence without installing any application in the terminal 910. That is, the fifth cloud computing apparatus 3200 for a complex sentence may include a fifth logical expression conversion unit 3210 for storing the result of converting the logical expression of the complex sentence in a cloud computing scheme and a fifth cloud computing unit 3220 that makes the terminal 910 perform reading and writing of data stored in the storage medium by the fifth logical expression conversion unit 3210.

### Example 6

Hereinafter, through FIGS. 32 to 40, a sixth embodiment will be described by a method of generating math formula semantic information and an apparatus therefor.

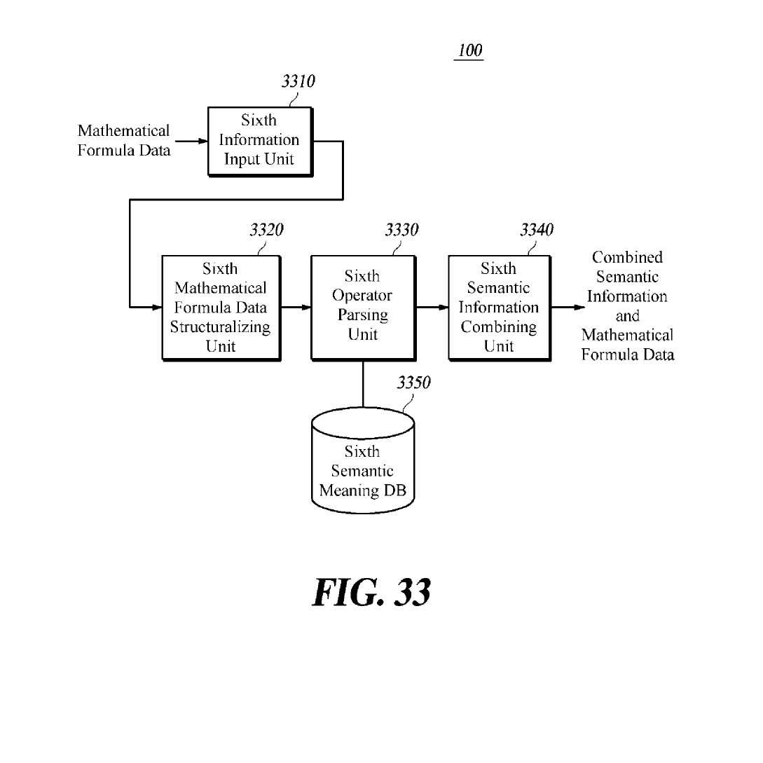

FIG. 33 is a schematic block diagram of an apparatus for processing a math formula and a natural language according to the sixth embodiment of the present disclosure.

The natural language and math formula processing apparatus 100 according to the sixth embodiment includes a sixth information input unit 3310, a sixth math formula data structuralizing unit 3320, a sixth operator parsing unit 3330 and a sixth semantic information combining unit 3340 which may be omitted in some cases.

The sixth information input unit 3310 receives math formula data which represents an equation or math formula and transfers the same to the sixth math formula data structuralizing unit 3320.

The sixth math formula data structuralizing unit 3320 extracts and structuralizes operators and parameters delivered from the sixth information input unit 3310.

The sixth operator parsing unit 3330 extracts a semantic meaning of the operator with respect to the structuralized operator from the sixth math formula data structuralizing unit 3320, couples the extracted semantic meaning to a parameter associated with the operator, and generates the parsing semantic information.

The sixth semantic information combining unit 3340 generates combined semantic information and math formula data by combining parsed semantic information generated by the sixth operator parsing unit 3330 with input math formula data.

With the schema defined and standardized in W3C, contents based MathML (hereinafter called cMathML) provides a semantic addition to the existing presentation MathML (hereinafter called pMathML) to complement its limitation. cMathML contains more tags to handle the semantically unclear factors inherent in pMathML. As with pMathML in figuring out the involved meaning of the math formula, a program parsing process can grasp a limited meaning.

The sixth information input unit 3310 can receive the input of math formula data in the format of the contents based MathML (such as cMathML) with its schema defined standardized in W3C. Although cMathML is suggested herein for the math formula data, the sixth embodiment is not limited thereto and other various methods can structuralize the math formula data in set formats for inputs. In addition, if the input math formula data is in Tex, OpenMath or other formats, the sixth information input unit 3310 can convert such data into MathML format before transferring it to the sixth math formula data structuralizing unit 3320. In addition, the math formula data input may be made directly by a user operation or command which is not a necessary constraint but it may be input through document data expressing the math formula from a separate external server.

Meanwhile, a DOM (Document Object Model) may be used for programmatically structuring XML structured documents such as cMathML. DOM acts to classify the XML structured documents into elements to make a tree structure.

In sum, the sixth math formula data structuralizing unit 3320 extracts the operates and parameters from math formula data and provides a tree structure with MathML formatted math formula input undergone DOM processing.

The sixth operator parsing unit 3330 extracts a semantic meaning of the operator with respect to the tree structuralized operator, couples the extracted semantic meaning from the corresponding operator to a parameter associated with the operator, and generates the parsing semantic information. The sixth operator parsing unit 3330 may also extract the semantic meaning of the corresponding operator with reference to the predefined semantic meaning DB 150.

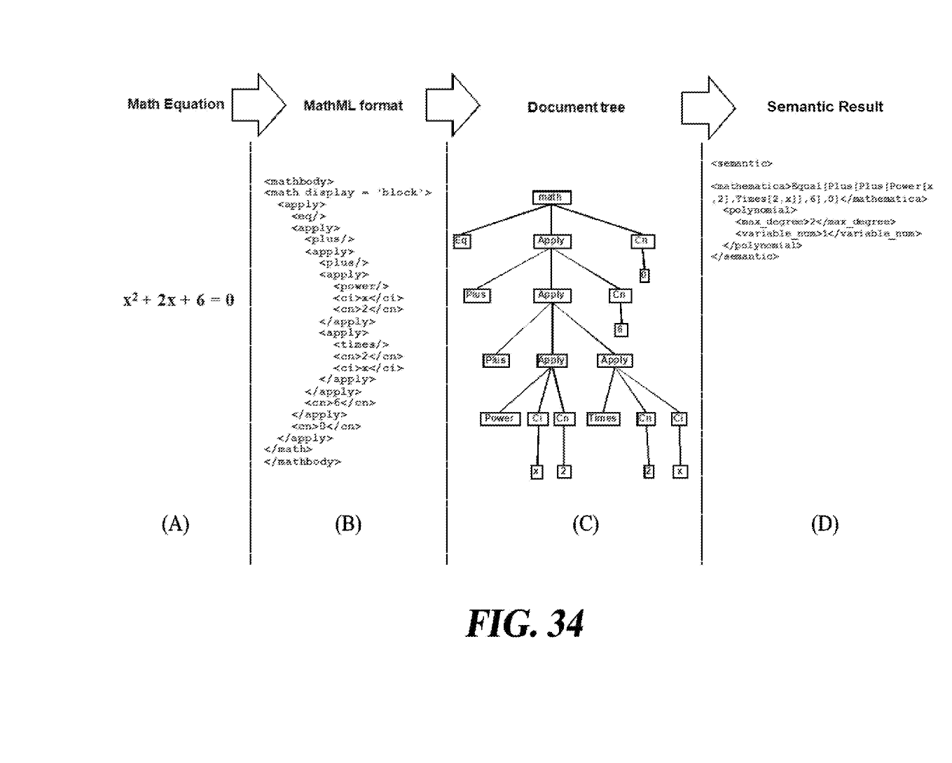

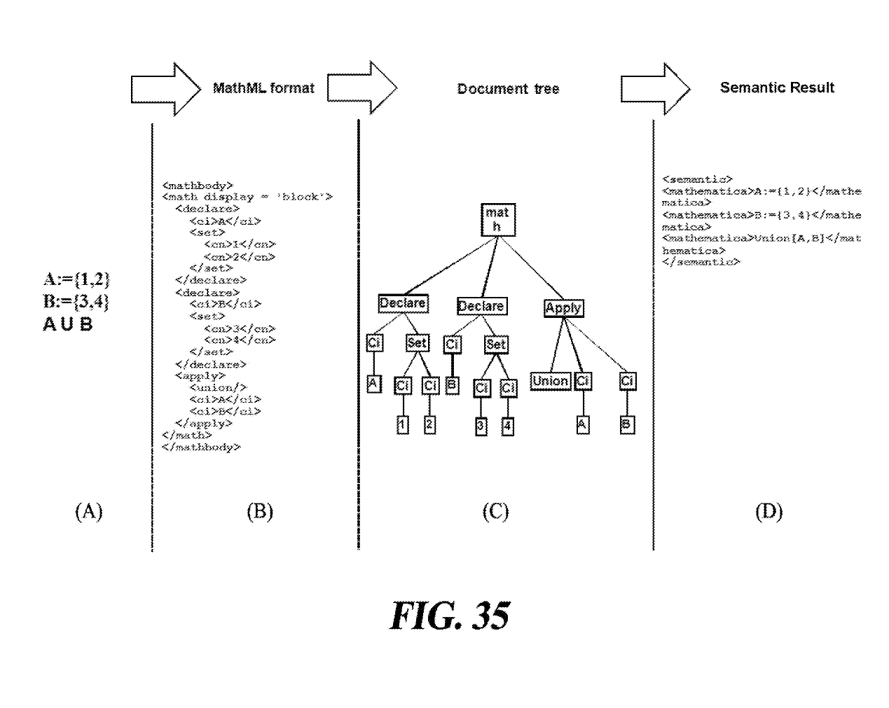

FIGS. 34 and 35 are exemplary views of an operator parsing result for math formula data expressed in math formula according to a sixth embodiment of the present disclosure.

As illustrated in FIG. 34 at A, if the math formula is “x2+2x+6=0” with the math formula data expressed and input in cMathML format into sixth information input unit 3310, the sixth math formula data structuralizing unit 3320 can structuralize the cMathML formatted math formula data into a tree structure at C.

In the tree structure of FIG. 34 at C from the sixth math formula data structuralizing unit 3320, sibling nodes under one parent node have operator nodes at the leftmost sides, which are named ‘Plus’, ‘Power’, ‘Times’ and ‘Eq’. Operator nodes' parameters exist at operator nodes' sibling node positions. If the sibling nodes have other child nodes, tags such as <Apply> show at the illustrated location.

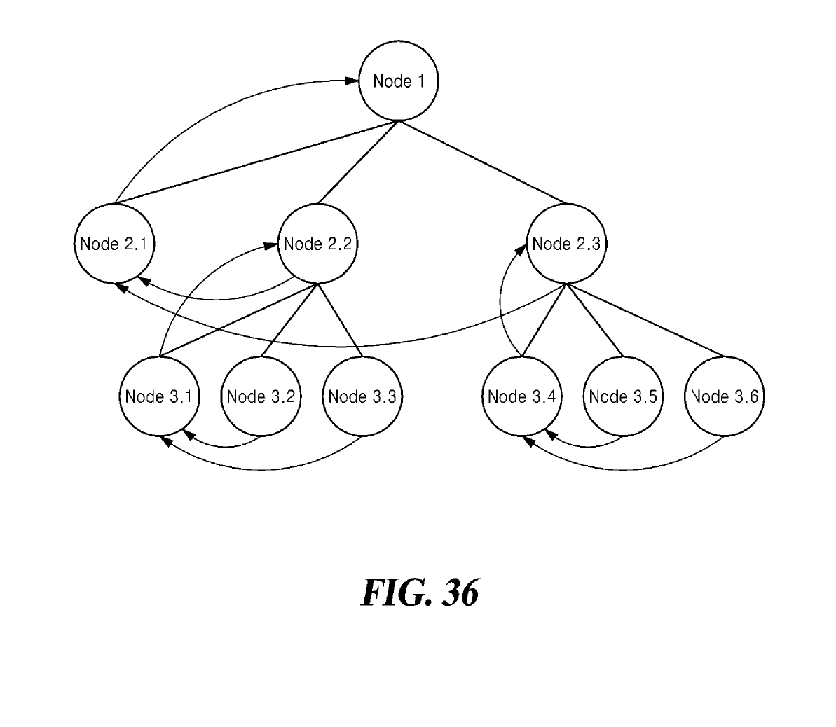

FIG. 36 is a diagram of the traversal order of the nodes that reflect the characteristics cMathML.

As shown in FIG. 36, the math formula structuralization tree structure can be traversed in a pre-order traversing technique. By default, cMathML uses <apply> </apply> in representing a term characteristically, which means one of the child nodes of some nodes contains this tag. Thus, when parsing the tree, information extraction is first carried out for nodes except the node containing <apply> followed by forwarding the aggregated information to the node that has <apply>. In addition, the <apply> node transmits information to its upper node and the upper node in turn transmits the data to <apply> nodes on the same level repeatedly to continue until the data reaches the top node. Finally, when it reaches the root node, all the information has been aggregated, when the semantic information required can be obtained at the root node. Although the present example describes the pre-order traversing technique being applied to the tree structure, the sixth embodiment is not limited thereto.

At this time, the sixth operator parsing unit 3330 in traversing the tree structure acquires each node's information and extracts the semantic meanings of the operators such as ‘Plus’, ‘Power’ and ‘Times’ that are present in its visiting nodes in the traversing course. If the representation of the tree structure is different from the generated representation of the parsing result, the semantic meanings DB 150 may be provided to store representations of the parsing results corresponding to the representations of tree structures so that the sixth operator parsing unit 3330 refers to the semantic meanings DB 150 in extracting the semantic meanings of the operators. In addition, while included in the structuralized tree structure, if the representation of the tree structure is different from the generated representation of the parsing result, direct referencing can be made to the information such as ‘Plus’, ‘Power’ and ‘Times’.

The sixth operator parsing unit 3330 extracts a semantic meaning of the operator, extracts a parameter associated with the operator from the structures tree structure, couples the extracted parameter to a semantic meaning of the operator in order to generate the parsing semantic result as shown in FIG. 34 at D. In other words, among the sibling nodes, the parameters of the operator are expressed as bound by operators to be “Power [x, 2]”, “Times [2, x]” and the like. For example, sibling nodes of ‘Power’ are ‘Cn’ and ‘Ci’, which are connected to sibling nodes of ‘x’ and ‘2’ respectively, whereby connecting ‘x’ and ‘2’ to the operator ‘Power’.

Meanwhile, the sixth operator parsing unit 3330 in its tree structure parsing operation can extract semantic information containing the type of operation of the formula, the number of variables, degree of terms and the like. In other words, it's not that the sixth operator parsing unit 3330 extracts the semantic information by visiting just one node. Rather, by visiting all the nodes and keeping information of the number of variables, degree of terms and such with respect to an operator in store throughout, the sixth operator parsing unit 3330 extracts comprehensive semantic information representing the type and characteristics of the corresponding formula data and include it in the parsing semantic information.

Referring to FIG. 35, when a formula like [Equation 2] as at A generates formula data which is expressed in cMathML format as at B and then input to the sixth information input unit 3310, the sixth math formula data structuralizing unit 3320 can structuralize the formula data in cMathML format at B into a tree structure as C.

$$A := \{ 1 , 2 \} \\ B := \{ 3 , 4 \} \\ AUB \qquad Equation 2$$

In the tree structure of FIG. 35 at C from the sixth math formula data structuralizing unit 3320, sibling nodes under one parent node have operator nodes at the leftmost sides, which are ‘Union’, ‘Set’ and ‘Ci’. Operator nodes' parameters exist at operator nodes' sibling node positions. If the sibling nodes have other child nodes, tags such as <Apply> and <Declare> show at the illustrated location.

At this time, the sixth operator parsing unit 3330 in traversing the tree structure acquires each node's information and extracts the semantic meanings of the operators such as ‘Union’, ‘Set’ and ‘Ci’ that are present in its visiting nodes in the traversing course.

The sixth operator parsing unit 3330 in its traversing operation on the tree structure at C extracts a semantic meaning of the operator, extracts a parameter associated with the operator from the structures tree structure, couples the extracted parameter to a semantic meaning of the operator in order to generate the parsing semantic result as shown at D. In other words, of the sibling nodes, the parameters of the operator are expressed as bound by operators to be “Union [A, B]” and the like. For example, sibling nodes of ‘Union’ are a couple of ‘Ci’, which are connected to sibling nodes of ‘A’ and ‘B’ respectively, whereby connecting ‘A’ and ‘B’ to the operator ‘Ci’. In addition, the parameter also can have its semantic meaning extracted referring to tag ‘Declare’ in the tee structure.

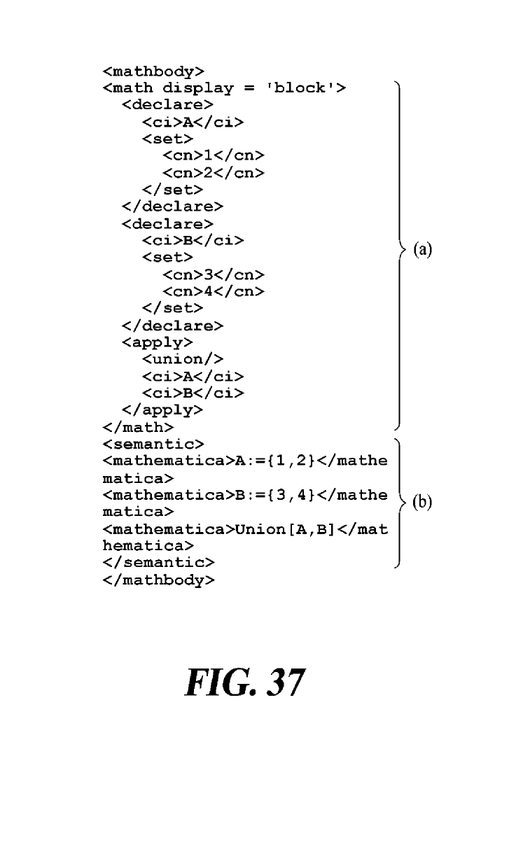

FIG. 37 is an exemplary view of semantic information coupling math formula data composed of parsing semantic information (b) combined with a math formula inputted (a) according to a sixth embodiment of the present disclosure.

As illustrated in FIG. 37, the sixth semantic information combining unit 3340 generates combined semantic information and math formula data by combining the math equation (a) as in FIG. 34 and parsed semantic information (b) generated by the sixth operator parsing unit 3330.

In other words, the generated combination semantic information and math formula data (a+b) can have the structure of the XML formatted preset schema, or a similar structure as the one in FIG. 37 where the parsed semantic information (b) is inserted as <Semantic> </Semantic> tags after the XML formatted math equation (a).

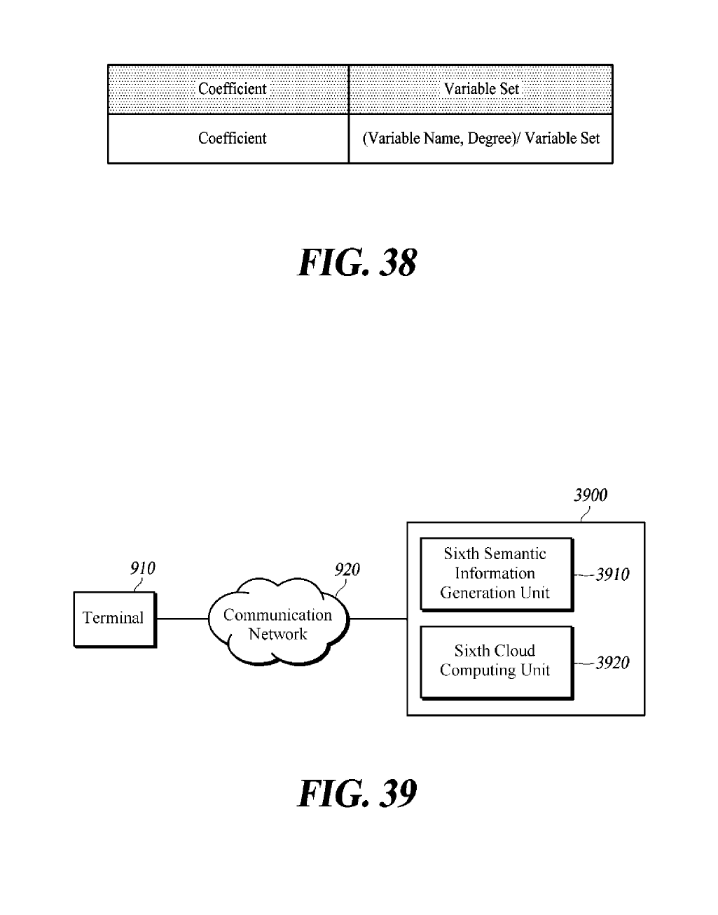

FIG. 38 is a diagram of the structure of data for transferring data between nodes in the course of traversing the nodes.

FIG. 38 is an illustration of a template of the data structure for storage of an equation, it can be extended easily into other data storage structures. Math formulas as divided into large groups may include polynomial, matrix, set, vector, relationship, integration, differentiation and the like. These groups may have the similar data structure as the abovementioned template and can be extended into possible additions of further structures based on the template.

As in the case of FIG. 34 where a tree structure contains a plurality of nodes as child nodes, the present disclosure can store information on the child nodes' operator nodes and parameter nodes. For example, as depicted in FIG. 38, the information on the nodes may contain a storage structure such as a set of variables, and the variable set may contain information corresponding to variable names and degrees and the like. The stored variable set may contain one or more variables, and the stored variable set may contain another variable set to have nested storage structured.

FIG. 39 is an exemplary view of a system in which an apparatus for processing a natural language and a math formula provides a cloud computing apparatus with data according to a sixth embodiment of the present disclosure.

To enable the natural language and math formula processing apparatus according to the sixth embodiment to provide a cloud computing preparation of data, a system is necessary with the terminal 910, communication network 920 and a sixth cloud computing unit 3900 inclusive.

Here, terminal 910 refers to terminals capable of transmitting/receiving various data via communication network 920 following instructions or manipulations of a user and may be one of a tablet PC, laptop computer, personal computer or PC, smartphone, personal digital assistant or PDA and mobile communication terminal. Further, the terminal 910 may be a cloud computing terminal that supports a cloud computing capable of using services such as reading, inputting and storing of data, and use of network and content. In other words, terminal 910 means a memory for storing programs for connecting with the sixth cloud computing apparatus 3900 via communication network 920, and a microprocessor for executing the relevant programs to effect operations and controls. To be more specific, terminal 910 may be any terminals as long as they connect to communication network 920 for server-client communications with the sixth cloud computing apparatus 3900 and encompasses any communicating computing devices including the notebook computer, mobile communication terminal, PDA, etc. Meanwhile, terminal 920 is preferably made to have a touch screen though it is not limited to that effect.

The terminal 910 may input a complex sentence to the sixth cloud computing apparatus 3900, and the sixth cloud computing apparatus 3900 may extract semantic information of the complex sentence in a cloud computing method and provide the terminal 910 with the semantic information. That is, the terminal 910 may include a separate input/output interface unit that provides an input/output interface to the sixth cloud computing apparatus 3900 in order to input/output data to and from the sixth cloud computing apparatus 3900 in a cloud computing scheme, and an interface control unit that makes reading and writing of data with respect to storage medium stored in the sixth cloud computing apparatus 3900 through the input/output interface unit. To be more specific, the terminal 910 may input math formula data with the math formula expressed through the input/output interface unit to the sixth cloud computing apparatus 3900. Upon receiving the math formula representing data, the sixth cloud computing apparatus 3900 extracts and structuralize operators and parameters from the received math formula data, extracts the semantic meaning of the operator which has been structuralized, couples the extracted semantic meaning with a parameter associated with the operator to generate parsed semantic information, and thereby actually enables the terminal 920 to extract semantic information by parsing the math formula data without needing to install any software applications.

The communication network 920 refers to a network capable of transmitting/receiving data with an Internet protocol using various wired/wireless communication technologies such as Internet network, Intranet network, and mobile communication network, which performs a function to relay data between the terminal 910 and the sixth cloud computing apparatus 3900.

The sixth cloud computing apparatus 3900 may be embodied based on the natural language and math formula processing apparatus 100. Further, the sixth cloud computing apparatus 3900 may make the terminal 910 perform reading and writing of data with respect to storage medium stored in the sixth cloud computing apparatus 3900 to provide the terminal 910 with parsed semantic information of math formula data via the cloud computing. When the math formula data is inputted, the sixth cloud computing apparatus 3900 may extracts and structuralize operators and parameters from the received math formula data, extracts the semantic meaning of the operator which has been structuralized, couples the extracted semantic meaning with a parameter associated with the operator to generate parsed semantic information, store the same in a computer-readable recording medium, and transmit data of the relevant record medium to the terminal 910. Therefore, the sixth cloud computing apparatus 3900 may provide a cloud computing capable of parsing the math formula data without installing any application in the terminal 910. That is, the sixth cloud computing apparatus 3900 may include a sixth sematic information generation unit 3910 for extracting the semantic information of the math formula data and a sixth cloud computing unit 3920 that makes the terminal 910 perform reading and writing of data stored in the storage medium by the sixth semantic information generation unit 3910.

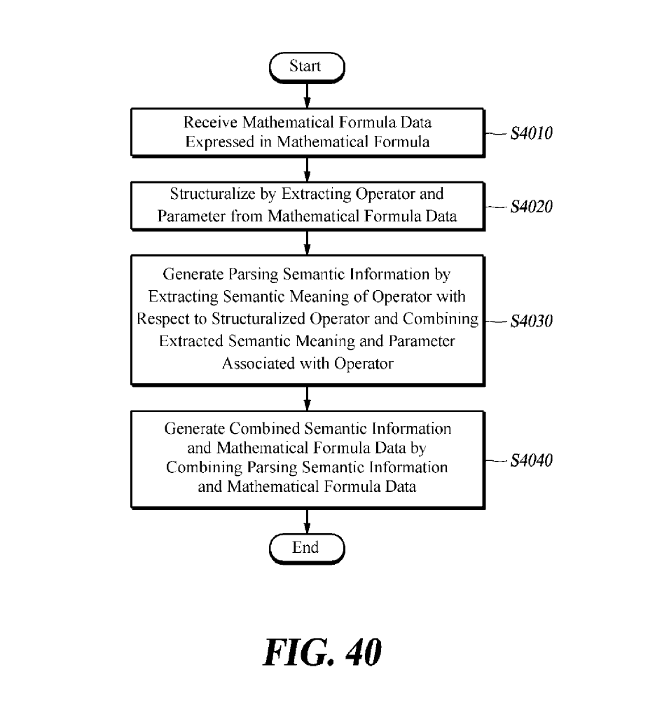

FIG. 40 is a flowchart of a method for generating math formula semantic information according to the sixth embodiment of the present disclosure.

The method for generating math formula semantic information according to the sixth embodiment includes receiving math formula data expressed in math formula (S4010), structuralizing by extracting operators and parameters from the math formula data (S4020), generating parsed semantic information by extracting the semantic meaning of an operator with respect to the structuralized operator and combining the extracted semantic meaning and the parameter associated with the operator (S4030), and generating combined semantic Information and math formula data by combining the parsed semantic information with the math formula data (S4040).

Here, the information input process (S4010) corresponds to the operation of the sixth information input unit 3310, the math formula data structuralization process (S4020) to the sixth math formula data structuralization unit 3320, the operator parsing process (S4030) to the sixth operator parsing unit 3330, and the semantic information combining process (S4040) to the semantic information combining unit 3340. Therefore, a detailed description for the above processes will be omitted.

According to the present disclosure as described above, there are effects, capable of providing dedicated input tools for allowing a user to input a natural language and a math formula, generating semantic information, extracting semantic information automatically, structuralizing the natural language and math formula as recombined data on the basis of analyzed contents of combined data of the natural language and math formula, expressing a complex sentence including the natural language and math formula to have a logical relationship automatically, and indexing structuralized information of a user query on the basis of semantic information.

Further, according to a first embodiment of the present disclosure, there is an effect, capable of providing dedicated text input tools and math formula input tools for allowing a user to input a natural language and a math formula, and receiving the natural language and math formula inputted through the text input tool and math formula input tool. Further, according to the present embodiment, there is an effect, capable of storing and managing semantic information generated by performing a natural language process and a math formula process together with respect to the natural language and math formula inputted through the text input tool and the math formula tool.

Further, according to a second embodiment of the present disclosure, there is an effect, capable of managing data of a natural language combined with a math formula using data of a natural language recombined with a math formula on the basis of an analysis content generated by performing a natural language process and a math formula process together. Further, according to a third embodiment of the present disclosure, there is an effect, capable of indexing information generated by structuralizing a user query together with semantic information generated by performing the natural language process and the math formula process on the basis of the semantic information, analyzing a similarity between them through an index of data composed of the natural language combined with the math formula, and providing a scored ranking.

Further, according to a fourth embodiment of the present disclosure, there is an effect, capable of automatically extracting semantic information included a mathematical problem composed of a natural language and a standardized math formula. Further, according to a fifth embodiment of the present disclosure, there is an effect, capable of automatically expressing that a complex sentence including a natural language and a math formula has a logical relationship between them. Further, there is an effect, capable of extracting semantic information involved in a math formula when the math formula inputted in an arbitrarily structuralized scheme is parsed.

Some embodiments as described above may be implemented in the form of one or more program commands that can be read and executed by a variety of computer systems and be recorded in any non-transitory, computer-readable recording medium. The computer-readable recording medium may include a program command, a data file, a data structure, etc. alone or in combination. The program commands written to the medium are designed or configured especially for the at least one embodiment, or known to those skilled in computer software. Examples of the computer-readable recording medium include magnetic media such as a hard disk, a floppy disk, and a magnetic tape, optical media such as a CD-ROM and a DVD, magneto-optical media such as an optical disk, and a hardware device configured especially to store and execute a program, such as a ROM, a RAM, and a flash memory. Examples of a program command include a premium language code executable by a computer using an interpreter as well as a machine language code made by a compiler. The hardware device may be configured to operate as one or more software modules to implement one or more embodiments of the present disclosure. In some embodiments, one or more of the processes or functionality described herein is/are performed by specifically configured hardware (e.g., by one or more application specific integrated circuits or ASIC(s)). Some embodiments incorporate more than one of the described processes in a single ASIC. In some embodiments, one or more of the processes or functionality described herein is/are performed by at least one processor which is programmed for performing such processes or functionality.

Although exemplary embodiments of the present disclosure have been described for illustrative purposes, those skilled in the art will appreciate that various modifications, additions and substitutions are possible, without departing from various characteristics of the disclosure. Therefore, exemplary embodiments of the present disclosure have not been described for limiting purposes. Accordingly, the scope of claimed invention is not to be limited by the above embodiments but by the claims and the equivalents thereof.

What is claimed is:

1. An apparatus for processing a natural language and a mathematical formula, the apparatus comprising:
a natural language and mathematical formula input unit configured to receive a natural language and a mathematical formula inputted;
an information generation unit configured to generate parsing semantic information of the mathematical formula from combined data including the natural language combined with the mathematical formula;
an operation information extraction unit configured to extract operation information generated by using a logical condition from the combined data;
a natural language and mathematical formula structuralizing unit configured to analyze, classify in terms of specific meaning and recombine the combined data;
an operation structuralizing unit configured to structuralize the operation information; and
a natural language and mathematical formula indexing unit configured to index the combined data.

2. The apparatus of claim 1, wherein the natural language and mathematical formula input unit includes:
a first natural language input processor configured to provide a text input tool used to receive the natural language inputted;
a first mathematical formula input processor configured to provide a mathematical formula input tool used to receive the mathematical formula inputted;
a first information processing unit configured to deliver aggregated data generated by aggregating the natural language and the mathematical formula inputted;
a first parsing unit configured to receive the aggregated data inputted, and generate semantic information used to analyze and classify each of constitutional information constituting the natural language and mathematical formula, the classifying being performed in terms of specific meaning; and
a first data management unit configured to recombine one or more of the constitutional information, the natural language, the mathematical formula and the semantic information and to store the one or more recombined information.

3. The apparatus of claim 1, wherein the natural language and mathematical formula structuralizing unit includes:
a second information input unit configured to receive the combined data inputted;
a second separation unit configured to separate the natural language and the mathematical language from the combined data;
a second natural language processing unit configured to analyze and classify each first information constituting the separated natural language, the classifying being performed in terms of specific meaning;
a second mathematical formula processing unit configured to analyze and classify each second information constituting the separated mathematical formula, the classifying being performed in terms of specific meaning; and
a second data management unit configured to recombine one or more of the first information, the second information, the natural language and the mathematical formula and to store the one or more recombined information as recombined data.

4. The apparatus of claim 1, wherein the natural language and mathematical formula indexing unit includes:
a third information input unit configured to receive the combined data inputted;
a third semantic parser unit configured to separate the natural language and mathematical formula from the combined data and generate semantic information used to analyze and classify each of constitutional information constituting the separated natural language and mathematical formula, the classifying being performed in terms of specific meaning;
a third data management unit configured to recombine one or more of the constitutional information, the natural language, the mathematical formula and the semantic information and to store the recombined information as recombined data;
a third query parser unit configured to extract and structuralizes a keyword included in a user query inputted; and
a third indexing unit configured to generate semantic index information generated by indexing the semantic information and generate query index information generated by matching the semantic index information to information on the keyword.

5. The apparatus of claim 1, wherein the operation information extraction unit includes:
a fourth information input unit configured to receive the combined data inputted;
a fourth separation unit configured to separate the natural language and mathematical formula from the combined data;
a fourth natural language processing unit configured to generate a natural language token by tokenizing the separated natural language;
a fourth mathematical formula processing unit configured to generate a mathematical formula token by parsing the separated mathematical formula and by extracting a semantic meaning and;
a fourth rule storage unit configured to store a rule generated by coupling a logical condition of natural language and mathematical formula with the operation information corresponding to the logical condition; and
a fourth operation extraction unit configured to extract the operation information of the combined data from the stored rule by comparing the generated natural language token and the generated mathematical formula token with the logical condition of the stored rule.

6. The apparatus of claim 1, wherein the operation structuralizing unit includes:
a fifth information input unit configured to receive the combined data inputted;
a fifth sentence analysis unit configured to analyze sentence constitution of the combined data, tokenize the natural language and the mathematical formula and generate a natural language token and a mathematical formula token;
a fifth operation extraction unit configured to extract the operation information corresponding to a meaning of the natural language token with reference to a natural language token rule; and
a fifth operation execution unit configured to structuralize the extracted operation information with respect to the mathematical formula token.

7. The apparatus of claim 1, wherein the information generation unit includes:
a sixth information input unit configured to receive a mathematical formula data inputted, the mathematical formula data being expressed in the mathematical formula;
a sixth mathematical formula data structuralizing unit configured to extract an operator and a parameter from the mathematical formula data and structuralize the extracted operator and the extracted parameter; and
a sixth operator parsing unit configured to extract a semantic meaning of the operator with respect to the structuralized operator, couple the extracted semantic meaning to a parameter associated with the operator, and generate the parsing semantic information.

8. An apparatus for processing a natural language and a mathematical formula, the apparatus comprising:
a first natural language input processor configured to provide a text input tool used to receive a natural language inputted;
a first mathematical formula input processor configured to provide a mathematical formula input tool used to receive a mathematical formula inputted;
a first information processing unit configured to deliver aggregation data generated by aggregating the natural language and the mathematical formula inputted;
a first parsing unit configured to receive the aggregated data inputted, and generate semantic information used to analyze and classify each of constitutional information constituting the natural language and mathematical formula, the classifying being performed in terms of specific meaning; and
a first data management unit configured to recombine one or more of the constitutional information, the natural language, the mathematical formula and the semantic information and to store the one or more recombined information.

9. An apparatus for processing a natural language and a mathematical formula, the apparatus comprising:
a second information input unit configured to receive combined data composed of a natural language combined with a mathematical formula;
a second separation unit configured to separate the natural language and the mathematical formula from the combined data;
a second natural language processing unit configured to analyze and classify each first information constituting the separated natural language, the classifying being performed in terms of specific meaning;
a second mathematical formula processing unit configured to analyze and classify each second information constituting the separated mathematical formula, the classifying being performed in terms of specific meaning; and
a second data management unit configured to recombine one or more of the first information, the second information, the natural language and the mathematical formula and to store the one or more recombined information as recombined data.

10. An apparatus for processing a natural language and mathematical formula, the apparatus comprising:
a third information input unit configured to receive combined data composed of a natural language combined with a mathematical formula;
a third semantic parser unit configured to separate the natural language and mathematical formula from the combined data and generate semantic information used to analyze and classify each of constitutional information constituting the separated natural language and mathematical formula, the classifying being performed in terms of specific meaning;
a third data management unit configured to recombine one or more of the constitutional information, the natural language, the mathematical formula and the semantic information and to store the recombined information as recombined data;
a third query parser unit configured to extract and structuralize a keyword included in a user query inputted; and
a third indexing unit configured to generate semantic index information generated by indexing the semantic information and generate query index information generated by matching the semantic index information to information on the keyword.

11. An apparatus for processing a natural language and a mathematical formula, the apparatus comprising:
a fourth information input unit configured to receive a complex sentence including a natural language and a mathematical formula;
a fourth separation unit configured to separate the natural language and the mathematical formula from the complex sentence;
a fourth natural language processing unit configured to generate a natural language token by tokenizing the separated natural language;
a fourth mathematical formula processing unit configured to parse the separated mathematical formula, extract a semantic meaning and generate a mathematical formula token;
a fourth rule storage unit configured to store a rule generated by coupling a logical condition of the natural language and mathematical formula to operation information corresponding to the logical condition; and
a fourth operation extraction unit configured to extract operation information of the complex sentence from the stored rule by comparing the generated natural language token and the generated mathematical formula token with a logical condition of the stored rule.

12. An apparatus for processing a natural language and a mathematical formula, the apparatus comprising:
a fifth information input unit configured to receive a complex sentence including a natural language and a mathematical formula;
a fifth sentence analysis unit configured to analyze a sentence composition of the complex sentence, tokenize mathematical formula data and the natural language, and generate a mathematical formula token and a natural language token;
a fifth operation extraction unit configured to extract operation information corresponding to a meaning of the natural language token with reference to a natural language token rule; and
a fifth operation execution unit configured to structuralize the extracted operation information with respect to the mathematical formula token.

13. An apparatus for processing a natural language and mathematical formula, the apparatus comprising:
a sixth information input unit configured to receive mathematical formula data expressed in a mathematical formula;
a sixth mathematical formula data structuralizing unit configured to extract an operator and a parameter from the mathematical formula data and structuralize the operator and parameter; and
a sixth operator parsing unit configured to extract a semantic meaning of the operator with respect to the structuralized operator, couple the extracted semantic meaning to a parameter associated with the operator, and generate parsing semantic information.

14. A method of processing a natural language and a mathematical formula, the method performed by an apparatus for processing a natural language and a mathematical formula and comprising:
receiving the natural language and the mathematical formula inputted;
generating parsing semantic information of the mathematical formula from combined data composed of the natural language combined with the mathematical formula;
extracting operation information generated by using a logical condition from the combined data;
structuralizing the natural language and the mathematical formula by analyzing, classifying and recombining the combined data, the classifying being performed in terms of specific meaning;
structuralizing the operation information; and
indexing the combined data.

15. The method of claim 14, wherein the receiving of the natural language and mathematical formula comprises:
receiving the natural language inputted through a text input tool;
receiving the mathematical formula inputted through a mathematical formula input tool;
delivering aggregated data generated by aggregating the received natural language and the received mathematical formula;
receiving the aggregated data, and generating semantic information used to analyze each of constitutional information constituting the natural language and mathematical formula and to classify said each of the constitutional information in terms of specific meaning; and
recombining one or more of the constitutional information, the natural language, the mathematical formula and the semantic information and storing the one or more recombined information.

16. The method of claim 14, wherein the structuralizing of the natural language and mathematical formula comprises:
receiving the combined data inputted;
separating the natural language and the mathematical formula from the combined data;
analyzing and classifying each first information constituting the separated natural language, the classifying being performed in terms of specific meaning;
analyzing and classifying each second information constituting the separated mathematical formula, the classifying being performed in terms of specific meaning; and
recombining one or more of the first information, the second information, the natural language and the mathematical formula and storing the one or more recombined information as recombined data.

17. The method of claim 14, wherein the indexing of the combined data comprises:
receiving the combined data inputted;
separating the natural language and the mathematical formula from the combined data, and generating semantic information used to analyze and classify each of constitutional information constituting the separated natural language and mathematical formula, the classifying being performed in terms of specific meaning;
recombining one or more of the constitutional information, the natural language, the mathematical formula and the semantic information and storing the one or more recombined information as recombined data;
extracting and structuralizing a keyword included in a user query inputted; and
generating semantic index information generated by indexing the semantic information, and generating query index information generated by matching the semantic index information to information on the keyword.

18. The method of claim 14, wherein the extracting of the operation information comprises:
receiving the combined data inputted;
separating the natural language and mathematical formula from the combined data;
tokenizing the separated natural language to generate a natural language token;
parsing the separated mathematical formula and extracting a semantic meaning to generate a mathematical formula token;
storing a rule generated by coupling a logical condition of the natural language and mathematical formula to the operation information corresponding to the logical condition; and
extracting the operation information of the combined data from the stored rule by comparing the natural language token and mathematical formula token generated with the logical condition of the stored rule.

19. The method of claim 14, wherein the structuralizing of the operation information comprises:
receiving the combined data inputted;
analyzing a sentence constitution of the combined data and tokenizing the mathematical formula and natural language, and generating a mathematical formula token and a natural language token;
extracting the operation information corresponding to a meaning of the natural language token with reference to a natural language token rule; and
structuralizing the extracted operation information with respect to the mathematical formula token.

20. The method of claim 14, wherein the generating of parsing semantic information comprises:
receiving mathematical formula data expressed in the mathematical formula;
extracting an operator and a parameter from the mathematical formula data and structuralizing the operator and parameter; and
generating the parsing semantic information by extracting a semantic meaning of the operator with respect to the structuralized operator and coupling the extracted semantic meaning to the parameter associated with the operator.

21. A method for processing a natural language and a mathematical formula, the method performed by an apparatus for processing a natural language and a mathematical formula and comprising:
performing a first natural language inputting for providing a text input tool to receive a natural language inputted;
performing a first mathematical formula inputting for providing a mathematical formula input tool to receive a mathematical formula inputted;
performing a first information process for delivering aggregation date generated by aggregating the natural language and mathematical formula inputted;
performing a first parsing for receiving the aggregated data inputted, and generating semantic information used to analyze and classify each of constitutional information constituting the natural language and mathematical formula, the classifying being performed in terms of specific meaning; and
performing a first data management for recombining one or more of the constitutional information, the natural language, the mathematical formula and the semantic information and storing the recombined information.

22. A method for processing a natural language and a mathematical formula, the method performed by an apparatus for processing a natural language and a mathematical formula and comprising:
performing a second information inputting for receiving combined data inputted, the combined data being composed of a natural language combined with a mathematical formula;
performing a second separation for separating the natural language and the mathematical formula from the combined data;
performing a second natural language process for analyzing and classifying each first information constituting the separated natural language, the classifying being performed in terms of specific meaning;
performing a second mathematical formula process for analyzing and classifying each second information constituting the separated mathematical formula, the classifying being performed in terms of specific meaning; and
performing a second data management for recombining one or more of the first information, the second information, the natural language and the mathematical formula and storing the recombined information as recombined data.

23. A method for processing a natural language and a mathematical formula, the method performed by an apparatus for processing a natural language and a mathematical formula and comprising:
performing a third information inputting for receiving combined data inputted, the combined data being composed of a natural language combined with a mathematical formula;
performing a third semantic parser process for separating the natural language and the mathematical formula from the combined data, and generating semantic information used to analyze and classify each of constitutional information constituting the separated natural language and the mathematical formula, the classifying being performed in terms of specific meaning;
performing a third data management for recombining one or more of the constitutional information, the natural language, the mathematical formula and the semantic information and storing the recombined information as recombined data;
performing a third query parser process for extracting and structuralizing a keyword included in a user query inputted; and
performing a third indexing for generating semantic index information generated by indexing the semantic information and generating query index information generated by matching the semantic index information to the keyword information.

24. A method for processing a natural language and a mathematical formula, the method performed by an apparatus for processing a natural language and a mathematical formula and comprising:
performing a fourth information inputting for receiving a complex sentence including a natural language and a mathematical formula;
performing a fourth separation for separating the natural language and the mathematical formula from the complex sentence;
performing a fourth natural language process for generating a natural language token by tokenizing the separated natural language;
performing a fourth mathematical formula process for generating a mathematical formula token by parsing the separated mathematical formula and extracting a semantic meaning;
performing a fourth rule storage for storing a rule generated by coupling a logical condition of the natural language and mathematical formula to operation information corresponding to the logical condition; and
performing a fourth operation extraction for extracting operation information of the complex statement from the stored rule by comparing the generated natural language token and mathematical formula token with the logical condition of the stored rule.

25. A method for processing a natural language and a mathematical formula, the method performed by an apparatus for processing a natural language and a mathematical formula and comprising:
performing a fifth information inputting for receiving complex sentence including a natural language and a mathematical formula;
performing a fifth sentence analysis for analyzing a sentence constitution of the complex sentence, tokenizing the mathematical data and the natural language, and generating a mathematical formula token and a natural language token;
performing a fifth operation extraction for extracting operation information corresponding to a meaning of the natural language token with reference to a natural language token rule; and
performing a fifth operation for structuralizing the extracted operation information with respect to the mathematical formula token.

26. A method for processing a natural language and a mathematical formula, the method performed by an apparatus for processing a natural language and a mathematical formula and comprising:
performing a sixth information inputting for receiving mathematical formula data inputted, the mathematical formula data being expressed in a mathematical formula;
performing a sixth mathematical formula data structuralizing for extracting an operator and a parameter from the mathematical formula data and structuralizing the operator and parameter; and
performing a sixth operator parsing for extracting a semantic meaning of the operator with respect to the structuralized operator, coupling the extracted semantic meaning to a parameter associated with the operator, and generating parsing semantic information.
